(19) United States
(12) Patent Application Publication
(10) Pub. No.: US 2023/0216040 A1
(43) Pub. Date: Jul. 6, 2023

(54) Nanopowder Coatings That Enhance Lithium Battery Component Performance

(71) Applicant: The Regents of The University of Michigan, Ann Arbor, MI (US)

(72) Inventors: RICHARD M. LAINE, Ann Arbor, MI (US); ELENI TEMECHE, Ann Arbor, MI (US); TAYLOR BRANDT, Ann Arbor, MI (US); PHILYONG KIM, Ann Arbor, MI (US)

(21) Appl. No.: 18/091,478

(22) Filed: Dec. 30, 2022

Related U.S. Application Data
(60) Provisional application No. 63/296,601, filed on Jan. 5, 2022.

(51) Int. Cl. H01M 4/38; H01M 4/36; H01M 10/0562; H01M 10/0525

(52) U.S. Cl. CPC H01M 4/382; H01M 4/366; H01M 10/0562; H01M 10/0525; H01M 2004/021

(57) ABSTRACT

An electrode for an electrochemical device is disclosed. The electrode comprises a lithium host material; and a porous coating on the lithium host material. The porous coating can comprise a solid-state ion conducting electrolyte material selected from:
(i) lithium aluminum oxides,
(ii) lithium containing phosphates,
(iii) LiₓPON wherein x is 1, 1.5, 3, or 6,
(iv) LiₓSiPON wherein x is 1, 1.5, 3, or 6,
(v) LiₓSiON wherein x is 2, 4, or 6,
(vi) lithium lanthanum zirconium oxides, and
(vii) mixtures of two or more of (i), (ii), (iii), (iv), (v), and (vi).

The porous coating comprising the solid-state ion conducting electrolyte material may be formed from one or more precursors that form the porous coating comprising the solid-state ion conducting electrolyte material upon cycling of the electrochemical device.

### CROSS-REFERENCES TO RELATED APPLICATIONS

This application claims priority to U.S. Patent Application No. 63/296,601 filed Jan. 5, 2022.

### STATEMENT REGARDING FEDERALLY SPONSORED RESEARCH

This invention was made with government support under DMR1926199 awarded by the National Science Foundation—Division of Materials Research. The government has certain rights in the invention.

### BACKGROUND OF THE INVENTION

### 1. Field of the Invention

This invention relates to coatings that enhance battery component performance.

### 2. Description of the Related Art

Coatings play multiple roles in a wide variety of applications. They can be used as protective layers because they are mechanically strong or corrosion resistant [Ref. 1-3], prevent reflections or resist fogging, or they can prevent migration of substrate components (elements) or offer selected transport of one ion over others or electrons. They can prevent aggregation or sintering of particles. They can stabilize high surface area substrates or reduce surface free energies. They can stabilize specific phases. They can protect from infection or promote drug transport across membranes.

When used with active phases in battery components, some primary purposes of a coating are to promote selective ion/electron diffusion pathways, prevent corrosion through loss of active ions or unwanted chemical oxidation/reduction of active components. They may also offer mechanical properties that resist charge/discharge dimensional changes or prevent unwanted phase transitions or favor formation of desirable phases.

Coatings have been used successfully with silicon anodes to limit volume expansion during lithiation [Ref. 4-8]. They have been used to protect cathode materials from HF generated by hydrolysis of PF₆ through formation of AlF₃ and/or LiF. In Li—S systems, they have been used to limit or prevent sulfide shuttling that leads to loss of active material and formation of insulating layers [Ref. 9-13]. In high voltage cathodes, they have been used to prevent dissolution of Mn for example [Ref. 14-18].

Coatings have been used as synthetic solid electrolyte interfaces (SEIs) to prevent formation, or excessive growth, of SEIs for specific battery chemistries. Coatings have also been used to improve ionic and/or electronic conductivity of battery components. Finally, coatings have been used extensively to block dendrite propagation during cycling.

Coating methods most commonly target uniform and complete coating of substrates preferably limiting the formation of “pinholes,” as these are high energy defects likely permit unwanted processes even promoting them vs. uncoated substrates. To this end, multiple techniques have been explored to deposit uniform and thin coatings often based on solution (e.g. sol-gel or precipitation processing) or gas phase deposition methods. Gas phase deposition techniques including CVD, ALD and plasma assisted versions, and a number of sputtering technologies have all been explored with varying degrees of success.

Critical concerns focus on non-uniform coatings. The literature is replete with examples of coatings with defect pores [Ref. 5,6] that for example serve as the source of crack initiation leading to coating failure. Alternately, pores are also frequently associated with chemical pitting of substrates initiating corrosive failure. Pores (defects) can serve as nucleation sites for growth of and propagation of dendrites within ceramic electrolytes such as LLZO [Ref. 19].

Therefore, there is a need for improved coatings that enhance battery component performance.

### SUMMARY OF THE INVENTION

We have unexpectedly found that coating active cathode and/or active anode materials with nanopowders that are solid electrolytes or that can transform to solid electrolytes during battery operation can substantially improve the performance of the coated active material by enhancing energy capacities, increasing long term stability, and eliminating or greatly reducing degradative processes in a number of unexpected ways. The coatings can be applied by mixing using ball milling, ultrasonic mixing or electrospray coating, and despite being porous offer a wide variety of greatly enhanced properties. Typically, porous coatings are especially prone to failure because the pores themselves can promote degradation of the active materials; yet, our findings described herein are the exact opposite. In some instances, coated cathode materials outperform any known examples of these same uncoated materials. The Li—S systems are especially stable compared to prior literature examples.

In one aspect, the present disclosure provides an electrode for an electrochemical device. The electrode comprises a lithium host material; and a porous coating on the lithium host material. The porous coating can comprise a solid-state ion conducting electrolyte material selected from:
(i) lithium aluminum oxides,
(ii) lithium containing phosphates,
(iii) LiₓPON wherein x is 1, 1.5, 3, or 6,
(iv) LiₓSiPON wherein x is 1, 1.5, 3, or 6,
(v) LiₓSiON wherein x is 2, 4, or 6,
(vi) a ceramic electrolyte material having the formula LiᵤReᵥM_{w}AₓO_{y} wherein Re can be any combination of elements with a nominal valence of +3 including La, Nd, Pr, Pm, Sm, Sc, Eu, Gd, Tb, Dy, Y, Ho, Er, Tm, Yb, and Lu, M can be any combination of metals with a nominal valence of +3, +4, +5 or +6 including Zr, Ta, Nb, Sb, W, Hf, Sn, Ti, V, Bi, Ge, and Si, A can be any combination of dopant atoms with nominal valence of +1, +2, +3 or +4 including H, Na, K, Rb, Cs, Ba, Sr, Ca, Mg, Fe, Co, Ni, Cu, Zn, Ga, Al, B, and Mn, u can vary from 3-7.5, v can vary from 0-3, w can vary from 0-2, x can vary from 0-2; and y can vary from 11-12.5, and
(vii) mixtures of two or more of (i), (ii), (iii), (iv), (v), and (vi).
   The porous coating comprising the solid-state ion conducting electrolyte material may be formed from one or more precursors that form the porous coating comprising the solid-state ion conducting electrolyte material upon cycling of the electrochemical device.

In one embodiment, the electrode comprises: a plurality of first particles comprising a porous coating of one of the solid-state ion conducting electrolyte materials on the lithium host material, and a plurality of second particles comprising a porous coating of another of the solid-state ion conducting electrolyte materials on the lithium host material. The one of the solid-state ion conducting electrolyte material can be present in the first particles at a weight percentage between 5% and 30% based on a total weight of the one of the solid-state ion conducting electrolyte material and the lithium host material in the first particles, and the another of the solid-state ion conducting electrolyte materials can be present in the second particles at a weight percentage between 5% and 30% based on a total weight of the another of the solid-state ion conducting electrolyte material and the lithium host material in the second particles.

In one embodiment, the electrode has a thickness between 1 and 200 micrometers. In one embodiment, the porous coating has a thickness between about 20 nanometers and about 10 micrometers. In one embodiment, the porous coating comprises particles having an average particle size between 1 and 100 nanometers.

In one embodiment, the electrode is a cathode, and the lithium host material is selected from the group consisting of lithium metal oxides wherein the metal is one or more aluminum, cobalt, iron, manganese, nickel and vanadium, and lithium-containing phosphates having a general formula LiMPO₄ wherein M is one or more of cobalt, iron, manganese, and nickel. In another embodiment, the electrode is a cathode, and the lithium host material comprises a lithium manganese oxide. In another embodiment, the electrode is a cathode, and the lithium host material comprises nano-sized lithium manganese oxide particles.

In one embodiment, the solid-state ion conducting electrolyte material comprises a lithium aluminum oxide. In another embodiment, the solid-state ion conducting electrolyte material comprises a lithium containing phosphate. In another embodiment, the solid-state ion conducting electrolyte material comprises a lithium-aluminum-titanium-silicon-phosphate. In another embodiment, the solid-state ion conducting electrolyte material comprises the ceramic electrolyte material.

In one embodiment, the electrode is a cathode, and the lithium host material has a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811). In another embodiment, the solid-state ion conducting electrolyte material comprises a lithium containing phosphate. In another embodiment, the solid-state ion conducting electrolyte comprises material a lithium-aluminum-titanium-silicon-phosphate.

In one embodiment, the electrode is a cathode, and the lithium host material has a formula LiNi_{1-x-y}MnₓAl_{y}O₂ (NMA) wherein x+y+z=1. In another embodiment, the electrode is a cathode, and the lithium host material comprises a sulfur containing material. In another embodiment, the solid-state ion conducting electrolyte material comprises a lithium containing phosphate. In another embodiment, the solid-state ion conducting electrolyte material comprises a lithium-aluminum-titanium-silicon-phosphate. In another embodiment, the solid-state ion conducting electrolyte material comprises LiₓSiPON wherein x is 1, 1.5, 3, or 6.

In one embodiment, the electrode is an anode, and the lithium host material is selected from the group consisting of lithium titanium oxides, silicon-containing materials, and high entropy oxides.

In one embodiment, the electrode is an anode, and the lithium host material is lithium titanium oxide.

In one embodiment, the solid-state ion conducting electrolyte material comprises a lithium aluminum oxide and LiₓSiON wherein x is 2, 4, or 6.

In one embodiment, the electrode is an anode, and the electrode comprises a plurality of first particles and a plurality of second particles, the first particles comprising a porous coating of lithium aluminum oxide on lithium titanium oxide, and the second particles comprising a porous coating of LiₓSiON wherein x is 2, 4, or 6 on lithium titanium oxide. In one embodiment, the lithium aluminum oxide coating is present on the first particles at a weight percentage between 1% and 10% based on a total weight of the lithium aluminum oxide coating and the lithium titanium oxide in the first particles, and the LiₓSiON coating is present on the second particles at a weight percentage between 1% and 20% based on a total weight of the LiₓSiON coating and the lithium titanium oxide in the second particles.

In one embodiment, the electrode has an areal loading density between 3 and 4 mg/cm². In one embodiment, the electrode has a lithium ion diffusion coefficient of at least 1×10⁻¹² cm²/s.

In one embodiment, the electrode further comprises: a conductive additive selected from the group consisting of silica depleted rice hull ash, graphite, carbon black, acetylene black, Ketjen black, channel black, furnace black, lamp black, thermal black, conductive fibers, metallic powders, conductive whiskers, conductive metal oxides, and mixtures thereof. In another embodiment, the electrode further comprises silica depleted rice hull ash.

In one embodiment, the electrode further comprises: a binder selected from the group consisting of polyvinylidene fluoride (PVDF), polyacrylic acid, poly(methylmethacrylate), poly(vinylacetate), polyvinyl alcohol, polyethyleneoxide, polyvinylpyrrolidone, polyvinyl ether, polyvinylchloride, polyacrylonitrile, polyvinylpyridine, styrene-butadiene rubber, acrylonitrile-butadiene rubber, polyethylene, polypropylene, ethylene-propylene-diene terpolymers (EPDM), cellulose, carboxymethylcellulose, starch, hydroxypropylcellulose, and mixtures thereof.

In another aspect, the present disclosure provides an electrochemical device comprising at least one of the embodiments of the electrodes described above as a cathode; an anode; and an electrolyte positioned between the cathode and the anode. In one embodiment, the electrochemical device has a columbic efficiency of 95% or greater.

In one embodiment of the electrochemical device, the anode comprises lithium metal. In one embodiment of the electrochemical device, the anode consists essentially of lithium metal.

In one embodiment of the electrochemical device, the electrolyte comprises a liquid electrolyte including a lithium compound in an organic solvent. The lithium compound can be selected from the group consisting of LiPF₆, LiBF₄, LiClO₄, lithium bis(fluorosulfonyl)imide (LiFSI), LiN(CF₃SO₂)₂ (LiTFSI), and LiCF₃SO₃ (LiTf), and the organic solvent can be selected from the group consisting of carbonate-based solvents, ether-based solvents, ionic liquids, and mixtures thereof. The carbonate based solvent can be selected from the group consisting of dimethyl carbonate, diethyl carbonate, ethyl methyl carbonate, dipropyl carbonate, methylpropyl carbonate, ethylpropyl carbonate, methylethyl carbonate, ethylene carbonate, propylene carbonate, butylene carbonate, fluoroethylene carbonate, and mixtures thereof. and the ether based solvent can be selected from the group consisting of diethyl ether, dibutyl ether, monoglyme, diglyme, tetraglyme, 2-methyltetrahydrofuran, tetrahydrofuran, 1,3-dioxolane, 1,2-dimethoxyethane, 1,4-dioxane, and mixtures thereof.

In one embodiment of the electrochemical device, the electrolyte comprises a solid ionically conductive polymer selected from the group consisting of poly(ethylene oxide) (PEO), polypropylene oxide (PPO), polyacrylonitrile (PAN), polyvinyl alcohol (PVA), polymethyl methacrylate (PMMA), polydimethyl siloxane (PDMS), polyvinyl pyrollidone (PVP), LiₓPON wherein x is 1, 1.5, 3, or 6, LiₓSiPON wherein x is 1, 1.5, 3, or 6, and combinations thereof.

In one embodiment of the electrochemical device, the electrolyte comprises a solid ionically conductive polymer selected from the group consisting of poly(ethylene oxide) (PEO), LiₓPON wherein x is 1, 1.5, 3, or 6, LiₓSiPON wherein x is 1, 1.5, 3, or 6, LiₓSiON wherein x is 2, 4, or 6, and combinations thereof.

In yet another aspect, the present disclosure provides an electrochemical device comprising at least one of the embodiments of the electrodes described above as an anode; a cathode; and an electrolyte positioned between the cathode and the anode. In one embodiment, the electrochemical device has a columbic efficiency of 95% or greater.

In one embodiment of the electrochemical device, the cathode comprises a cathode active material selected from (i) lithium metal oxides wherein the metal is one or more aluminum, cobalt, iron, manganese, nickel and vanadium, (ii) lithium-containing phosphates having a general formula LiMPO₄ wherein M is one or more of cobalt, iron, manganese, and nickel, and (iii) materials having a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811). In one embodiment of the electrochemical device, the cathode comprises a sulfur containing material.

In one embodiment of the electrochemical device, the electrolyte comprises a liquid electrolyte including a lithium compound in an organic solvent. The lithium compound can be selected from the group consisting of LiPF₆, LiBF₄, LiClO₄, lithium bis(fluorosulfonyl)imide (LiFSI), LiN(CF₃SO₂)₂ (LiTFSI), and LiCF₃SO₃ (LiTf), and the organic solvent is selected from the group consisting of carbonate based solvents, ether based solvents, ionic liquids, and mixtures thereof. The carbonate based solvent can be selected from the group consisting of dimethyl carbonate, diethyl carbonate, ethyl methyl carbonate, dipropyl carbonate, methylpropyl carbonate, ethylpropyl carbonate, methylethyl carbonate, ethylene carbonate, propylene carbonate, butylene carbonate, fluoroethylene carbonate, and mixtures thereof. and the ether based solvent can be selected from the group consisting of diethyl ether, dibutyl ether, monoglyme, diglyme, tetraglyme, 2-methyltetrahydrofuran, tetrahydrofuran, 1,3-dioxolane, 1,2-dimethoxyethane, 1,4-dioxane, and mixtures thereof.

In one embodiment of the electrochemical device, the electrolyte comprises a solid ionically conductive polymer selected from the group consisting of poly(ethylene oxide) (PEO), polypropylene oxide (PPO), polyacrylonitrile (PAN), polyvinyl alcohol (PVA), polymethyl methacrylate (PMMA), polydimethyl siloxane (PDMS), polyvinyl pyrollidone (PVP), LiₓPON wherein x is 1, 1.5, 3, or 6, LiₓSiPON wherein x is 1, 1.5, 3, or 6, LixSiON wherein x is 2, 4, or 6, and combinations thereof.

In one embodiment of the electrochemical device, the electrolyte comprises a solid ionically conductive polymer selected from the group consisting of poly(ethylene oxide) (PEO), LiₓPON wherein x is 1, 1.5, 3, or 6, LiₓSiPON wherein x is 1, 1.5, 3, or 6, LiₓSiON wherein x is 2, 4, or 6, and combinations thereof.

In still another aspect, the present disclosure provides a method for forming an electrode for an electrochemical device wherein the method comprises: (a) forming a slurry including coated particles comprising a porous coating of a solid-state ion conducting electrolyte material on a lithium host material; and (b) casting a layer of the slurry on a surface to form the electrode. The solid-state ion conducting electrolyte material can be selected from:
(i) lithium aluminum oxides,
(ii) lithium containing phosphates,
(iii) LiₓPON wherein x is 1, 1.5, 3, or 6,
(iv) LiₓSiPON wherein x is 1, 1.5, 3, or 6,
(v) LiₓSiON wherein x is 2, 4, or 6,
(vi) a ceramic electrolyte material having the formula LiᵤReᵥM_{w}AₓO_{y} wherein Re can be any combination of elements with a nominal valence of +3 including La, Nd, Pr, Pm, Sm, Sc, Eu, Gd, Tb, Dy, Y, Ho, Er, Tm, Yb, and Lu, M can be any combination of metals with a nominal valence of +3, +4, +5 or +6 including Zr, Ta, Nb, Sb, W, Hf, Sn, Ti, V, Bi, Ge, and Si, A can be any combination of dopant atoms with nominal valence of +1, +2, +3 or +4 including H, Na, K, Rb, Cs, Ba, Sr, Ca, Mg, Fe, Co, Ni, Cu, Zn, Ga, Al, B, and Mn, u can vary from 3-7.5, v can vary from 0-3, w can vary from 0-2, x can vary from 0-2; and y can vary from 11-12.5, and
(vii) mixtures of two or more of (i), (ii), (iii), (iv), (v), and (vi).

In one embodiment of the method, the solid-state ion conducting electrolyte material is selected from the group consisting of: (i) lithium aluminum oxides, (ii) lithium containing phosphates, (iii) LiₓPON wherein x is 1, 1.5, 3, or 6, (iv) LiₓSiPON wherein x is 1, 1.5, 3, or 6, (v) LiₓSiON wherein x is 2, 4, or 6, (vi) a ceramic electrolyte material having the formula LiᵤReᵥM_{w}AₓO_{y} wherein Re can be any combination of elements with a nominal valence of +3 including La, Nd, Pr, Pm, Sm, Sc, Eu, Gd, Tb, Dy, Y, Ho, Er, Tm, Yb, and Lu, M can be any combination of metals with a nominal valence of +3, +4, +5 or +6 including Zr, Ta, Nb, Sb, W, Hf, Sn, Ti, V, Bi, Ge, and Si, A can be any combination of dopant atoms with nominal valence of +1, +2, +3 or +4 including H, Na, K, Rb, Cs, Ba, Sr, Ca, Mg, Fe, Co, Ni, Cu, Zn, Ga, Al, B, and Mn, u can vary from 3-7.5, v can vary from 0-3, w can vary from 0-2, x can vary from 0-2; and y can vary from 11-12.5, and (vii) mixtures thereof.

In one embodiment of the method, step (a) comprises forming the coated particles by (i) forming a plurality of particles of the lithium host material, and (ii) forming the porous coating of the solid-state ion conducting electrolyte material on the plurality of particles of the lithium host material. The plurality of particles of the lithium host material can be formed by liquid-feed flame spray pyrolysis. In one embodiment of the method, the porous coating of the solid-state ion conducting electrolyte material is formed on the plurality of particles of the lithium host material by ball milling a mixture of the solid-state ion conducting electrolyte material and the plurality of particles of the lithium host material. In one embodiment of the method, the porous coating of the solid-state ion conducting electrolyte material is formed on the plurality of particles of the lithium host material ultrasonic mixing the solid-state ion conducting electrolyte material and the plurality of particles of the lithium host material. In one embodiment of the method, the porous coating of the solid-state ion conducting electrolyte material is formed on the plurality of particles of the lithium host material by an electrospray coating process.

In one embodiment of the method, the surface is a surface of a current collector. In one embodiment of the method, the layer of the slurry has a thickness between 1 and 200 micrometers. In one embodiment of the method, the layer of the slurry does not undergo a heat treatment.

In one embodiment of the method, the coated particles comprise: a plurality of first particles comprising a porous coating of one of the solid-state ion conducting electrolyte materials on the lithium host material, and a plurality of second particles comprising a porous coating of another of the solid-state ion conducting electrolyte materials on the lithium host material. In one embodiment of the method, the one of the solid-state ion conducting electrolyte materials is present in the first particles at a weight percentage between 5% and 30% based on a total weight of the one of the solid-state ion conducting electrolyte material and the lithium host material in the first particles, and the another of the solid-state ion conducting electrolyte materials is present in the second particles at a weight percentage between 5% and 30% based on a total weight of the another of the solid-state ion conducting electrolyte materials and the lithium host material in the second particles.

In one embodiment of the method, the porous coating has a thickness between about 20 nanometers and about 10 micrometers. In one embodiment of the method, the porous coating comprises particles having an average particle size between 1 and 100 nanometers.

In one embodiment of the method, the lithium host material is selected from the group consisting of lithium metal oxides wherein the metal is one or more aluminum, cobalt, iron, manganese, nickel and vanadium, and lithium-containing phosphates having a general formula LiMPO₄ wherein M is one or more of cobalt, iron, manganese, and nickel. In one embodiment of the method, the lithium host material comprises a lithium manganese oxide.

In one embodiment of the method, the solid-state ion conducting electrolyte material comprises a lithium aluminum oxide. In one embodiment of the method, the solid-state ion conducting electrolyte material comprises a lithium containing phosphate. In one embodiment of the method, the solid-state ion conducting electrolyte material comprises a lithium-aluminum-titanium-silicon-phosphate.

In one embodiment of the method, the solid-state ion conducting electrolyte material comprises a ceramic electrolyte material having the formula LiᵤReᵥM_{w}AₓO_{y} wherein Re can be any combination of elements with a nominal valence of +3 including La, Nd, Pr, Pm, Sm, Sc, Eu, Gd, Tb, Dy, Y, Ho, Er, Tm, Yb, and Lu, M can be any combination of metals with a nominal valence of +3, +4, +5 or +6 including Zr, Ta, Nb, Sb, W, Hf, Sn, Ti, V, Bi, Ge, and Si, A can be any combination of dopant atoms with nominal valence of +1, +2, +3 or +4 including H, Na, K, Rb, Cs, Ba, Sr, Ca, Mg, Fe, Co, Ni, Cu, Zn, Ga, Al, B, and Mn, u can vary from 3-7.5, v can vary from 0-3, w can vary from 0-2, x can vary from 0-2; and y can vary from 11-12.5.

In one embodiment of the method, the lithium host material has a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811). In one embodiment of the method, the solid-state ion conducting electrolyte material comprises a lithium containing phosphate. In one embodiment of the method, the lithium host material has a formula LiNi_{1-x-y}MnₓAl_{y}O₂ (NMA) wherein x+y+z=1. In one embodiment of the method, the lithium host material comprises a sulfur containing material.

In one embodiment of the method, the solid-state ion conducting electrolyte material comprises a lithium containing phosphate. In one embodiment of the method, the solid-state ion conducting electrolyte material comprises LiₓSiPON wherein x is 1, 1.5, 3, or 6. In one embodiment of the method, the lithium host material is selected from the group consisting of lithium titanium oxides, silicon-containing materials, and high entropy oxides. In one embodiment of the method, the lithium host material is lithium titanium oxide. In one embodiment of the method, the solid-state ion conducting electrolyte material comprises a lithium aluminum oxide and LiₓSiON wherein x is 2, 4, or 6.

In one embodiment of the method, the coated particles comprise a plurality of first particles and a plurality of second particles, the first particles comprising a porous coating of lithium aluminum oxide on lithium titanium oxide, and the second particles comprising a porous coating of LiₓSiON wherein x is 2, 4, or 6 on lithium titanium oxide. In one embodiment of the method, the lithium host material comprises nano-sized particles.

In yet another aspect, the present disclosure provides a method for forming an electrode for an electrochemical device wherein the method comprises: (a) forming a slurry including coated particles comprising a lithium host material and a coating of one or more precursors that form a porous coating of a solid-state ion conducting electrolyte material on the lithium host material upon cycling of the electrochemical device; and (b) casting a layer of the slurry on a surface to form the electrode. The solid-state ion conducting electrolyte material can be selected from:
(i) lithium aluminum oxides,
(ii) lithium containing phosphates,
(iii) LiₓPON wherein x is 1, 1.5, 3, or 6,
(iv) LiₓSiPON wherein x is 1, 1.5, 3, or 6,
(v) LiₓSiON wherein x is 2, 4, or 6,
(vi) a ceramic electrolyte material having the formula LiᵤReᵥM_{w}AₓO_{y} wherein Re can be any combination of elements with a nominal valence of +3 including La, Nd, Pr, Pm, Sm, Sc, Eu, Gd, Tb, Dy, Y, Ho, Er, Tm, Yb, and Lu, M can be any combination of metals with a nominal valence of +3, +4, +5 or +6 including Zr, Ta, Nb, Sb, W, Hf, Sn, Ti, V, Bi, Ge, and Si, A can be any combination of dopant atoms with nominal valence of +1, +2, +3 or +4 including H, Na, K, Rb, Cs, Ba, Sr, Ca, Mg, Fe, Co, Ni, Cu, Zn, Ga, Al, B, and Mn, u can vary from 3-7.5, v can vary from 0-3, w can vary from 0-2, x can vary from 0-2; and y can vary from 11-12.5, and
(vii) mixtures of two or more of (i), (ii), (iii), (iv), (v), and (vi).

In one embodiment of the method, the porous coating comprises particles having an average particle size between 1 and 100 nanometers.

In one embodiment of the method, the lithium host material is selected from the group consisting of lithium metal oxides wherein the metal is one or more aluminum, cobalt, iron, manganese, nickel and vanadium, and lithium-containing phosphates having a general formula LiMPO₄ wherein M is one or more of cobalt, iron, manganese, and nickel.

In one embodiment of the method, the lithium host material comprises a lithium manganese oxide.

In one embodiment of the method, the solid-state ion conducting electrolyte material comprises a lithium aluminum oxide. In one embodiment of the method, the solid-state ion conducting electrolyte material comprises a lithium containing phosphate.

In one embodiment of the method, the lithium host material has a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811).

In one embodiment of the method, the solid-state ion conducting electrolyte material comprises a lithium containing phosphate.

In one embodiment of the method, the lithium host material has a formula LiNi_{1-x-y}MnₓAl_{y}O₂ (NMA) wherein x+y+z=1. In one embodiment of the method, the lithium host material comprises a sulfur containing material.

In one embodiment of the method, the solid-state ion conducting electrolyte material comprises a lithium containing phosphate. In one embodiment of the method, the solid-state ion conducting electrolyte material comprises LiₓSiPON wherein x is 1, 1.5, 3, or 6.

In one embodiment of the method, the lithium host material is selected from the group consisting of lithium titanium oxides, silicon-containing materials, and high entropy oxides. In one embodiment of the method, the lithium host material is lithium titanium oxide.

In one embodiment of the method, the lithium host material comprises nano-sized particles.

These and other features, aspects, and advantages of the present disclosure will become better understood upon consideration of the following detailed description, drawings, and appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows the electrochemical performance of a LMNO-5Al₂O₃/Li half-cell wherein panel (a) is Capacity vs. cycle number, panel (b) is Energy density vs. capacity, panel (c) is Columbic efficiency vs. cycle number, panel (d) is Potential vs. cycle number, and panel (e) is Potential vs discharge capacity.

FIG. 2 shows the electrochemical performance of a LMNO-5 wt. % LiAlO₂/Li half-cell wherein panel (a) is Capacity vs. cycle number, panel (b) is Energy density vs. capacity, panel (c) is Columbic efficiency vs. cycle number, panel (d) is Potential vs. cycle number, and panel (e) is Potential vs discharge capacity.

FIG. 3 shows the electrochemical performance of a LMNO-5 wt. % LLZO/Li half-cell wherein panel (a) is Capacity vs. cycle number, panel (b) is Energy density vs. capacity, panel (c) is Columbic efficiency vs. cycle number, panel (d) is Potential vs. cycle number, and panel (e) is Potential vs discharge capacity.

FIG. 4 shows the electrochemical performance of a LMNO-5 wt. % LATSP/Li half-cell wherein panel (a) is Capacity vs. cycle number, panel (b) is Energy density vs. capacity, panel (c) is Columbic efficiency vs. cycle number, panel (d) is Potential vs. cycle number, and panel (e) is Potential vs discharge capacity.

FIG. 5 shows the electrochemical performance of a LMNO-10 wt. % LATSP/Li half-cell wherein panel (a) is Capacity vs. cycle number, panel (b) is Energy density vs. capacity, panel (c) is Columbic efficiency vs. cycle number, panel (d) is Potential vs. cycle number, and panel (e) is Potential vs discharge capacity.

FIG. 6 shows the electrochemical performance of a LMNO-20 wt. % LATSP/Li half-cell wherein panel (a) is Capacity vs. cycle number, panel (b) is Energy density vs. capacity, panel (c) is Columbic efficiency vs. cycle number, panel (d) is Potential vs. cycle number, and panel (e) is Potential vs discharge capacity.

FIG. 7 shows XPS core level spectra of P 2p (left) and F 1s (right) for LMNO+5-20 wt. % LATSP electrode after 100 cycles.

FIG. 8 shows wide-scan survey XPS spectra of LMNO+5-10 wt. % Al₂O₃ electrodes after 100 cycles.

FIG. 9 shows XPS core level spectra of F 1s (left) and Al 2p (right) for LMNO+5-10 wt. % Al₂O₃ electrode after 100 cycles.

FIG. 10 shows the electrochemical performance of a NMC (5-20 wt. %) LATSP/Li half-cell.

FIG. 11 shows Scheme 1 for the synthesis of LiₓSiON polymer electrolyte.

FIG. 12 shows Scheme 2 for the preparation of LTO-composite anodes.

FIG. 13 shows XRD plots of panel (a) LTO-pristine and LTO-LiAlO₂ and panel (b) LTO-Li₆SiON powders.

FIG. 14 shows SEM images of pristine LTO panel (a), LTO-5 wt. % LiAlO₂ panel (b), LTO-10 wt. % LiAlO₂ panel (c), LTO-5 wt. % Li₆SiON panel (d), LTO-10 wt. % Li₆SiON panel (e), and LTO-10 wt. % LiAlO₂-10 wt. % Li₆SiON panel (f) powders.

FIG. 15 shows XPS survey spectra panel (a) and high-resolution spectra of Ti 2p panel (b), Al 2p panel (c), Si 2p panel (d), and N 1s panel (e) for LTO, LTO-LiAlO₂, and LTO-Li₆SiON electrodes.

FIG. 16 shows SEM and EDX images for the pristine LTO panel (a), LTO-5 wt. % LiAlO₂ panel (b), and LTO-10 wt. % Li₆SiON panel (c) electrodes.

FIG. 17 shows Nyquist plot of LTO composite-Li half-cell panels (a and c) and plot of Zᵣₑ vs angular frequency panels (b and d). The dotted line corresponds to the experimental value and the solid line indicates the fitted data.

FIG. 18 shows cyclic voltammograms of the LTO-pristine, LTO-LiAlO₂, and LTO-Li₆SiON panel (a) and LTO-LiAlO₂—Li₆SiON panel (b) half-cells.

FIG. 19 shows cycling performance of the LTO-pristine, LTO-LiAlO₂, and LTO-Li₆SiON panel (a) and LTO-LiAlO₂—Li₆SiON panel (b) half-cells cycled between 1 and 2.5 V.

FIG. 20 shows cycling performance of the LTO-LiAlO₂, and LTO-Li₆SiON panel (a) and LTO-LiAlO₂—Li₆SiON panel (b) half-cells cycled between 0.01 and 2.5 V.

FIG. 21 shows a comparison of discharge capacities of the various electrodes cycled between 1.0 and 2.5 V panel (a) and 0.01 and 2.5 V panel (b) at selected C-rates.

FIG. 22 shows XRD plots of LTO NP and LTO heated to 700° C./2 h/N₂.

FIG. 23 shows XRD plots of LTO-LiAlO₂—Li₆SiON powders.

FIG. 24 shows FTIR spectra of panel (a) pristine LTO, LTO-LiAlO₂, LTO-Li₆SiON, and panel (b) LTO-LiAlO₂—Li₆SiON powders.

FIG. 25 shows TGA (700° C./10° C. min-1/N₂) of panel (a) pristine LTO, LiAlO₂, Li₆SiON, and panel (b) LTO-LiAlO₂ and LTO-Li₆SiON powders.

FIG. 26 shows Ti 2p core XPS spectra of panel (a) pristine LTO, panel (b) LTO-5 wt. % Li₆SiON, and panel (c) LTO-10 wt. % Li₆SiON electrodes.

FIG. 27 shows XPS survey spectra panel (a), core level spectra of Ti 2p panel (b), Al 2p panel (c), Si 2p panel (d), and N 1s panel (e) LTO-LiAlO₂—Li₆SiON electrodes.

FIG. 28 shows SEM and EDX images for the pristine LTO-10 wt. % LiAlO₂ panel (a), LTO-5 wt. % Li₆SiON panel (b), and panel (c) LTO-10 wt. % LiAlO₂-5 wt. % Li₆SiON electrodes.

FIG. 29 shows a Randle-Ershler equivalent circuit model used to fit the Nyquist plot.

FIG. 30 shows Potential vs. capacity plots at selected cycle numbers for half-cells assembled with panel (a) LTO-5 wt. % LiAlO₂-10 wt. % Li₆SiON, panel (b) LTO-10 wt. % LiAlO₂-5 wt. % Li₆SiON, and panel (c) LTO-10 wt. % LiAlO₂-10 wt. % Li₆SiON electrodes.

FIG. 31 shows panel (a) Potential vs. capacity plots at 70 cycles and panel (b) enlarged charge-discharge curves of LTO-LiAlO₂—Li₆SiON electrodes.

FIG. 32 shows Nyquist plots of pristine and composite LTO-Li half-cells after 100 cycles.

FIG. 33 shows long-term cycling stability of LTO-5 wt. % LiAlO₂-10 wt. % Li₆SiON—Li half cell at 5 C.

FIG. 34 shows Li—S half-cell w/o LATSP Potential vs. time & specific capacity vs. cycle number.

FIG. 35 shows potential vs. time and specific capacity vs. cycle number of the Li—S half-cell with 15 wt. % LATSP.

FIG. 36 shows specific capacity of the Li—S half-cells with or without LATSP.

FIG. 37 shows potential vs. time and specific capacity vs. cycle number of Sample 4 (5 wt. % LiAlO₂).

FIG. 38 shows potential vs. time and specific capacity vs. cycle number of Sample 5 (10 wt. % Li₆SiPON in Table B).

FIG. 39 shows best discharge capacities of five different S electrodes wherein 5 C is 5 wt. % high surface area C (1700 m² g⁻¹).

FIG. 40 shows galvanostatic plots of NMC-LATSP/60PEO+Li₆PON/LTO-20 wt. % LATSP full cell at room temperature.

FIG. 41 is a schematic of one embodiment of a lithium metal battery having a coating applied to cathode active material.

FIG. 41A is an enlarged view of the cathode of the lithium metal battery of FIG. 41 taken at line 41A-41A.

FIG. 42 is a schematic of another embodiment of a lithium metal battery having a coating applied to cathode active material.

FIG. 42A is an enlarged view of the cathode of the lithium metal battery of FIG. 42 taken at line 42A-42A.

FIG. 43 is a schematic of another embodiment of a lithium metal battery having a coating applied to anode active material.

FIG. 43A is an enlarged view of the anode of the lithium metal battery of FIG. 43 taken at line 43A-43A.

FIG. 44 is a schematic of another embodiment of a lithium metal battery having a coating applied to anode active material.

FIG. 44A is an enlarged view of the anode of the lithium metal battery of FIG. 43 taken at line 43A-43A.

FIG. 45 is a schematic of another embodiment of a lithium metal battery having a coating applied to cathode active material and a coating applied to anode active material.

FIG. 45A is an enlarged view of the cathode of the lithium metal battery of FIG. 45 taken at line 45A-45A.

FIG. 45B is an enlarged view of the anode of the lithium metal battery of FIG. 45 taken at line 45B-45B.

FIG. 46 is a schematic of another embodiment of a lithium metal battery having a coating applied to cathode active material and a coating applied to anode active material.

FIG. 46A is an enlarged view of the cathode of the lithium metal battery of FIG. 46 taken at line 46A-46A.

FIG. 46B is an enlarged view of the anode of the lithium metal battery of FIG. 46 taken at line 46B-46B.

FIG. 47 shows the electrochemical performance of n-LMNO+0 wt. % LiAlO₂/Li (baseline) half-cell, wherein panel (a) is capacity vs. cycle number, panel (b) is energy density vs. capacity, panel (c) is columbic efficiency vs. cycle number, panel (d) is potential vs. cycle number, and panel (e) is potential vs discharge capacity, wherein n-LMNO is nano-size overlithiated Li_{1.26}Mn_{1.5}Ni_{0.5}O₄.

FIG. 48 shows the electrochemical performance of n-LMNO+5 wt. % LiAlO₂/Li half-cell, wherein panel (a) is capacity vs. cycle number, panel (b) is energy density vs. capacity, panel (c) is columbic efficiency vs. cycle number, panel (d) is potential vs. cycle number, and panel (e) is potential vs discharge capacity, wherein n-LMNO is nano-size overlithiated Li_{1.26}Mn_{1.5}Ni_{0.5}O₄.

FIG. 49 shows the electrochemical performance of n-LMNO+10 wt. % LiAlO₂/Li half-cell, wherein panel (a) is capacity vs. cycle number, panel (b) is energy density vs. capacity, panel (c) is columbic efficiency vs. cycle number, panel (d) is potential vs. cycle number, and panel (e) is potential vs discharge capacity, wherein n-LMNO is nano-size overlithiated Li_{1.26}Mn_{1.5}Ni_{0.5}O₄.

FIG. 50 shows the electrochemical performance of n-LMNO+20 wt. % LiAlO₂/Li half-cell wherein panel (a) is capacity vs. cycle number, panel (b) is energy density vs. capacity, panel (c) is columbic efficiency vs. cycle number, panel (d) is potential vs. cycle number, and panel (e) is potential vs discharge capacity, wherein n-LMNO is nano-size overlithiated Li_{1.26}Mn_{1.5}Ni_{0.5}O₄.

### DETAILED DESCRIPTION OF THE INVENTION

Before the present invention is described in further detail, it is to be understood that the invention is not limited to the particular embodiments described. It is also to be understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

It should be apparent to those skilled in the art that many additional modifications beside those already described are possible without departing from the inventive concepts. In interpreting this disclosure, all terms should be interpreted in the broadest possible manner consistent with the context. Variations of the term “comprising”, “including”, or “having” should be interpreted as referring to elements, components, or steps in a non-exclusive manner, so the referenced elements, components, or steps may be combined with other elements, components, or steps that are not expressly referenced. Embodiments referenced as “comprising”, “including”, or “having” certain elements are also contemplated as “consisting essentially of” and “consisting of” those elements, unless the context clearly dictates otherwise. It should be appreciated that aspects of the disclosure that are described with respect to a system are applicable to the methods, and vice versa, unless the context explicitly dictates otherwise.

Numeric ranges disclosed herein are inclusive of their endpoints. For example, a numeric range of between 1 and 10 includes the values 1 and 10. When a series of numeric ranges are disclosed for a given value, the present disclosure expressly contemplates ranges including all combinations of the upper and lower bounds of those ranges. For example, a numeric range of between 1 and 10 or between 2 and 9 is intended to include the numeric ranges of between 1 and 9 and between 2 and 10.

The present invention provides a method of introducing high surface area nanopowders to the surfaces of catholyte and anolyte active materials by a process that can be milling using ultrasonic agitation or ball milling or electrostatic spraying wherein the catholyte or anolyte materials with or without other additives including carbon, and binders are mixed for a period of time such that the active materials become uniformly coated with the nanopowders at mass fractions that enhance the activity and stability of the active materials while also not significantly diminishing their capacities. Thereafter, mixtures of nanoparticles plus active material are formulated in a coating that can include a binder and an electrolyte which can be a liquid or a solid polymer electrolyte or a ceramic thin film electrolyte whose performance itself by the presence of nanoparticle electrolyte results in enhancements measured as extensions of cycle life by 50-200% and improvements in capacities by 5-50% against uncoated materials over similar cycle lives.

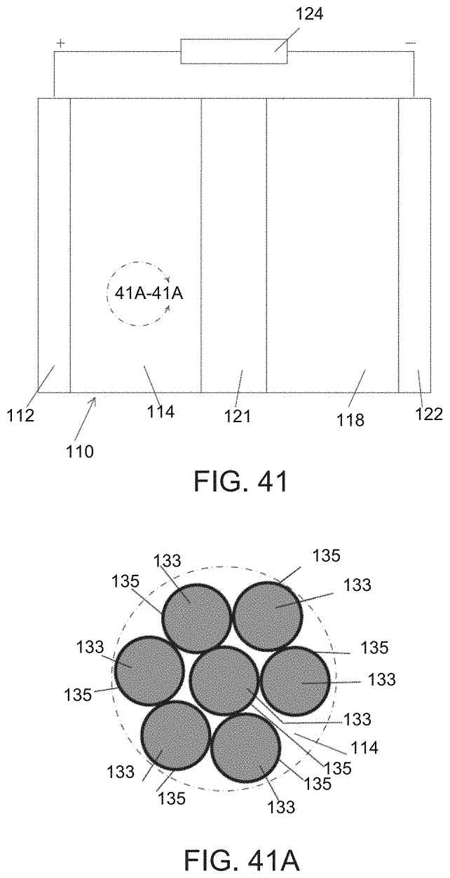

FIG. 41 shows a lithium metal battery 110 according to one non-limiting example embodiment of the present disclosure. The lithium metal battery 110 includes a first current collector 112 (e.g., aluminum) in contact with a cathode 114. A separator 121 is arranged between the cathode 114 and the anode 118, which is in contact with a second current collector 122 (e.g., aluminum). The first and second current collectors 112 and 122 of the lithium metal battery 110 may be in electrical communication with an electrical component 124. The electrical component 124 could place the lithium metal battery 110 in electrical communication with an electrical load that discharges the battery or a charger that charges the battery.

A suitable active material for the cathode 114 of the lithium metal battery 110 is a lithium host material capable of storing and subsequently releasing lithium ions. Looking at FIG. 41A, there is shown an enlarged, schematic illustration of a volume of the cathode 114 of the lithium metal battery 110. The volume of the cathode 114 includes a plurality of particles comprising a porous coating 135 of a solid-state ion conducting electrolyte material on an inner region of a lithium host material 133. The porous coating 135 may have a thickness between about 20 nanometers and about 10 micrometers, or a thickness between about 20 nanometers and about 5 micrometers. The porous coating 135 can comprise particles having an average particle size between 1 and 100 nanometers.

The lithium host material 133 may comprise a lithium host material selected from the group consisting of lithium metal oxides wherein the metal is one or more aluminum, cobalt, iron, manganese, nickel and vanadium; and lithium-containing phosphates having a general formula LiMPO₄ wherein M is one or more of cobalt, iron, manganese, and nickel. The lithium host material 133 may comprise a lithium manganese oxide. The lithium host material 133 may comprise a lithium host material having a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811). The lithium host material 133 may comprise a lithium host material having a formula LiNi_{1-x-y}MnₓAl_{y}O₂ (NMA) wherein x+y+z=1. The lithium host material 133 may comprise a sulfur containing material, such as a material including S₈.

The porous coating 135 may comprise a solid-state ion conducting electrolyte material selected from the group consisting of: (i) lithium aluminum oxides, (ii) lithium containing phosphates, (iii) LiₓPON wherein x is 1, 1.5, 3, or 6, (iv) LiₓSiPON wherein x is 1, 1.5, 3, or 6, (v) LiₓSiON wherein x is 2, 4, or 6, (vi) a ceramic electrolyte material having the formula LiᵤReᵥM_{w}AₓO_{y} wherein Re can be any combination of elements with a nominal valence of +3 including La, Nd, Pr, Pm, Sm, Sc, Eu, Gd, Tb, Dy, Y, Ho, Er, Tm, Yb, and Lu, M can be any combination of metals with a nominal valence of +3, +4, +5 or +6 including Zr, Ta, Nb, Sb, W, Hf, Sn, Ti, V, Bi, Ge, and Si, A can be any combination of dopant atoms with nominal valence of +1, +2, +3 or +4 including H, Na, K, Rb, Cs, Ba, Sr, Ca, Mg, Fe, Co, Ni, Cu, Zn, Ga, Al, B, and Mn, u can vary from 3-7.5, v can vary from 0-3, w can vary from 0-2, x can vary from 0-2; and y can vary from 11-12.5, and (vii) mixtures thereof.

In some aspects, the cathode 114 may include a conductive additive. Many different conductive additives, e.g., Co, Mn, Ni, Cr, Al, or Li, may be substituted or additionally added into the structure to influence electronic conductivity, ordering of the layer, stability on delithiation and cycling performance of the cathode materials. Other suitable conductive additives include silica depleted rice hull ash, graphite, carbon black, acetylene black, Ketjen black, channel black, furnace black, lamp black, thermal black, conductive fibers, metallic powders, conductive whiskers, conductive metal oxides, and mixtures thereof.

In some aspects, the cathode 114 may include a binder. Non-limiting examples of the binder include: polyvinylidene fluoride (PVDF), polyacrylic acid, poly(methylmethacrylate), poly(vinylacetate), polyvinyl alcohol, polyethyleneoxide, polyvinylpyrrolidone, polyvinyl ether, polyvinylchloride, polyacrylonitrile, polyvinylpyridine, styrene-butadiene rubber, acrylonitrile-butadiene rubber, polyethylene, polypropylene, ethylene-propylene-diene terpolymers (EPDM), cellulose, carboxymethylcellulose, starch, hydroxypropylcellulose, and mixtures thereof.

The anode 118 of the lithium metal battery 110 may comprise lithium metal. In one embodiment, the anode 118 of the lithium metal battery 110 consists essentially of lithium metal.

An example material for the separator 121 of the battery 110 can a permeable polymer such as a polyolefin. Example polyolefins include polyethylene, polypropylene, and combinations thereof.

The lithium metal battery 110 includes a liquid electrolyte. The liquid electrolyte may comprise a lithium compound in an organic solvent. The lithium compound may be selected from LiPF₆, LiBF₄, LiClO₄, lithium bis(fluorosulfonyl)imide (LiFSI), LiN(CF₃SO₂)₂ (LiTFSI), and LiCF₃SO₃ (LiTf). The organic solvent may be selected from carbonate based solvents, ether based solvents, ionic liquids, and mixtures thereof. The carbonate based solvent may be selected from the group consisting of dimethyl carbonate, diethyl carbonate, ethyl methyl carbonate, dipropyl carbonate, methylpropyl carbonate, ethylpropyl carbonate, methylethyl carbonate, ethylene carbonate, propylene carbonate, butylene carbonate, and fluoroethylene carbonate; and the ether based solvent is selected from the group consisting of diethyl ether, dibutyl ether, monoglyme, diglyme, tetraglyme, 2-methyltetrahydrofuran, tetrahydrofuran, 1,3-dioxolane, 1,2-dimethoxyethane, and 1,4-dioxane.

The current collector 112 and the current collector 122 can comprise a conductive material. For example, the current collector 112 and the current collector 122 may comprise molybdenum, aluminum, nickel, copper, combinations and alloys thereof or stainless steel.

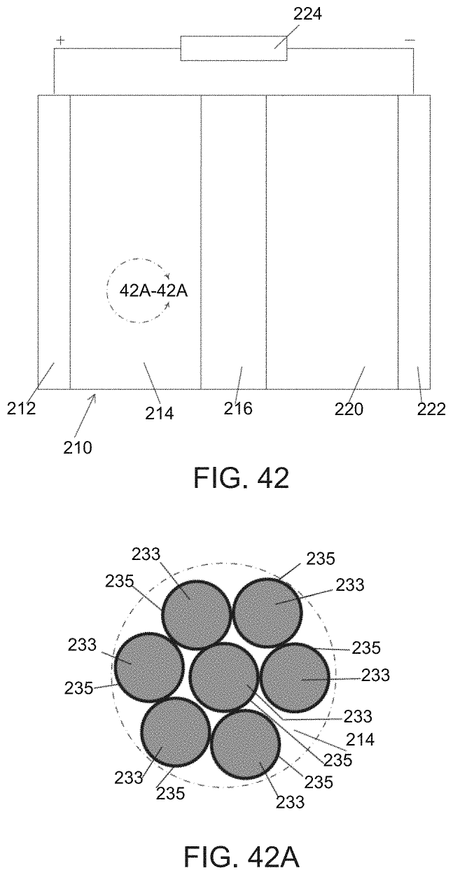

FIG. 42 shows a lithium metal battery 210 according to another non-limiting example embodiment of the present disclosure. The lithium metal battery 210 includes a current collector 212 in contact with a cathode 214. A solid state electrolyte 216 is arranged between the cathode 214 and an anode 220, which is in contact with a second current collector 222 (e.g., aluminum). The current collectors 212 and 222 of the lithium metal battery 210 may be in electrical communication with an electrical component 224. The electrical component 224 could place the lithium metal battery 210 in electrical communication with an electrical load that discharges the battery or a charger that charges the battery.

Looking at FIG. 42A, there is shown an enlarged, schematic illustration of a volume of the cathode 214 of the lithium metal battery 210. The volume of the cathode 214 includes a plurality of particles comprising a porous coating 235 of a solid-state ion conducting electrolyte material on an inner region of a lithium host material 233. The porous coating 235 may have a thickness between about 20 nanometers and about 10 micrometers, or a thickness between about 20 nanometers and about 5 micrometers. The porous coating 235 can comprise particles having an average particle size between 1 and 100 nanometers.

The lithium host material 233 may comprise one or more of the lithium host materials listed above for lithium host material 133. The porous coating 235 may comprise one or more of the solid-state ion conducting electrolyte materials listed above for porous coating 135.

The cathode 214 of the lithium metal battery 210 may include one or more of the conductive additives listed above for battery 110. The cathode 214 of the lithium metal battery 210 may include one or more of the binders listed above for battery 110.

The anode 220 of the lithium metal battery 210 may comprise lithium metal. In one embodiment, the anode 220 of the lithium metal battery 210 consists essentially of lithium metal.

The current collector 212 and the current collector 222 can comprise a conductive material. For example, the current collector 212 and the current collector 222 may comprise molybdenum, aluminum, nickel, copper, combinations and alloys thereof or stainless steel.

The solid state electrolyte 216 of the lithium metal battery 210 can include any solid material capable of storing and transporting Li⁺ ions between the anode 218 and the cathode 214.

One example solid state electrolyte 216 of the lithium metal battery 210 can be a solid polymer electrolyte containing one or more ionically conductive polymers selected from poly(ethylene oxide) (PEO), polypropylene oxide (PPO), polyacrylonitrile (PAN), polyvinyl alcohol (PVA), polymethyl methacrylate (PMMA), polydimethyl siloxane (PDMS), polyvinyl pyrollidone (PVP), LiₓPON wherein x is 1, 1.5, 3, or 6, LiₓSiPON wherein x is 1, 1.5, 3, or 6, LiₓSiON wherein x is 2, 4, or 6, and combinations thereof.

Another suitable solid state electrolyte 216 of the lithium metal battery 210 includes an electrolyte material having the formula LiᵤReᵥM_{w}AₓO_{y}, wherein

Re can be any combination of elements with a nominal valence of +3 including La, Nd, Pr, Pm, Sm, Sc, Eu, Gd, Tb, Dy, Y, Ho, Er, Tm, Yb, and Lu;

M can be any combination of metals with a nominal valence of +3, +4, +5 or +6 including Zr, Ta, Nb, Sb, W, Hf, Sn, Ti, V, Bi, Ge, and Si;

A can be any combination of dopant atoms with nominal valence of +1, +2, +3 or +4 including H, Na, K, Rb, Cs, Ba, Sr, Ca, Mg, Fe, Co, Ni, Cu, Zn, Ga, Al, B, and Mn;

u can vary from 3-7.5;

v can vary from 0-3;

w can vary from 0-2;

x can vary from 0-2; and

y can vary from 11-12.5.

The electrolyte material may be a lithium lanthanum zirconium oxide.

Another example solid state electrolyte 216 can include any combination oxide or phosphate materials with a garnet, perovskite, NaSICON, or LiSICON phase.

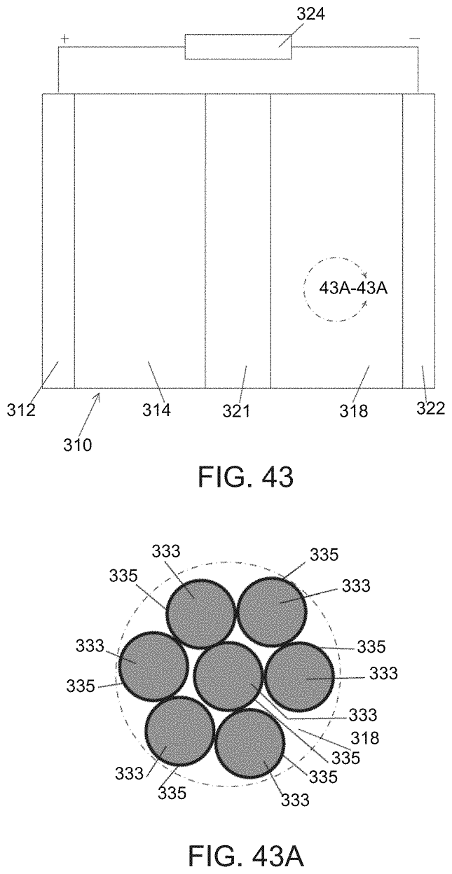

FIG. 43 shows a lithium ion battery 310 according to another non-limiting example embodiment of the present disclosure. The lithium ion battery 310 includes a first current collector 312 (e.g., aluminum) in contact with a cathode 314. A separator 321 is arranged between the cathode 314 and an anode 318, which is in contact with a second current collector 322 (e.g., aluminum). The first and second current collectors 312 and 322 of the lithium ion battery 310 may be in electrical communication with an electrical component 324. The electrical component 324 could place the lithium ion battery 310 in electrical communication with an electrical load that discharges the battery or a charger that charges the battery.

Looking at FIG. 43A, there is shown an enlarged, schematic illustration of a volume of the anode 318 of the lithium ion battery 310. The volume of the anode 318 includes a plurality of particles comprising a porous coating 335 of a solid-state ion conducting electrolyte material on an inner region of a lithium host material 333. The porous coating 335 may have a thickness between about 20 nanometers and about 10 micrometers, or a thickness between about 20 nanometers and about 5 micrometers. The porous coating 335 can comprise particles having an average particle size between 1 and 100 nanometers.

The lithium host material 333 may comprise one or more lithium host materials selected from lithium titanium oxide (Li₄Ti₅O₁₂, LTO), silicon-containing materials, such as silicon (e.g., silicene), silicon carbides (e.g., SiC), silicon nitrides (Si₃N₄), silicon nitride oxides (e.g., Si₂N₂O), and high entropy oxides (e.g., (Co_{0.2}Cu_{0.2}Mg_{0.2}Ni_{0.2}Zn_{0.2})O).

The porous coating 335 may comprise one or more of the solid-state ion conducting electrolyte materials listed above for porous coating 135.

An example cathode active material for the cathode 314 is a lithium metal oxide wherein the metal is one or more aluminum, cobalt, iron, manganese, nickel and vanadium. Non-limiting example lithium metal oxides are LiCoO₂ (LCO), LiFeO₂, LiMnO₂ (LMO), LiMn₂O₄, LiNiO₂ (LNO), LiNiₓCo_{y}O₂, LiMnₓCo_{y}O₂, LiMnₓNi_{y}O₂, LiMnₓNi_{y}O₄, LiNiₓCo_{y}Al_{z}O₂ (NCA), LiNi_{1/3}Mn_{1/3}Co_{1/3}O₂ and others. Another example of a cathode active material is a lithium-containing phosphate having a general formula LiMPO₄ wherein M is one or more of cobalt, iron, manganese, and nickel, such as lithium iron phosphate (LFP) and lithium iron fluorophosphates. The cathode can comprise a cathode active material having a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811). The cathode can comprise a cathode active material having a formula LiNi_{1-x-y}MnₓAl_{y}O₂ (NMA) wherein x+y+z=1. Another example of a cathode active material is porous carbon (for a lithium air battery). Another example of a cathode active material is a sulfur containing material (for a lithium sulfur battery). The cathode active material can be a mixture of any number of these cathode active materials.

The cathode 314 of the lithium ion battery 310 may include one or more of the conductive additives listed above for battery 110. The cathode 314 of the lithium ion battery 310 may include one or more of the binders listed above for battery 110.

An example material for the separator 321 of the lithium ion battery 310 can a permeable polymer such as a polyolefin. Example polyolefins include polyethylene, polypropylene, and combinations thereof.

The lithium ion battery 310 includes a liquid electrolyte. The liquid electrolyte may comprise any of the liquid electrolytes listed above for battery 110.

The current collector 312 and the current collector 322 can comprise a conductive material. For example, the current collector 312 and the current collector 322 may comprise molybdenum, aluminum, nickel, copper, combinations and alloys thereof or stainless steel.

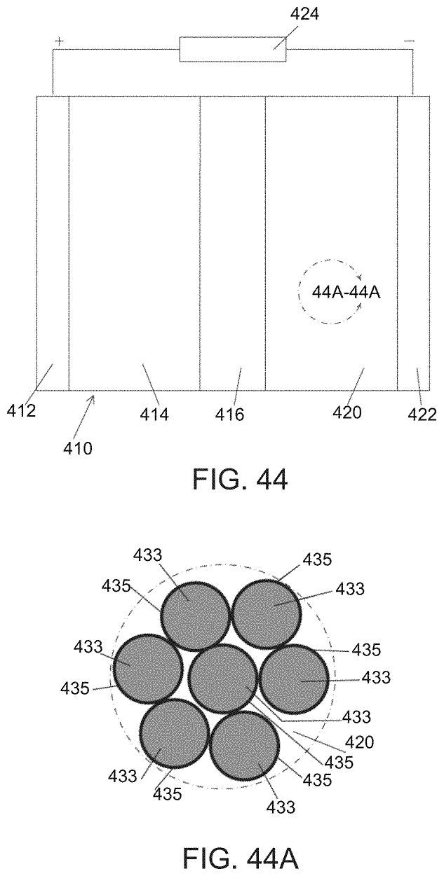

FIG. 44 shows a lithium ion battery 410 according to another non-limiting example embodiment of the present disclosure. The lithium ion battery 410 includes a current collector 412 in contact with a cathode 414. A solid state electrolyte 416 is arranged between the cathode 414 and an anode 420, which is in contact with a second current collector 422 (e.g., aluminum). The current collectors 412 and 422 of the lithium ion battery 410 may be in electrical communication with an electrical component 424. The electrical component 424 could place the lithium ion battery 410 in electrical communication with an electrical load that discharges the battery or a charger that charges the battery.

Looking at FIG. 44A, there is shown an enlarged, schematic illustration of a volume of the anode 418 of the lithium ion battery 410. The volume of the anode 418 includes a plurality of particles comprising a porous coating 435 of a solid-state ion conducting electrolyte material on an inner region of a lithium host material 433. The porous coating 435 may have a thickness between about 20 nanometers and about 10 micrometers, or a thickness between about 20 nanometers and about 5 micrometers. The porous coating 435 can comprise particles having an average particle size between 1 and 100 nanometers.

The lithium host material 433 may comprise one or more lithium host materials selected from lithium titanium oxide (Li₄Ti₅O₁₂, LTO), silicon-containing materials, such as silicon (e.g., silicene), silicon carbides (e.g., SiC), silicon nitrides (Si₃N₄), silicon nitride oxides (e.g., Si₂N₂O), and high entropy oxides (e.g., (Co_{0.2}Cu_{0.2}Mg_{0.2}Ni_{0.2}Zn_{0.2})O).

The porous coating 435 may comprise one or more of the solid-state ion conducting electrolyte materials listed above for porous coating 135.

An example cathode active material for the cathode 414 is a cathode active material listed above for battery 310.

The cathode 414 of the lithium ion battery 410 may include one or more of the conductive additives listed above for battery 110. The cathode 414 of the lithium ion battery 410 may include one or more of the binders listed above for battery 110.

The solid state electrolyte 416 of the lithium ion battery 410 can include one or more of the solid state electrolytes listed above for battery 210.

The current collector 412 and the current collector 422 can comprise a conductive material. For example, the current collector 412 and the current collector 422 may comprise molybdenum, aluminum, nickel, copper, combinations and alloys thereof or stainless steel.

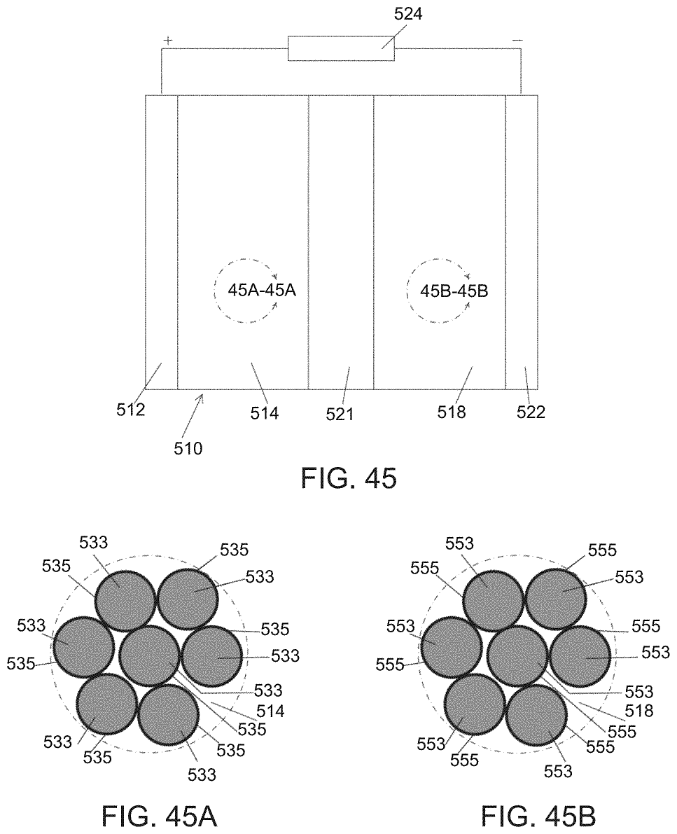

FIG. 45 shows a lithium ion battery 510 according to another non-limiting example embodiment of the present disclosure. The lithium ion battery 510 includes a first current collector 512 (e.g., aluminum) in contact with a cathode 514. A separator 521 is arranged between the cathode 514 and an anode 518, which is in contact with a second current collector 522 (e.g., aluminum). The first and second current collectors 512 and 522 of the lithium ion battery 510 may be in electrical communication with an electrical component 524. The electrical component 524 could place the lithium ion battery 510 in electrical communication with an electrical load that discharges the battery or a charger that charges the battery.

Looking at FIG. 45A, there is shown an enlarged, schematic illustration of a volume of the cathode 514 of the lithium ion battery 510. The volume of the cathode 514 includes a plurality of particles comprising a porous coating 535 of a solid-state ion conducting electrolyte material on an inner region of a lithium host material 533. The porous coating 535 may have a thickness between about 20 nanometers and about 10 micrometers, or a thickness between about 20 nanometers and about 5 micrometers. The porous coating 535 can comprise particles having an average particle size between 1 and 100 nanometers.

The lithium host material 533 may comprise one or more of the lithium host materials listed above for lithium host material 133. The porous coating 535 may comprise one or more of the solid-state ion conducting electrolyte materials listed above for porous coating 135.

The cathode 514 may include one or more of the conductive additives listed above for battery 110. The cathode 514 may include one or more of the binders listed above for battery 110.

Looking at FIG. 45B, there is shown an enlarged, schematic illustration of a volume of the anode 518 of the lithium ion battery 510. The volume of the anode 518 includes a plurality of particles comprising a porous coating 555 of a solid-state ion conducting electrolyte material on an inner region of a lithium host material 553. The porous coating 555 may have a thickness between about 20 nanometers and about 10 micrometers, or a thickness between about 20 nanometers and about 5 micrometers. The porous coating 555 can comprise particles having an average particle size between 1 and 100 nanometers.

The lithium host material 553 may comprise one or more of the lithium host materials listed above for lithium host material 333.

The porous coating 555 may comprise one or more of the solid-state ion conducting electrolyte materials listed above for porous coating 135.

An example material for the separator 521 of the lithium ion battery 510 can a permeable polymer such as a polyolefin. Example polyolefins include polyethylene, polypropylene, and combinations thereof.

The lithium ion battery 510 includes a liquid electrolyte. The liquid electrolyte may comprise any of the liquid electrolytes listed above for battery 110.

The current collector 512 and the current collector 522 can comprise a conductive material. For example, the current collector 512 and the current collector 522 may comprise molybdenum, aluminum, nickel, copper, combinations and alloys thereof or stainless steel.

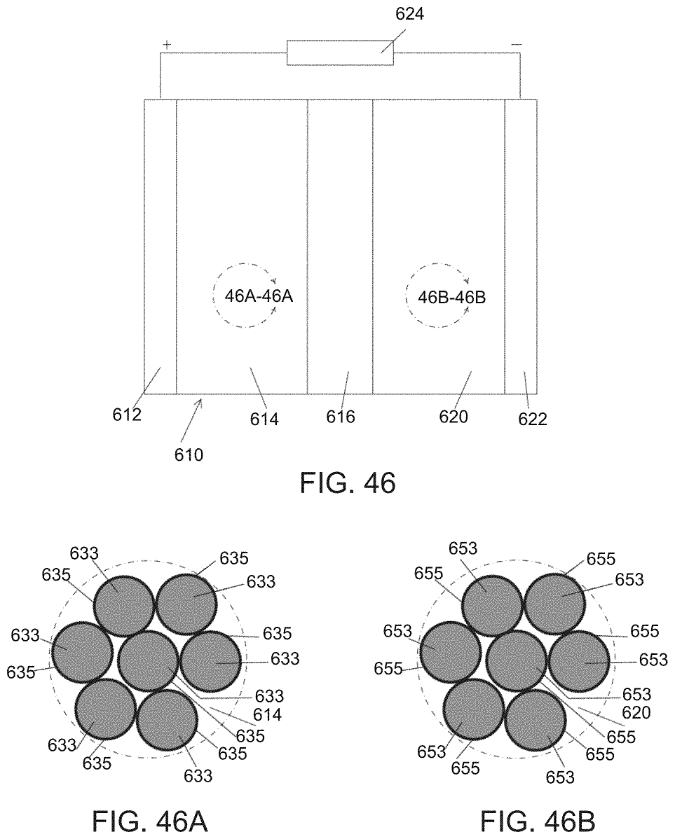

FIG. 46 shows a lithium ion battery 610 according to another non-limiting example embodiment of the present disclosure. The lithium ion battery 610 includes a current collector 612 in contact with a cathode 614. A solid state electrolyte 616 is arranged between the cathode 614 and an anode 620, which is in contact with a second current collector 622 (e.g., aluminum). The current collectors 612 and 622 of the lithium ion battery 610 may be in electrical communication with an electrical component 624. The electrical component 624 could place the lithium ion battery 610 in electrical communication with an electrical load that discharges the battery or a charger that charges the battery.

Looking at FIG. 46A, there is shown an enlarged, schematic illustration of a volume of the cathode 614 of the lithium ion battery 610. The volume of the cathode 614 includes a plurality of particles comprising a porous coating 635 of a solid-state ion conducting electrolyte material on an inner region of a lithium host material 633. The porous coating 635 may have a thickness between about 20 nanometers and about 10 micrometers, or a thickness between about 20 nanometers and about 5 micrometers. The porous coating 635 can comprise particles having an average particle size between 1 and 100 nanometers.

The lithium host material 633 may comprise one or more of the lithium host materials listed above for lithium host material 133. The porous coating 635 may comprise one or more of the solid-state ion conducting electrolyte materials listed above for porous coating 135.

The cathode 614 may include one or more of the conductive additives listed above for battery 110. The cathode 614 may include one or more of the binders listed above for battery 110.

Looking at FIG. 45B, there is shown an enlarged, schematic illustration of a volume of the anode 618 of the lithium ion battery 610. The volume of the anode 618 includes a plurality of particles comprising a porous coating 655 of a solid-state ion conducting electrolyte material on an inner region of a lithium host material 653. The porous coating 655 may have a thickness between about 20 nanometers and about 10 micrometers, or a thickness between about 20 nanometers and about 5 micrometers. The porous coating 655 can comprise particles having an average particle size between 1 and 100 nanometers.

The lithium host material 653 may comprise one or more of the lithium host materials listed above for lithium host material 333.

The porous coating 655 may comprise one or more of the solid-state ion conducting electrolyte materials listed above for porous coating 135.

The solid state electrolyte 616 of the lithium ion battery 610 can include one or more of the solid state electrolytes listed above for battery 210.

The current collector 612 and the current collector 622 can comprise a conductive material. For example, the current collector 612 and the current collector 622 may comprise molybdenum, aluminum, nickel, copper, combinations and alloys thereof or stainless steel.

### EXAMPLES

The following Examples are provided in order to demonstrate and further illustrate certain embodiments and aspects of the present invention and are not to be construed as limiting the scope of the invention.

Given all of the above anticipated issues with porous coatings, it is counterintuitive to envision that porous coatings on active battery components can actually provide much superior cell performance when the coating material comprises nanopowders coated by simple (ultrasonic or ball) milling (or electrospray coating) at contents of from 5-30 wt. %. In some instances, the coating does not actually have to have Li⁺ content to promote superior properties.

The following Examples demonstrate that the introduction of lithium ion conducting nanopowders to both cathode and anode materials in the form of imperfect (porous) but uniform coatings provide enhanced performance and/or reduced degradation during cycling to voltages normal for that active material. Another important point is that these coatings can be made by simple ball milling for example which is easily scalable and cost effective as opposed to gas phase coating techniques.

### Example 1—Coatings on Cathodes—LMNO

### 1. Overview of Example 1

In Example 1, a lithium manganese oxide (LMNO) powder (Li_{1.1}Mn_{1.5}Ni_{0.5}O₄ from Nano One) was coated with nano-size particles of Al₂O₃, Li₇La₃Zr₂O₁₂ (LLZO), LiAlO₂, and Li_{1.7}Al_{0.3}Ti_{1.7}Si_{0.4}P_{2.6}O₁₂, a lithium-aluminum-titanium-silicon-phosphate (LATSP). Lithium-aluminum-titanium-silicon-phosphates have a general composition Li_{1+x+y}AlₓTi₂₋ₓSi_{y}P_{3-y}O₁₂ wherein 0≤x≤1 and 0≤y≤1. Unlike most coating processes, the method involved the use of a soft and scalable ball milling technique in which 5-20 wt. % of the active and inactive nanoparticles were introduced to LMNO just before electrode fabrication. The Li_{1.1}Mn_{1.5}Ni_{0.5}O₄ (Nano One) powder and carbon black (C-65 having a primary particle size less than 50 nm.) were heated to 100° C./24 hours/vacuum. The electrode slurries were prepared by mixing Li_{1.1}Mn_{1.5}Ni_{0.5}O₄ (60-80 wt. %), C65 (5-10 wt. %), nanoparticles (5-20 wt. %), and polyvinylidene fluoride (PVDF) (10 wt. %) in 1-methyl pyrrolidin-2-one. The mixtures were then ball-milled for 24-48 hours using ZrO₂ beads (3 mm, 6 g). The slurries were then coated on Al foil.

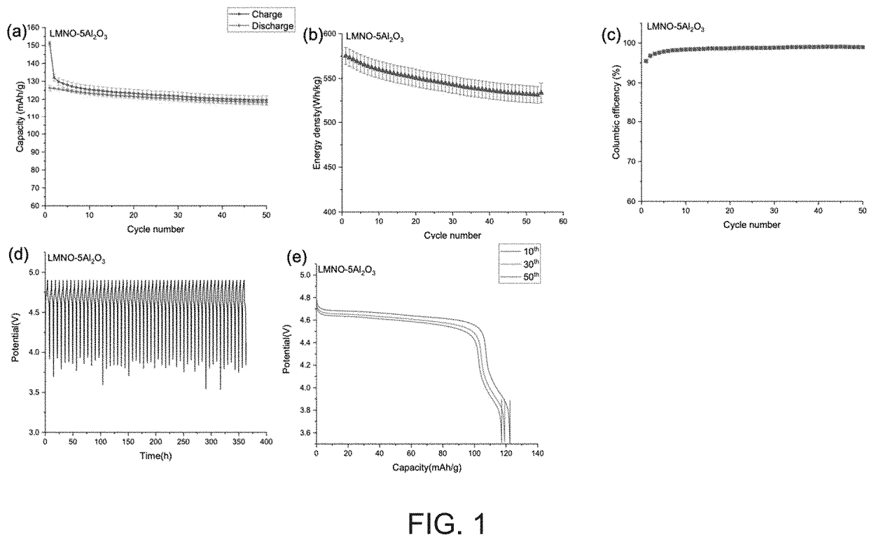

Half-cells were assembled using LMNO (Li_{1.1}Mn_{1.5}Ni_{0.5}O₄)+5 wt. % Al₂O₃, LiAlO₂, LLZO, or LATSP (Li_{1.7}Al_{0.3}Ti_{1.7}Si_{0.4}P_{2.6}O₁₂) nanoparticles as the catholyte, lithium metal as the anode, and Celgard polypropylene membrane (25 μm) as a separator. For initial studies, the electrolyte system was 1.1 M LiPF₆ mixed solvent (1:1:1 wt. % ratio) EC:DEC:EMC with 10 wt. % fluoroethylene carbonate (FEC). Before cell assembly, the metallic Li (16 mm W×750 μm T) was scraped to expose a clean surface. The 2032 coin cells were compressed using a ˜0.1 kpsi uniaxial pressure. The electrochemical values of three half-cells were averaged as shown in FIGS. 1-6.

FIG. 1 shows the electrochemical performance of LMNO (Li_{1.1}Mn_{1.5}Ni_{0.5}O₄)−5 wt. % Al₂O₃/Li half-cell; panel (a) is Capacity vs. cycle number, panel (b) is Energy density vs. capacity, panel (c) is Columbic efficiency vs. cycle number, panel (d) is Potential vs. cycle number, and panel (e) is Potential vs discharge capacity. FIG. 1 shows galvanostatic cycling of the LMNO (Li_{1.1}Mn_{1.5}Ni_{0.5}O₄)−5 wt. % Al₂O₃/Li half-cell between 3.5-4.9V at 0.3 C. The potential vs. time profile shows that the half-cell cycled to the targeted potentials with minimal polarization and IR drop for 350 hours. The potential vs. capacity plot shows that the half-cell maintained flat discharge plateaus of ˜4.7 V, attributed to the redox of Ni. The potential profile also showed a shoulder ˜4 V attributed to redox of Mn.

The half-cell shows an initial charge capacity of 150 mAh/g at 0.3 C. The discharge capacity gradually decreases to 120 mAh/g after 50 cycles (FIG. 1, panel e). The LMNO (Li_{1.1}Mn_{1.5}Ni_{0.5}O₄)−5 wt. % Al₂O₃/Li half-cell showed an average discharge energy density of ˜550 Wh/kg (FIG. 1 panel b). The half-cell also demonstrates optimal columbic efficiency ˜99%.

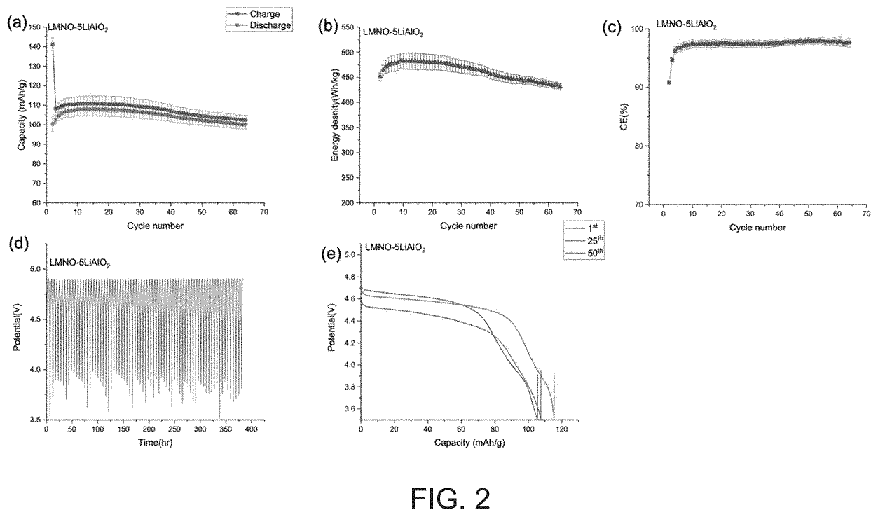

FIG. 2 shows the electrochemical performance of LMNO (Li_{1.1}Mn_{1.5}Ni_{0.5}O₄)−5 wt. % LiAlO₂/Li half-cell; panel (a) is Capacity vs. cycle number, panel (b) is Energy density vs. capacity, panel (c) is Columbic efficiency vs. cycle number, panel (d) is Potential vs. cycle number, and panel (e) is Potential vs discharge capacity. FIG. 2 shows galvanostatic cycling of the LMNO (Li_{1.1}Mn_{1.5}Ni_{0.5}O₄)−5 wt. % LiAlO₂/Li half-cell between 3.5-4.9V at 0.3 C. The potential vs. time profile shows that the half-cell cycled to the targeted potentials with minimal polarization and IR drop for 375 hours. The half-cell shows an initial charge capacity of 140 mAh/g at 0.3 C. The discharge capacity gradually decreases to 105 mAh/g after 65 cycles. The LMNO (Li_{1.1}Mn_{1.5}Ni_{0.5}O₄)−5 wt. % LiAlO₂/Li half-cell showed an average discharge energy density of ˜450 Wh/kg. The half-cell also demonstrates optimal columbic efficiency ˜97%.

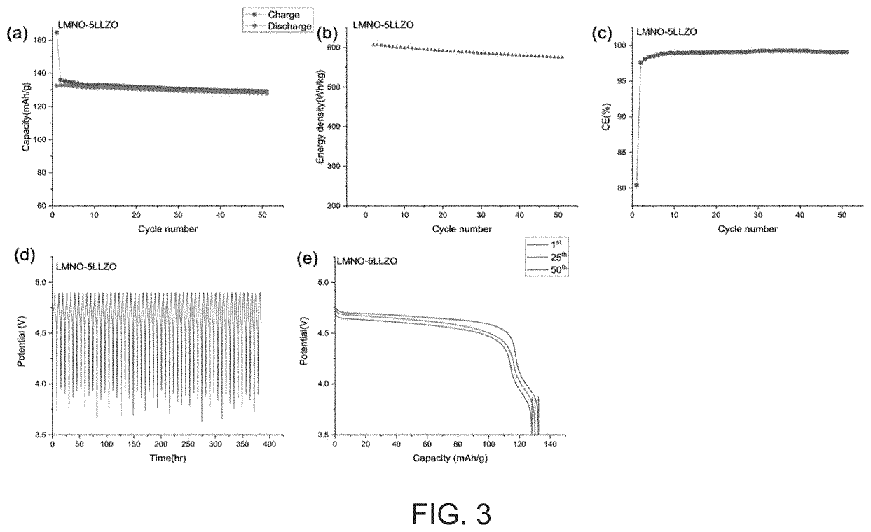

FIG. 3 shows the electrochemical performance of LMNO (Li_{1.1}Mn_{1.5}Ni_{0.5}O₄)−5 wt. % LLZO/Li half-cell; panel (a) is Capacity vs. cycle number, panel (b) is Energy density vs. capacity, panel (c) is Columbic efficiency vs. cycle number, panel (d) is Potential vs. cycle number, and panel (e) is Potential vs discharge capacity. FIG. 3 shows galvanostatic cycling of the LMNO (Li_{1.1}Mn_{1.5}Ni_{0.5}O₄)−5 wt. % LLZO/Li half-cell between 3.5-4.9V at 0.3 C. The half-cell shows an initial charge capacity of ˜160 mAh/g at 0.3 C. The discharge capacity gradually decreases to 130 mAh/g after 50 cycles (FIG. 3 panel e). The LMNO (Li_{1.1}Mn_{1.5}Ni_{0.5}O₄)−5 wt. % LLZO/Li half-cell showed an average discharge energy density of ˜600 Wh/kg (FIG. 3 panel b). The half-cell also demonstrates optimal columbic efficiency ˜98%.

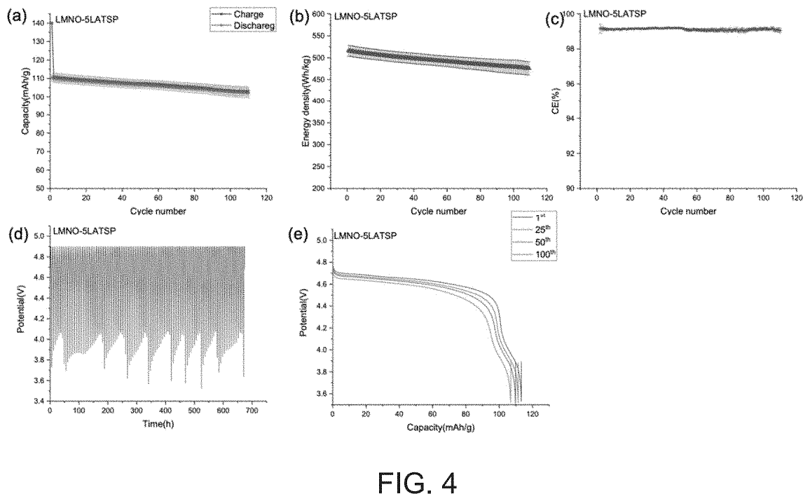

FIG. 4 shows the electrochemical performance of LMNO (Li_{1.1}Mn_{1.5}Ni_{0.5}O₄)−5 wt. % LATSP (Li_{1.7}Al_{0.3}Ti_{1.7}Si_{0.4}P_{2.6}O₁₂)/Li half-cell; panel (a) is Capacity vs. cycle number, panel (b) is Energy density vs. capacity, panel (c) is Columbic efficiency vs. cycle number, panel (d) is Potential vs. cycle number, and panel (e) is Potential vs discharge capacity.

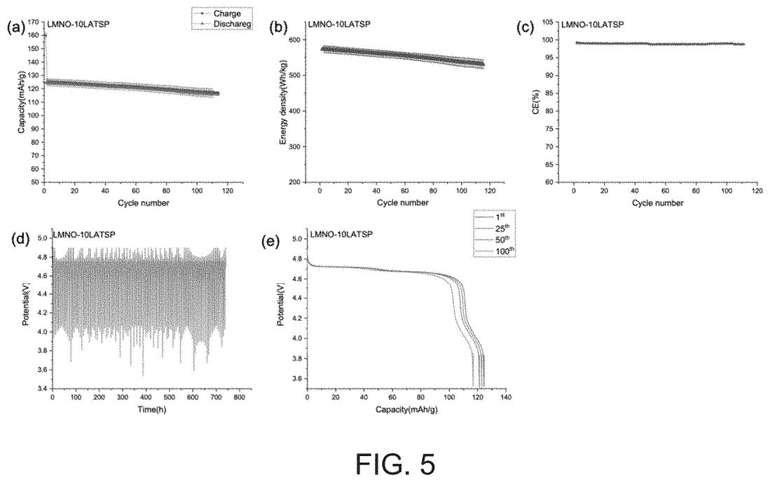

FIG. 5 shows the electrochemical performance of LMNO (Li_{1.1}Mn_{1.5}Ni_{0.5}O₄)−10 wt. % LATSP (Li_{1.7}Al_{0.3}Ti_{1.7}Si_{0.4}P_{2.6}O₁₂)/Li half-cell; panel (a) is Capacity vs. cycle number, panel (b) is Energy density vs. capacity, panel (c) is Columbic efficiency vs. cycle number, panel (d) is Potential vs. cycle number, and panel (e) is Potential vs discharge capacity.

FIGS. 4 and 5 show galvanostatic cycling of the LMNO (Li_{1.1}Mn_{1.5}Ni_{0.5}O₄)−5 wt. % LATSP (Li_{1.7}Al_{0.3}Ti_{1.7}Si_{0.4}P_{2.6}O₁₂) and LMNO (Li_{1.1}Mn_{1.5}Ni_{0.5}O₄)−10 wt. % LATSP (Li_{1.7}Al_{0.3}Ti_{1.7}Si_{0.4}P_{2.6}O₁₂)/Li half-cell between 3.5-4.9V at 0.3 C, respectively. The potential vs. time profiles shows that both half-cells cycled to the targeted potentials with minimal polarization and IR drop for 750 hours. The LMNO (Li_{1.1}Mn_{1.5}Ni_{0.5}O₄) half-cells assembled with 5 wt. % and 10 wt. % LATSP (Li_{1.7}Al_{0.3}Ti_{1.7}Si_{0.4}P_{2.6}O₁₂) show an initial charge capacity of ˜140 and 160 mAh/g at 0.3 C, respectively. The discharge capacities gradually decrease to 110 and 125 mAh/g after 110 cycles (FIG. 4 panel e and FIG. 5 panel e).

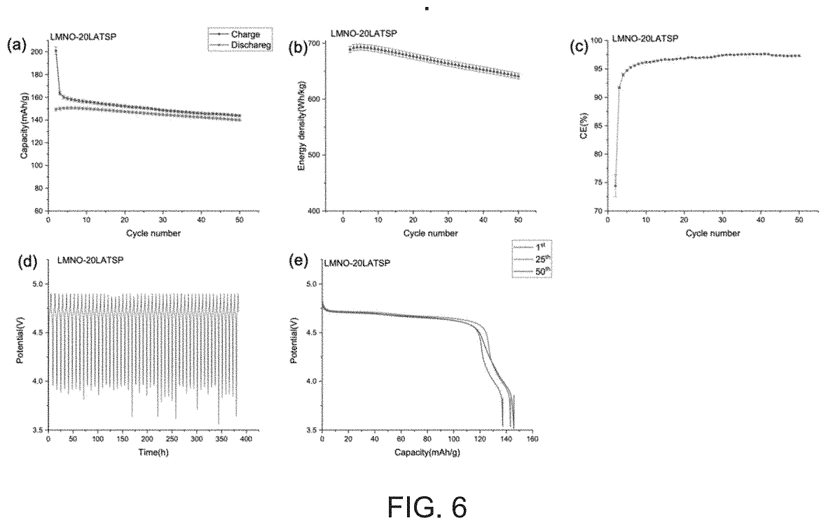

FIG. 6 shows the electrochemical performance of LMNO (Li_{1.1}Mn_{1.5}Ni_{0.5}O₄)−20 wt. % LATSP (Li_{1.7}Al_{0.3}Ti_{1.7}Si_{0.4}P_{2.6}O₁₂)/Li half-cell; panel (a) is Capacity vs. cycle number, panel (b) is Energy density vs. capacity, panel (c) is Columbic efficiency vs. cycle number, panel (d) is Potential vs. cycle number, and panel (e) is Potential vs discharge capacity. FIG. 6 shows galvanostatic cycling of the LMNO (Li_{1.1}Mn_{1.5}Ni_{0.5}O₄)−20 wt. % LATSP (Li_{1.7}Al_{0.3}Ti_{1.7}Si_{0.4}P_{2.6}O₁₂)/Li half-cell between 3.5-4.9V at 0.3 C. The half-cell shows an initial charge capacity of ˜200 mAh/g at 0.3 C. The discharge capacity gradually decreases to 140 mAh/g after 50 cycles (FIG. 6 panel e). The LMNO (Li_{1.1}Mn_{1.5}Ni_{0.5}O₄)−20 wt. % LATSP (Li_{1.7}Al_{0.3}Ti_{1.7}Si_{0.4}P_{2.6}O₁₂)/Li half-cell showed an average discharge energy density of ˜650 Wh/kg after 50 cycles (FIG. 6 panel b). This value is higher than what is reported for pristine LMNO (600 Wh/kg). The half-cell also demonstrates optimal columbic efficiency ˜97%. The energy density of LMNO increased with increasing LATSP content.

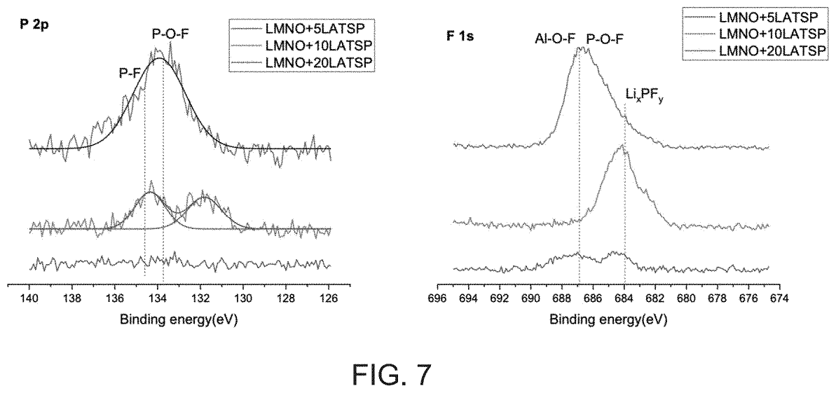

The core scan of LMNO (Li_{1.1}Mn_{1.5}Ni_{0.5}O₄)−10 wt. % LATSP (Li_{1.7}Al_{0.3}Ti_{1.7}Si_{0.4}P_{2.6}O₁₂) electrode after 100 cycles shows the presence of double P 2p peaks centered at 132 and 135 eV corresponding to the presence of P—O—F and P—F bonds (FIG. 7). The formation of P—O—F in the form of LiₓPO_{y}F_{z} is further supported by the F1s. The binding energy (BE) of the P 2p core peak is 138.2 eV for LiPF₆ [Ref. 20]. The observed P 2p peak for the cycled LMNO (Li_{1.1}Mn_{1.5}Ni_{0.5}O₄)-LATSP (Li_{1.7}Al_{0.3}Ti_{1.7}Si_{0.4}P_{2.6}O₁₂) electrode is slightly lower than what is reported for the electrolyte salt in the electrode surface. Hence, the presence of the P 2p peak could also be attributed to the presence of LATSP (Li_{1.7}Al_{0.3}Ti_{1.7}Si_{0.4}P_{2.6}O₁₂) electrolyte.

However, it is worth noting that a shift can be observed between the BEs measured for pure salts, and the BEs measured for small amounts of lithium salts at the electrodes' surfaces. This phenomenon is due to the XPS differential charging effect induced by the presence of insulating species at the surfaces of conducting electrodes.

FIG. 7 shows an XPS core level spectra of P 2p (left) and F 1s (right) for LMNO (Li_{1.1}Mn_{1.5}Ni_{0.5}O₄)+5-20 wt. % LATSP (Li_{1.7}Al_{0.3}Ti_{1.7}Si_{0.4}P_{2.6}O₁₂) electrode after 100 cycles.

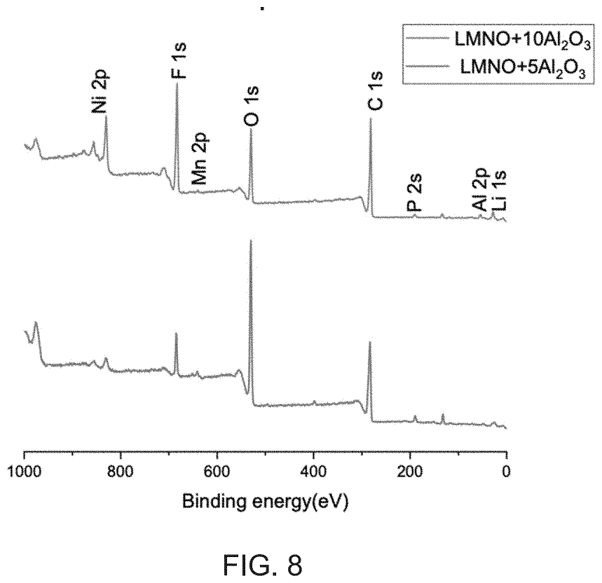

FIG. 8 shows a wide-scan survey XPS spectra of LMNO (Li_{1.1}Mn_{1.5}Ni_{0.5}O₄)+5-10 wt. % Al₂O₃ electrodes after 100 cycles.

FIG. 8 shows XPS spectra of LMNO (Li_{1.1}Mn_{1.5}Ni_{0.5}O₄)+5-10 wt. % Al₂O₃ electrodes after 100 cycles. The electrodes mainly show five elements (Ni, Mn, C, O, and Li). The LMNO (Li_{1.1}Mn_{1.5}Ni_{0.5}O₄)+Al₂O₃ electrode also shows signature peak of Al (Table A).

TABLE A
XPS analysis of LMNO + Al₂O₃ electrode after cycling.

| | Binding energy | LMNO- | LMNO- |
|---|---|---|---|
| Elements | (eV) | 5Al₂O₃ | 10Al₂O₃ |
| Ni 2p | 854 | 0.1 | 0.2 |
| F 1s | 684 | 3.1 | 8.0 |
| Mn 2p | 642 | 0.1 | 0.04 |
| O 1s | 530 | 23.1 | 8.8 |
| C 1s | 284 | 50 | 39.2 |
| P 2p | 133 | 3.3 | 1.5 |
| Al 2p | 73 | 0.6 | 3.2 |
| Li 1s | 58 | 19.6 | 39.1 |

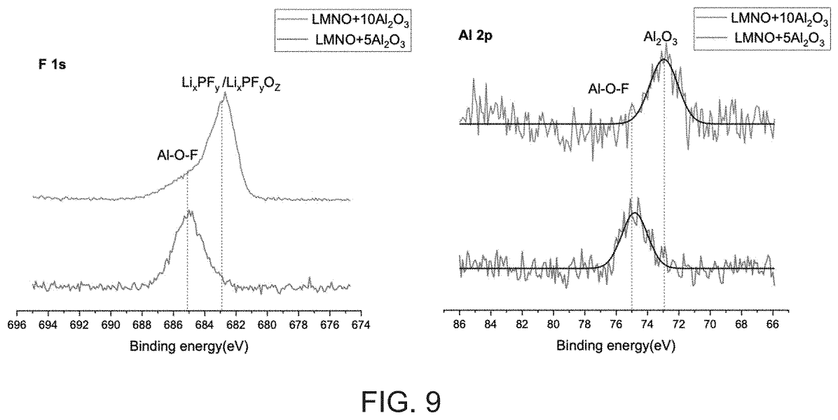

FIG. 9 shows an XPS core level spectra of F 1s (left) and Al 2p (right) for LMNO (Li_{1.1}Mn_{1.5}Ni_{0.5}O₄)+5-10 wt. % Al₂O₃ electrode after 100 cycles.

The Al 2p spectra shows an unexpected trend. The symmetric peak centered at ˜73 eV for the LMNO (Li_{1.1}Mn_{1.5}Ni_{0.5}O₄)−10 wt. % Al₂O₃ is characteristic of LiAlO₂, indicating the lithiation of alumina after extensive cycling. The binding energy shifts to higher values on cycling for LMNO (Li_{1.1}Mn_{1.5}Ni_{0.5}O₄)−5 wt. % Al₂O₃(FIG. 9). This increase is likely indicative of the partial fluorination of Al₂O₃. The binding energy of AlF₃ appears between 77.2 and 77.5 eV depending on the AlF₃ structure [Ref. 21]. This binding energy is much higher than the value found here at 75 eV indicating a mixed oxy-fluoride.

The mechanism of substitution proposed by Van Landschoot et al. [Ref. 22] is:

Al₂O₃+2HF→Al₂O₂F₂+H₂O

and further reaction with HF leads to Al₂OF₄ and ultimately AlF₃. Based on the Al 2p binding energy value ˜75 eV, we would expect that only Al₂O₂F₂ forms. The full transformation of Al₂O₃ into fluorinated species is not achieved after 100 cycles for Al₂O₃ (10 wt. %) coated electrodes as the Al—O²⁻ signal at 73 eV is still seen. We, therefore, expect that the full fluorination to AlF₃ requires a much larger number of cycles, thus indicating that nano-Al₂O₃ is a long-standing protective coating.

### Example 2—Coatings on Cathodes—NMC

Half-cells were assembled using LiNiₓMn_{y}Co_{z}O₂, wherein x+y+z=1 and x:y:z=6:2:2 (NMC 622)+5 wt. %, 10 wt. %, and 20 wt. % LATSP (Li_{1.7}Al_{0.3}Ti_{1.7}Si_{0.4}P_{2.6}O₁₂) as catholyte, lithium metal as the anode, and Celgard polypropylene membrane (25 μm) as a separator. For initial studies, the electrolyte system was 1.1 M LiPF₆ mixed solvent (1:1:1 wt. % ratio) ethylene carbonate (EC), dimethyl carbonate (DMC), and ethyl methyl carbonate (EMC) with 10 wt. % fluoroethylene carbonate (FEC). Before cell assembly, the metallic Li (16 mm W×750 μm T) was scraped to expose a clean surface. The 2032 coin cells were compressed using a ˜0.1 kpsi uniaxial pressure.

FIG. 7 shows galvanostatic cycling of the NMC 622 (5-20 wt. %) LATSP (Li_{1.7}Al_{0.3}Ti_{1.7}Si_{0.4}P_{2.6}O₁₂)/Li half-cell between 2.7-4.2 V at selected C-rates. The NMC 622 half-cells assembled with 5, wt. % 10 wt. %, and 20 wt. % LATSP (Li_{1.7}Al_{0.3}Ti_{1.7}Si_{0.4}P_{2.6}O₁₂) show discharge capacities of 152, 150, and 138 mAh/g after 20 cycles at 0.5 C. The specific capacity of NMC 622 increased with increasing LATSP content at faster C-rate (1 C). To further examine the stability of the surface modification, we can cycle the half-cells at high temperatures (55-60° C.) and higher potentials (4.3-4.6 V).

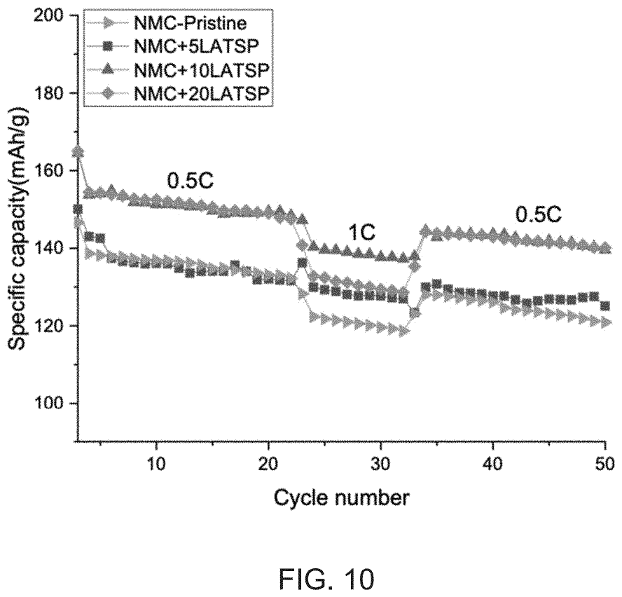

FIG. 10 shows the electrochemical performance of a NMC 622 (5 wt. %-20 wt. %) LATSP (Li_{1.7}Al_{0.3}Ti_{1.7}Si_{0.4}P_{2.6}O₁₂)/Li half-cell.

### Example 3—Coatings on Anodes—Nanopowder Coatings on Li₄Ti₅O₁₂ (LTO)

### 1. Overview of Example 3

Lithium-ion batteries (LIBs) are used extensively in electronics, electric vehicles, stationary power storage, and a multitude of related renewable energy applications attributed to their high energy and power densities [Ref. 31,32]. However, in current designs, LIBs based on commercial carbonaceous anode materials cannot meet the fast charge capabilities required for many large-scale applications due to serious safety problems associated with high charge/discharge rates [Ref. 33,34]. Given the low galvanostatic potential (˜0 vs Li⁺/Li) of current graphitic anodes, [Ref. 35,36] higher charging rates may cause (especially uneven) lithium plating generating internal short-circuits leading to catastrophic failure of traditional LIBs [Ref. 7,8]. Thus, to enable fast charging and improve LIB safety; numerous noncarbonaceous anodes have been explored [Ref. 39-41]. Among the possible alternate anode materials, lithium titanium oxides, such as Li₄Ti₅O₁₂ (LTO), have been considered very promising due to excellent thermal stability, high structural stability, good cyclability at high current densities, and negligible irreversible capacity [Ref. 42-44].

Spinel LTO anodes can facilitate up to three Li⁺ ions per formula unit and deliver theoretical capacities ˜175 mAh g⁻¹ without significant volume changes (<1%) when cycled [Ref. 45-47]. Graphite anodes in contrast expand up to 10 vol % during charging [Ref. 42]. This negligible volume change (zero-strain) property of LTO provides high structural stability, potentially enabling high charge/discharge rates thereby improving LIBs' versatility [Ref. 42,48,49]. In addition, LTO's operating potential is greater than the reduction voltage of conventional electrolyte solvents (propylene carbonate and ethylene carbonate), an attractive feature for rate performance [Ref. 50,51] Unfortunately, pristine spinel LTO exhibits poor electronic conductivity (10⁻¹³ S cm⁻¹) [Ref. 52]. attributed to the Ti⁴⁺ valence state and low Li⁺ diffusion coefficient (10⁻⁹-10⁻¹⁴ cm² s⁻¹) resulting in capacity loss and poor rate capability, which limits its usage in practical applications [Ref. 52-54]. To date, numerous methods have been explored to ameliorate the electronic conductivity and Li⁺ diffusivity [Ref. 42,55-57 The most common method focuses on doping with metallic (Cr³⁺, Ca²⁺, Ga³⁺, Mg²⁺, Ta⁵⁺, and Al³⁺) [Ref. 58-61] and nonmetallic (Br⁻, Cl⁻, and F⁻) [Ref. 62-64] ions to increase lattice electrical conductivity through partial reduction of Ti⁴⁺ to Ti³⁺.

Several efforts have been investigated to increase the electrical conductivity of LTO through surface modifications via conductive coatings [Ref. 65-68]. Although carbon-coatings offer a very efficient way to improve LTO anode rate capabilities, they also decrease cell's volumetric energy densities [Ref. 42,69]. Furthermore, fabrication of uniform and optimized carbon coated LTO using economically facile techniques remains challenging [Ref. 42].

Syntheses of nano LTO particles including nanorods, nanotubes, and nanowires offers an efficient strategy to improve LTO electrochemical performance [Ref. 70-72]. It is well-known that nanostructured active materials can enhance both electron and Li⁺ migration by shortening diffusion pathways and providing excess surface lithium storage ascribed to their large surface areas and small sizes [Ref. 32,67]. In addition, LTO NPs will have larger contact area between the electrolyte and electrode, resulting in improved intercalation kinetics. These phenomena contribute to enhance the rate capabilities of nanostructured LTO compared to bulk LTO. Multiple synthesis methods have been explored in efforts to prepare spinel LTO including sol-gel, hydrothermal synthesis, solution-combustion, and spray pyrolysis [Ref. 73-76]. However, these routes often offer low yields, involve complicated procedures, high costs, and toxic precursors detracting from commercialization practicality.

Therefore, the synthesis of nanoscale LTO materials with controlled morphologies, phase purity, and using low-cost methods is highly desirable for assembly of LTO batteries. This Example prepares LTO NPs using liquid-feed flame spray pyrolysis (LF-FSP).

Recent publications indicate that the introduction of appropriate amounts of solid electrolytes [LiAlO₂, Li_{1.3}Al_{0.3}Ti_{1.7}(PO₄)₃ (LATP), and Li_{0.33}La_{0.56}TiO₃] into a LTO anode is an effective, low-cost route to improve the electronic and ion transport of LTO [Ref. 54, 69, 77]. Thus, Han et al. [Ref. 74] reported that added LATP can coat and/or bridge LTO particles, thereby facilitating Li⁺ diffusion from electrolyte to the active material and improving electron migration to the current collector (Cu) by virtue of LATP's high ionic (6.2×10⁻⁵ S/cm) [Ref. 78] and electronic conductivities (5×10⁻¹¹ S/cm) [Ref. 79]. However, these studies use solid-state reaction methods (calcining >700° C.) to synthesize LTO-solid electrolyte composites, which makes it difficult to obtain nanostructured LTO particles as a result of particle necking.

Recently, we demonstrated that LF-FSP derived LiAlO₂ ceramic electrolytes offer optimal ionic conductivities (˜10⁻⁶ S/cm) and electronic conductivities of 6.7×10⁻¹⁰ S/cm at ambient, both 3 orders of magnitude higher than those reported for LTO (Table 1) [Ref. 80]. Hence, LTO-LiAlO₂ composite anodes were prepared via simple ball-milling. We coincidentally reported the synthesis and characterization of a novel polymer electrolyte (Li₆SiON) derived from rice hull ash (RHA), an agricultural waste, providing a green route to all-solid-state batteries (Scheme 1) [Ref. 81]. In our effort to synthesize the Li₆SiON polymer electrolyte, we realized that it might also be possible to use this precursor to coat LTO NPs. The Li₆SiON electrolyte offers a room temperature (Table 1) ionic conductivity of 10⁻⁶ S/cm and electrical conductivity of 10⁻⁷ S/cm six orders of magnitude greater than that of LTO.

TABLE 1
Ionic and Electronic Conductivities of LTO, LiAlO₂,
and Li₆SiON at Ambient

| | Ionic conductivity | Electronic | |
|---|---|---|---|
| Compounds | (S/cm) | conductivity (S/cm) | Ref. |
| LTO | 10⁻¹³-10⁻⁹ | <10⁻¹³ | 52, 53 |
| LiAlO₂ | 10⁻⁶ | 10⁻¹⁰ | 80 |
| Li₆SiON | 10⁻⁶ | 10⁻⁷ | 81 |

In this Example, we synthesized high surface area (˜38 m²/g) spinel LTO NPs using LF-FSP. Contrary to the typical solid-state reaction, this method eliminates glass forming, grinding, and ball milling steps. In addition, LF-FSP derived LTO NPs are agglomerated but not necked which is crucial for facile dispersion and tape-casting. To enhance the electrical conductivity of LTO anodes, the LTO was mixed with flame made LiAlO₂ NPs (APS=64 nm; 5 and 10 wt. %) and coated with Li₆SiON polymer precursors (5 and 10 wt. %).

To the best of our knowledge, this is the first time three component composite anodes, e.g., LTO-5 wt. % LiAlO₂-10 wt. % Li₆SiON, have been explored as an approach to improving LTO's rate capabilities. The composite anode exhibited a specific capacity of ˜217 mAh/g at 5 C for 500 cycles. The modified LTO NPs were characterized via XRD, XPS, SEM, EIS, and performance tests, as described in the following sections.

### 2. Experimental Section

### 2.1 Synthesis of LTO NPs

### Materials

Lithium hydroxide monohydrate (LiOH·H₂O) and propionic acid [(CH₃CH₂COOH), 99%] were purchased from Sigma-Aldrich (Milwaukee, Wis.). Titanium isopropoxide [Ti(OiPr)₄] and hexane were purchased from Fischer Scientific (Pittsburgh, Pa.). Absolute ethanol was purchased from Decon Labs (King of Prussia, Pa.). RHA was provided by Wadham Energy LP (Williams, Calif.). The solvent and reactants, 2-Methyl-2,4-pentanediol (hexylene glycol, HG) and lithium amide (LiNH₂) were purchased from Acros Organics. Lithium metal foil (˜750 μm), polyvinylidene fluoride [PVDF, (Mw˜534 kg/mol)], sodium hydroxide (NaOH), hydrochloric acid (HCl), and tetrahydrofuran (THF) were purchased from Sigma-Aldrich (St Louis, Mo.). Super C65 conductive carbon powder (˜62 m²/g), Celgard 2400 polypropylene separator membrane (˜25 μm), and coin cell parts were purchased from MTI Corporation (Richmond, Calif.). The mixed solvent of ethylene carbonate (EC), dimethyl carbonate (DMC), and ethyl methyl carbonate (EMC) (1:1:1 wt. %) containing 1 M LiPF₆ as the Li salt with the addition of 10 wt. % fluoroethylene carbonate (FEC) was purchased from Soulbrain (Northville, Mich.). THF was distilled over sodium benzophenone ketyl prior to use. All other chemicals were used as received.

The synthesis procedures for titanatrane {Ti(OCH₂CH₂)₃N—[OCH₂CH₂N(CH₂CH₂OH)₂]} and lithium propionate [LiO₂CCH₂CH₃] are discussed in our previous work [Ref. 82].

### Characterization

X-ray diffraction (XRD). A Rigaku Rotating Anode Goniometer (Rigaku Denki., LTD., Tokyo, Japan) was used to identify the phases and characterize the degree of crystallinity of as produced NPs using Cu Kα (λ=1.54 Å) radiation operating at a working voltage of 40 kV and a current of 100 mA. Scans were continuous from 10 to 70° 2θ using a scan rate of 5° min⁻¹ in 0.01 increments. The presence of crystallographic phases and their wt. % fractions were refined by using PDXL 2018 (Version 2.8.4). For Rietveld refinement, a model was imported from the Inorganic Crystal Structure Database (ICSD).

Specific surface area (SSA) analyses. SSA data was obtained using a Micromeritics ASAP 2020 sorption analyzer. Before sample analysis at −196° C. (77 K)/N₂, NPs samples (400 mg) were degassed at 300° C./5 h. BET method using ten data multipoint with relative pressures of 0.05-0.30 was used to determine SSAs. Average particle sizes (APS) of the as-produced NPs were determined by converting their respective SSAs using the equation APS=6/(SSA×p), where the net density of LTO (3.5 g/cm³) was used.

Scanning electron microscopy (SEM). A JSM-IT300HR In Touch Scope SEM (JEOL USA, Inc.) was used to analyze the microstructure of as-produced NPs and composite electrodes.

Thermogravimetric analysis (TGA). Q600 simultaneous TGA/DSC (TA Instruments, Inc.) was used to analyze the thermal stability and fraction of volatile components of as-produced NPs. The samples (15-25 mg), hand-pressed in a 3-mm dual-action die, were placed in alumina pans and ramped to 700° C. at 10° C. min⁻¹/air (60 mL min⁻¹).

X-ray photoelectron spectroscopy (XPS) Kratos Axis Ultra (Kratos Analytical) was used to determine the elements present. XPS system at room temperature under 3.1×10⁻⁸ Pa using monochromatic Al source (14 kV and 8 mA) was used to record the core level atoms. Binding energies of all the elements were calibrated relative to the gold with Au 4f_{7/2} at 84 eV. For each sample, a wide-scan survey was done on three separate points for better accuracy. All the data were analyzed by CASAXPS software.

Electrochemical impedance spectroscopy (EIS) was measured using a SP-300 (Bio-Logic Science Instruments, Knoxville, Tenn.) over a frequency range of 100 kHz to 0.01 Hz with an AC amplitude of 10 mV. The open-circuit voltage (OCV˜2.7 V) and cyclic voltammetry (CV) tests were carried out using the SP-300 potentiostats/galvanostat. The charge-discharge measurements on the half-cell were performed between 0.0-2.5 V (vs Li/Li⁺) using a multi-channel Maccor battery test system (MACCOR, USA).

### Methods

Lithium propionate (26.5 g) and titanatrane (236.8 g) were dissolved in anhydrous ethanol (1650 mL) to give a 3 wt. % ceramic yield solution. To avoid the loss of lithium during the combustion process, excess lithium propionate (100 wt. %) was used. The LF-FSP method was used to produce LTO NPs. A detailed description of LF-FSP process can be found elsewhere [Ref. 53].

The as-produced LTO NPs (10 g) were dispersed in anhydrous ethanol (350 mL) with 2 wt. % poly(acrylic acid) using an ultrasonic horn (Vibra-cell VC 505 Sonics & Mater. Inc.) for 10-15 minutes operating at 100 W. The suspension was left to settle for 5 hours to remove impurities and allow larger particles to settle. To remove the impurities the suspension was left to settle for 5 hours and the recovered supernatant was dried at 100° C./24 and heated to 700° C./2 h/O₂, hereafter referred to as pristine LTO.

### 2.2. Preparation of LTO/LiAlO₂/Li₆SiON Composites

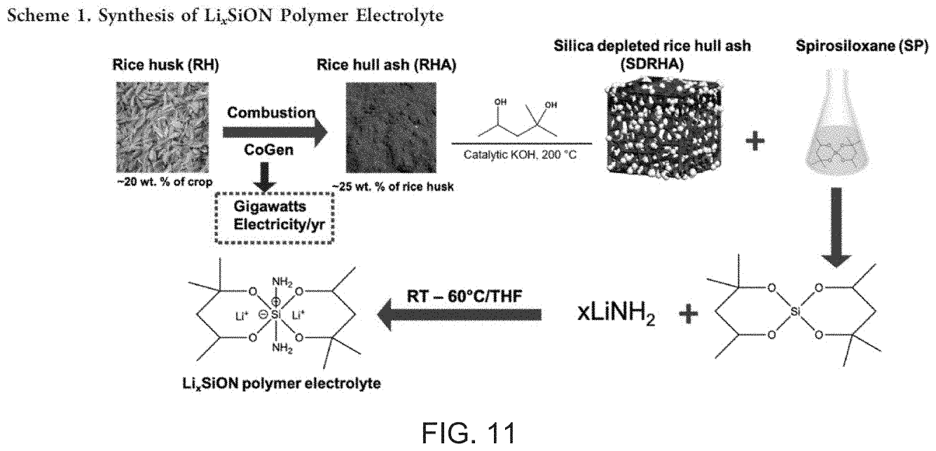

LiAlO₂ NPs were also synthesized using the LF-FSP method as discussed in our previous work [Ref. 80]. We recently reported the direct distillative extraction of silica from RHA as the spirosiloxane, [SP=(C₆H₆O₂)₂Si]. SP reacts with xLiNH₂ to provide in oligomeric mixtures denoted as LiₓSiON (x=2, 4, and 6) polymers with varying Li and N contents per Scheme 1 shown in FIG. 11. The Li₆SiON oligomers are for the most part soluble and stable in THF which makes it easier to coat LTO NPs, offering a simple and cost-effective green synthesis route to fabricate composite electrodes.

In our effort to enhance the electrical conductivity of LTO, composite anodes were processed by adding selected wt. % LiAlO₂ solid and Li₆SiON polymer electrolytes during electrode formulation per Table 2.

TABLE 2
Lists of Pristine and Composite Electrodes (wt. %)

| Electrodes | LiAlO₂ (wt. %) | Li₆SiON (wt. %) |
|---|---|---|
| LTO 0 0 | | |
| LTO-5 wt. % LiAlO₂ | 5 | 0 |
| LTO-10 wt. % LiAlO₂ | 10 | 0 |
| LTO-5 wt. % Li₆SiON | 0 | 5 |
| LTO-10 wt. % Li₆SiON | 0 | 10 |
| LTO-5 wt. % LiAlO₂- | 5 | 5 |
| 5 wt. % Li₆SiON | | |
| LTO-5 wt. % LiAlO₂- | 5 | 10 |
| 10 wt. % Li₆SiON | | |
| LTO-10 wt. % LiAlO₂- | 10 | 5 |
| 5 wt. % Li₆SiON | | |
| LTO-10 wt. % LiAlO₂- | 10 | 10 |
| 10 wt. % Li₆SiON | | |

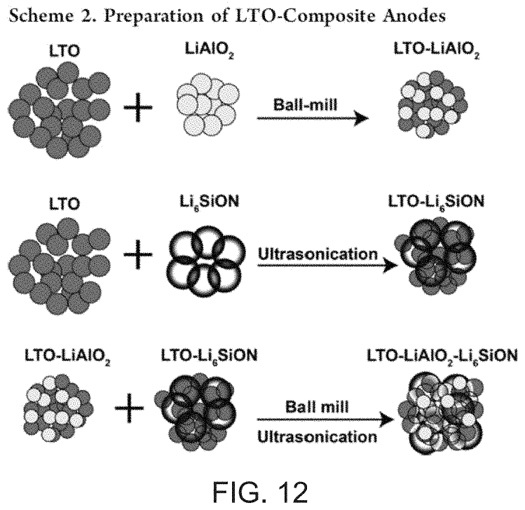

The LTO and LiAlO₂ NPs (5 and 10 wt. %) were dry ground for ˜30 minutes in air to ensure uniform mixing. The LTO-LiAlO₂ mixtures, dispersed in anhydrous ethanol (5 mL), were ball-milled for 24 hours using ZrO₂ beads (6 g, 3 mm) in 20 mL vial under nitrogen. The slurries were then heated at 100° C./24 h/vacuum. In a separate step, LTO NPs and Li₆SiON polymer precursor (5 and 10 wt. %) dissolved in THF then ultrasonicated at 100 W for 5-10 minutes. The recovered mixtures were then dried at 100° C./24 h/vacuum. To evaluate the synergistic effects of the LiAlO₂ and Li₆SiON electrolytes, composite electrodes are synthesized by mixing the LTO-LiAlO₂ powders with LTO-Li₆SiON powders. Scheme 2 in FIG. 12 depicts the preparation of the LTO-composite anode systems.

Before electrode fabrication, pristine LTO and carbon black (C65) were heated to 100° C./24 h/vacuum to remove trace moisture and eliminate oxygenated carbon species. Electrode slurries were prepared by mixing pristine LTO or LTO composites (80 wt. %), C65 (10 wt. %), and polyvinylidene fluoride (PVDF) (10 wt. %) in 1-methyl pyrrolidin-2-one.

The LTO-Li₆SiON mixtures were ultrasonicated for 10-15 min/N₂ to give homogeneous slurries. The LTO-LiAlO₂ mixtures were ball milled for 24 hours using ZrO₂ beads (6 g) in 20 mL vials and then coated onto current collector (Cu foils, 16 μm). After drying at 80° C./12 h/vacuum, the electrodes were cut into 8 mm discs, and thermo-pressed at 40-50 MPa/50° C./5 min using a heated benchtop press (Carver, Inc.) to improve packing density. The electrodes have areal loading densities ranging from 3 to 4 mg/cm². LTO-composite-Li half cells were assembled following the standard coin cell procedure discussed elsewhere [Ref. 84]. Briefly, NMC622 was used a cathode, Celgard 2400 polypropylene membrane as a separator, and a solution of 1.1 M LiPF₆ in a mixture solvent of EC:DC:DMC (weight ratio of 1:1:1) with 10 wt. % FEC additives as the electrolyte. The assembly process was conducted in an argon-filled glove box having 02 and H₂O contents below 0.5 ppm. The coin cells were compressed using a ˜0.1 kpsi uniaxial pressure (MTI).

### 3. Results and Discussion

In this section, we primarily characterize pristine LTO NPs and composite anodes by XRD, FTIR, SEM, and TGA. In the second part, we discuss the electrochemical properties of half-cells assembled using the LTO-composite electrodes. The effect of the LiAlO₂ solid electrolyte and Li₆SiON polymer electrolyte additives on the rate performance of the LTO were also investigated.

### 3.1 Structure and Morphology of LTO Composites

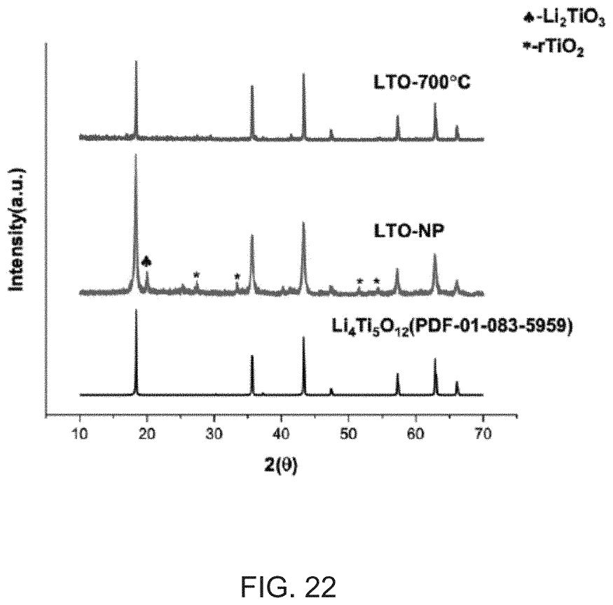

FIG. 22 shows the XRD powder pattern of as-produced LTO NP composed primarily of spinel LTO phase (92 wt. %). The weak diffraction peaks ˜27.6° and 55.5° 2θ can be assigned to TiO₂ (rutile) and the small peak˜20.3° 2θ is attributed to Li₂TiO₃ [Ref. 85]. The FIG. 22 broad peaks at low 2θ angles decrease and the intensity of the peak corresponding to Li₂TiO₃ decreases on heating to 700° C., suggesting formation of phase pure spinel LTO without impurities.

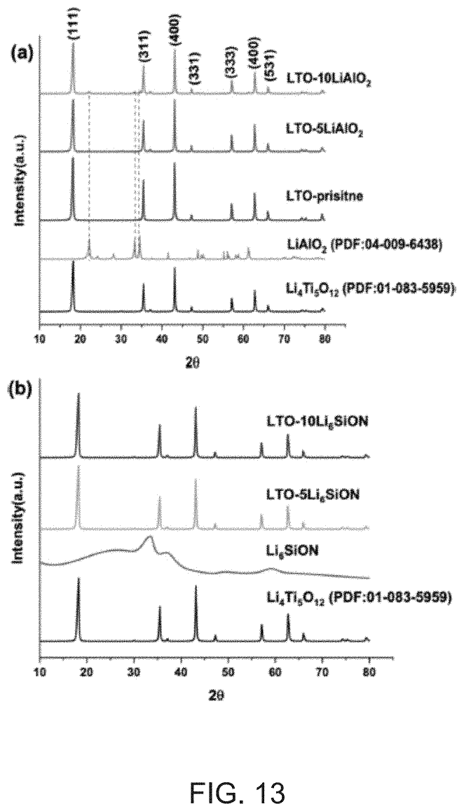

The XRD powder patterns of LTO-pristine, LTO-LiAlO₂, and LTO-Li₆SiON composites are shown in FIG. 13. All the peaks can be indexed to the Fd3-m space group with a cubic lattice [Ref. 77]. XRD of LTO-10 wt. % LiAlO₂ (FIG. 13, panel a) powder exhibits broad and low-intensity peak ˜21° and the doublet peaks at ˜34° 2θ, which can be indexed to γ-LiAlO₂ (PDF: 04-009-6438). Conversely, no noticeable lattice fringes ascribed to the presence of LiAlO₂ are found due to its low content and the fact that the LTO-LiAlO₂ composite powder was produced through a simple ball-milling without any heat treatment.

FIG. 13 panel b shows the XRD plot of the Li₆SiON powder heated to 100° C./12 h/vacuum. The broad peak centered at ˜35° 2θ suggests the absence of crystalline structure [Ref. 81]. Amorphous Li₆SiON generates no discernible diffraction peaks in the LTO-Li₆SiON composite powder.

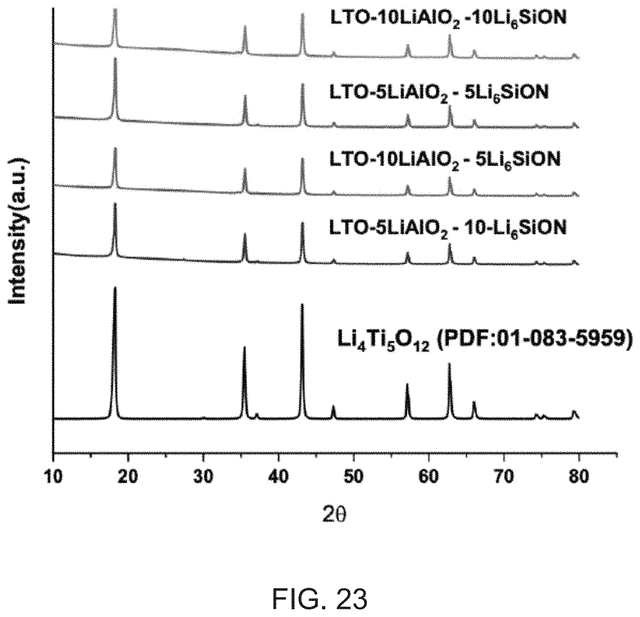

FIG. 23 presents the XRD patterns of LTO-LiAlO₂—Li₆SiON composite powders. The lattice parameters for the LTO-LiAlO₂—Li₆SiON (a=8.362 Å) powder are essentially the same as those of the pristine material (8.364 Å).

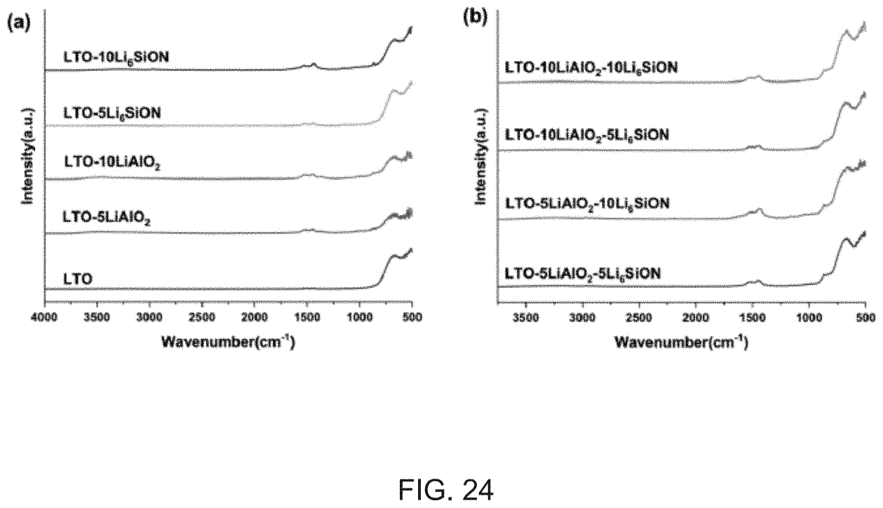

The FTIR spectra of LTO-pristine and LTO-composite powders are presented in FIG. 24. The spectra of all samples change slightly with addition of LiAlO₂ and Li₆SiON polymer electrolytes. The broad peak ˜1450-1500 cm⁻¹ corresponds to carbonate vC=O, typical for LF-FSP derived powders [Ref. 80].

The two broad absorption bands centered at 650 and 465 cm⁻¹, respectively, are due to the symmetric and asymmetric stretching vibrations of lattice [MO₆] octahedral groups confirming the presence of spinel LTO [Ref. 56].

High performance LTO anodes are available using nanostructured materials because such materials offer larger contact areas with electrolyte, shorter diffusion distances for Li⁺ and electrons, and excess near-surface lithium storage in comparison with micron-size LTO anodes [Ref. 57, 71]. The solid-state reaction method is simple; however, product quality is not satisfactory due to particle inhomogeneities, large APSs, and irregular morphologies. In contrast, we are able to the design and prepare uniform, nanoscale LTO electrodes for high performance applications.

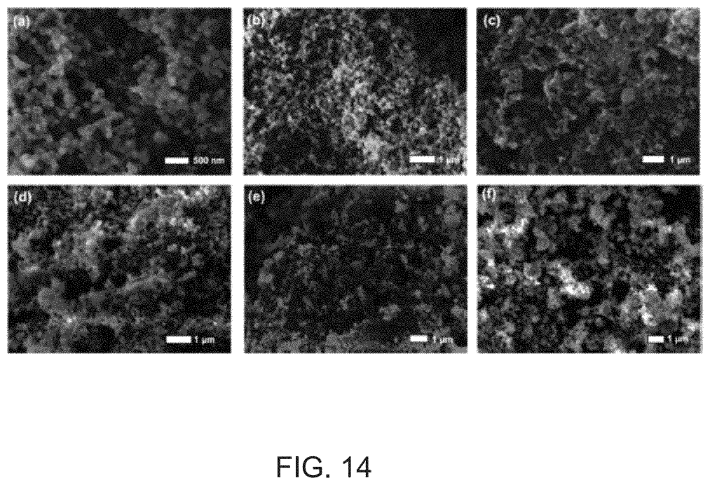

FIG. 14 shows SEMs of pristine LTO, LTO-composite powders. Powder morphologies of the pristine LTO (FIG. 14 panel a) and LTO-LiAlO₂ (FIG. 14 panel b, panel c) are similar agglomerates with uniform APSs<60 nm. Table S1 lists the SSAs and APSs of the LTO-composite powders.

TABLE S1
Lists of SSAs and APSs of the LTO-composite powders

| | SSA | APS |
|---|---|---|
| Electrodes | (m²/g) | (nm) |
| LTO | 37 ± 0.8 | 46 |
| LTO-5 wt. % LiAlO₂ | 35 ± 0.2 | 48 |
| LTO-10 wt. % LiAlO₂ | 31 ± 0.5 | 54 |
| LTO-5 wt. % Li₆SiON | 36 ± 0.3 | 47 |
| LTO-10 wt. % Li₆SiON | 37 ± 0.8 | 47 |

As noted above, high surface area is an important characteristic of nanostructured materials. The BET SSA of pristine LTO is 37±0.8 m²/g. The calculated APS using the BET surface area is ˜46 nm for the pristine LTO. The LTO-10 wt. % LiAlO₂ sample shows a slight decrease to 31 m²/g and increase in APS (54 nm) attributed to the relatively larger LiAlO₂ APS (64 nm) [Ref. 80].

FIG. 14 panels d,e show highly dispersed small particles on the LTO particles, which indicates that the polymer electrolyte is coated on the LTO particles, supporting the EDX studies presented below. The powder surface morphology of the LTO-10 wt. % LiAlO₂-10 wt. % Li₆SiON composite reveals denser particle accumulation attributed to the polymer electrolyte additives.

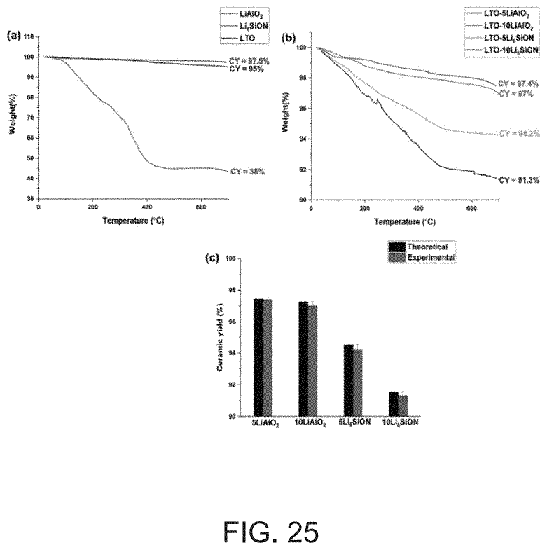

The thermal stability of the composite powders was investigated by TGA. FIG. 25 shows representative TGA plots (700° C./10° C. min⁻¹/N₂) for pristine LTO and LTO-composite powders. The mass losses <250° C. are attributed to physi/chemisorbed water on the surfaces of the LTO-LiAlO₂ composite powders. The LTO-Li₆SiON composite powder exhibits relatively larger mass loss (8 wt. %) from 100 to 450° C. ascribed to evaporation/or decomposition of organics.

FIG. 25 panel c demonstrates that the TGA ceramic yield for the LTO-composite powders are in good agreement with the theoretical ceramic yields calculated using the rule of mixtures.

### 3.2 Surface Characterization

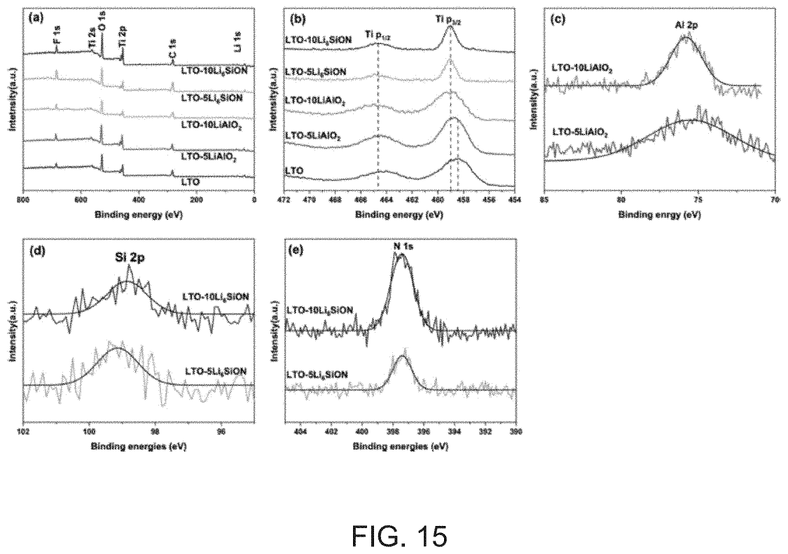

The surface chemical composition and binding energies of the LTO-pristine and LTO-composite electrodes were analyzed by XPS. The survey spectra (FIG. 15 panel a) reveal signature elements (Li, Ti, C, and O) for the LTO-pristine and LTO-composite electrodes. All electrodes show a small F 1s peak (2.3-3.5 at. %) ascribed to the presence of PVDF. The resulting deduced elements from XPS are listed in Tables S2 and S3.

TABLE S2
XPS analysis of pristine LTO, LTO-LiAlO₂ electrodes.

| | | At. % | | |
|---|---|---|---|---|
| | Binding | | LTO-5 | LTO-10 |
| | energy | LTO- | wt. % | wt. % |
| Elements | (eV) | pristine | LiAlO₂ | LiAlO₂ |
| F 1s | 685 | 2.3 | 2.6 | 2.4 |
| O 1s | 526 | 18.2 | 19.1 | 16 |
| Ti 2p | 455 | 5.6 | 6.3 | 6 |
| C 1s | 281 | 27.1 | 21 | 20 |
| Al 2p | 70 | — | 3.3 | 7.3 |
| Li 1s | 58 | 46.8 | 47.7 | 48.3 |

TABLE S3
XPS analysis of pristine LTO, LTO-Li₆SiON electrodes.

| | Binding | At. % | |
|---|---|---|---|
| | energy | LTO-5 wt. % | LTO-10 wt. % |
| Elements | (eV) | Li₆SiON | Li₆SiON |
| F 1s | 685 | 3.5 | 2.85 |
| O 1s | 526 | 16 | 14.5 |
| Ti 2p | 455 | 5.8 | 6.6 |
| N 1s | 397 | — | 3.2 |
| C 1s | 281 | 25.6 | 22.75 |
| Si 2p | 99 | 1.9 | 2.3 |
| Li 1s | 58 | 47.2 | 47.8 |

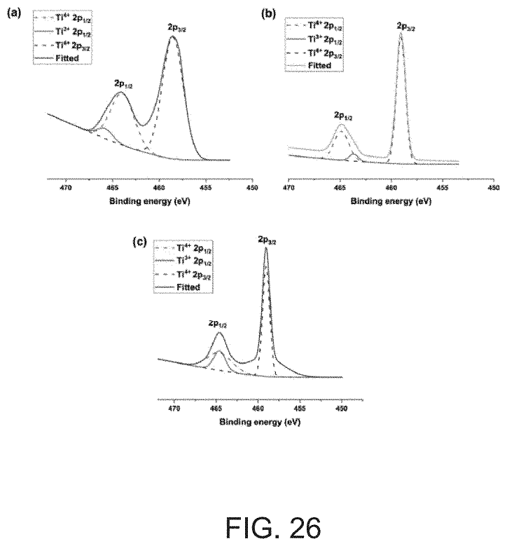

FIG. 15 panel b presents core resolution XPS spectra for electrode Ti 2p. Deconvoluted peaks at ˜464.4 and 458.5 eV corresponds to the Ti 2P_{1/2} and Ti 2P_{3/2} core level binding energies of Ti⁴⁺ of spinel LTO, respectively [Ref. 54, 57]. No noticeable change is observed in the Ti 2p core peak for the LTO-pristine and LTO-LiAlO₂ electrodes. The Ti 2p_{3/2} peak seems to shift slightly to higher binding energy (459 eV) for the LTO-Li₆SiON electrode compared to the pristine LTO electrode. This suggests that introducing the polymer electrolyte changes bonding at the LTO surface. FIG. 26 deconvolutes the Ti 2p peak for the LTO-pristine and LTO-composite electrodes. The Ti³⁺ contents at 2p_{1/2} increase to 10.2 and 15.7% for the LTO-5 wt. % Li₆SiON and LTO-10 wt. % Li₆SiON electrodes, respectively, which are significantly higher than the content in LTO-pristine electrode (4.2 wt. %). This implies that Ti⁴⁺ is partially reduced to Ti³⁺ during the coating process. As noted above, the presence of Ti³⁺ in LTO can effectively improve electron-hole concentrations enhancing bulk electrical conductivity [Ref. 42,59]. As a consequence, the LTO-Li₆SiON electrode exhibits superior electrical conductivity as discussed below.

The core level spectra of the Al 2p (74.8 eV) peak increases with increasing LiAlO₂ content (10 wt. %), a consequence of LiAlO₂ particles associated with the surface of LTO particles (FIG. 15 panel c). The core level spectra of Si 2p (99 eV) are similar in shape and peak position for the LTO electrode coated with 5 and 10 wt. % Li₆SiON polymer electrolytes as shown in FIG. 15 panel d. The overall atomic concentration of N (FIG. 15 panel e) increases with the introduction of 10 wt. % Li₆SiON, suggesting that the LTO surface is coated uniformly with the polymer electrolyte.

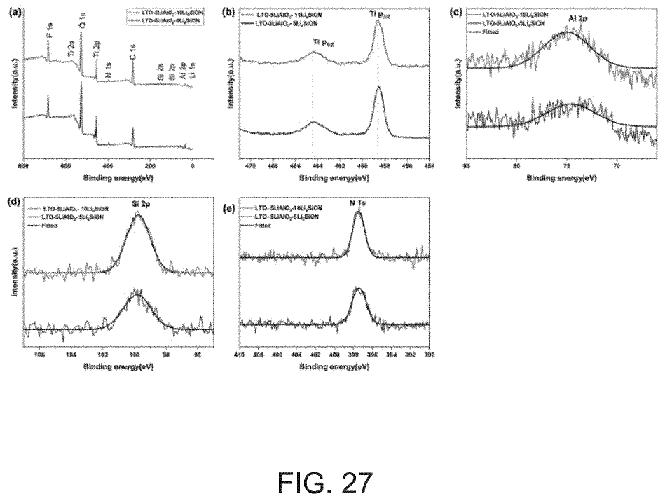

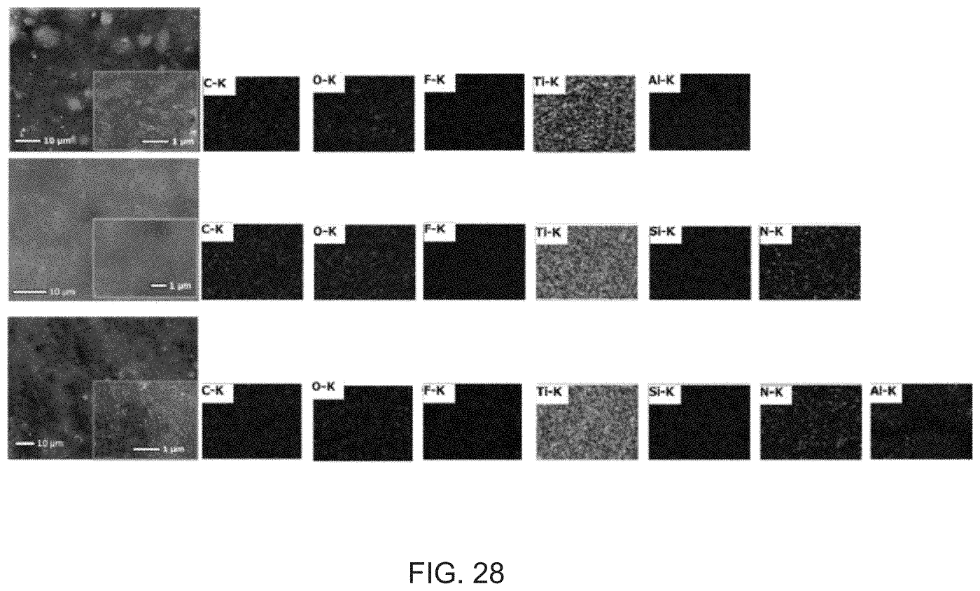

The survey spectra (FIG. 27) reveal signature peaks (Li, Ti, C, and O) for the LTO-LiAlO₂— Li₆SiON electrodes, while Al, Si, and N peaks are detected in the LTO composite electrodes ascribed to the presence of LiAlO₂ and Li₆SiON powders. The XPS derived compositions are listed in Table S4.

TABLE S4
XPS analysis of LTO-5LiAlO₂+ Li₆SiON
(5 and 10 wt. %) electrodes

| | | At. % | |
|---|---|---|---|
| | Binding | LTO-5 wt. % | LTO-5 wt. % |
| | energy | LiAlO₂₋5 | LiAlO₂₋ |
| Elements | (eV) | wt. % Li₆SiON | 10 wt. % Li₆SiON |
| F 1s | 684 | 5.6 | 4.8 |
| O 1s | 527 | 22.5 | 16.1 |
| Ti 2p | 455 | 5.1 | 6.6 |
| N 1s | 397 | 1 | 1 |
| C 1s | 281 | 32.2 | 32.7 |
| Si 2p | 99 | 1.3 | 1.5 |
| Al 2p | 73 | 4.8 | 6.2 |
| Li 1s | 58 | 27.5 | 31.1 |

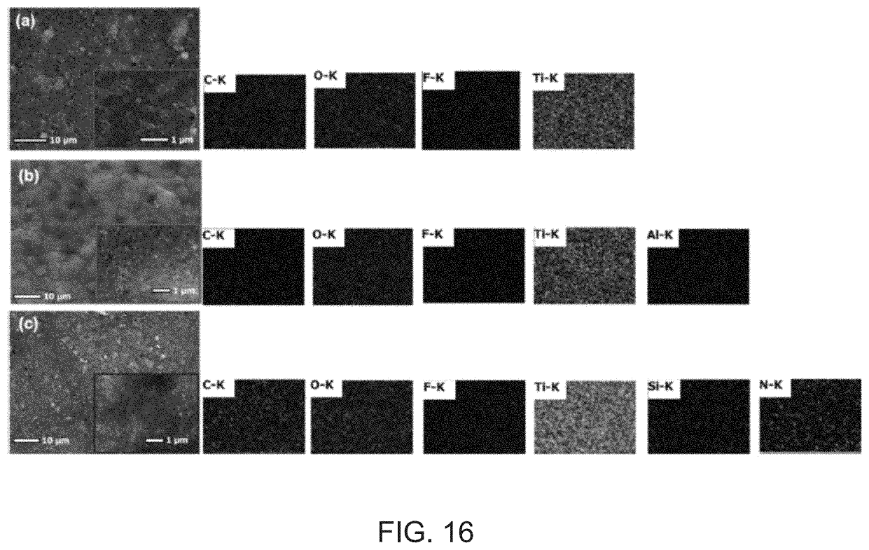

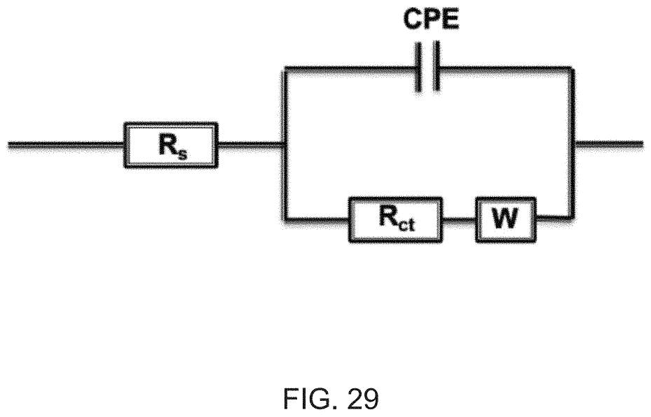

FIG. 16 panel a shows SEMs and EDX mapping of the pristine LTO electrode revealing a relatively porous microstructure. The EDX map presents uniform distribution of signature elements (C, O, F, and Ti), supporting the FIG. 15 panel a XPS studies. The elemental map of F results from the binder PVDF. FIG. 16 panel b shows SEMs and EDX mapping of an LTO-5 wt. % LiAlO₂ electrode revealing a relatively dense microstructure. The LTO-5 wt. % LiAlO₂ electrode seems to offer a smoother morphology compared to the electrode with higher LiAlO₂ content. Careful examination of the 10 wt. % LiAlO₂ modified electrode reveals some uneven LiAlO₂ coatings (FIG. 29 panel a). This might be ascribed to incomplete dispersion of the active particles with higher LiAlO₂ content. The EDX map presents uniform distribution of signature elements (C, O, Ti, F, and Al). The Al elemental map is also uniform for LTO-5 wt. % LiAlO₂ in congruent with the XPS data (FIG. 15 panel c). Table S5 lists the deduced atomic percentages based on EDX analyses for the LTO electrodes. As expected, the Al at. % increased with increasing LiAlO₂ content.

TABLE S5
Average atomic percentage (At. %) based on
EDX analysis for LTO-composite electrodes.

| | At. % | | | | | | |
|---|---|---|---|---|---|---|---|
| Electrodes | C | F | O | Ti | Al | Si | N |
| LTO-pristine | 29.7 | 6.3 | 48.4 | 15.6 | — | | |
| LTO-5 wt. % LiAlO₂ | 29.6 | 4.9 | 47.5 | 16.8 | 1.2 | | |
| LTO-10 wt. % LiAlO₂ | 28.3 | 7.0 | 50.3 | 12 | 2.4 | | |
| LTO-5 wt. % Li₆SiON | 23.7 | 8.2 | 52.5 | 13 | — | 1.4 | 1.2 |
| LTO-10 wt. % Li₆SiON | 23.1 | 7.5 | 50 | 15.4 | — | 2.2 | 1.8 |

FIG. 16 panel c and 29 panel b show SEM and EDX images of LTO+5 and 10 wt. % Li₆SiON electrodes, respectively. The Si and N elemental maps indicate uniform distributions for both electrodes corresponding with the XPS data (FIG. 15 panels d,e). As expected, the Si and N at. % increase with increased LiSiON content. The LTO-LiSiON electrodes show a relatively denser microstructure. Several notable experiments have demonstrated that the rate capability depends on the composition of additives, binder types, and degree of electrode compaction [Ref. 87]. Besides being an additive with superior ionic and electronic conductivities, the Li₆SiON polymer electrolyte can behave like a binder promoting intimate contact between the LTO particles and the current collector. These properties strongly enhance the LTO rate performance as discussed below.

### 3.3 Electrochemical Characterization

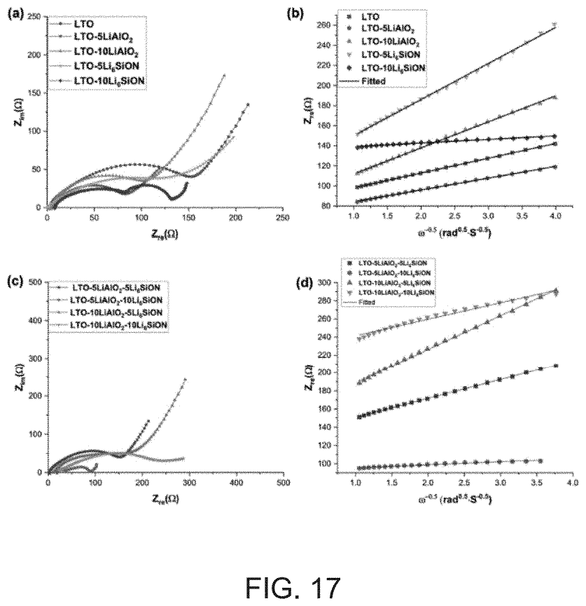

Electrochemical impedance spectroscopy (EIS) was performed on the LTO composite electrode-Li half-cells before cycling. The corresponding Nyquist plots are presented in FIG. 17 panels a,c. The impedance curves were fitted using a modified Randle-Ershler equivalent circuit model (FIG. 29). The Z axis intercept of the Nyquist plot at high frequency region is attributed to the ohmic resistance (Rₛ), which corresponds to internal resistance of electrode and electrolyte. The charge transfer resistance (R_{ct}) is associated with the semicircle in the intermediate frequency region. The sloped line in the low frequency-region represent the Warburg impedance (W), corresponding to the solid-state diffusion resistance. The constant phase elements (CPE) are attributed to the double-layer capacitance. The diffusion coefficient (D_{Li}) of the LTO-composite electrodes were calculated using equations S1-S3 [Ref. 69].

$${Z}_{re} = {R}_{ct} + {R}_{s} + {σω}^{- 1 / 2} \qquad ( S1 )$$

$$ω = 2 π f \qquad ( S2 )$$

$${D}_{Li} = \frac{{R}^{2} {T}^{2}}{2 {A}^{2} {n}^{4} {F}^{2} {C}_{Li}^{2} {σ}^{2}} \qquad ( S3 )$$

where R is the gas constant, T is the absolute temperature, F is the Faraday constant, A is the area of the electrode, n is the number of electrons per molecule during oxidation, Cu is the concentration of Li⁺ in solid, ω is the angular frequency, f is the frequency, and σ is the Warburg factor which is related to Zᵣₑ obtained from the slope of the line in FIG. 17 panels b and d.

All of the Nyquist spectra (FIG. 17 panels a,c) exhibit semicircles and tail in the high and low frequency regions, respectively. The electrical/ionic conductivity at the interface is represented by the Ret, and the diffusion of Li⁺ into the bulk of the active material is related to W. Appropriate LiAlO₂ (5 wt. %) and Li₆SiON (10 wt. %) modification improves the conduction of LTO anode as demonstrated in FIG. 17. This suggests that surface modification enhances LTO conductivity and decreases R_{ct}. The EIS studies indicate that the LTO-5 wt. % LiAlO₂ electrode have better Li⁺ diffusion coefficient than pristine LTO. However, the introduction of higher content LiAlO₂ (10 wt. %) resulted in an increase in the Rd and a decrease in Li⁺ diffusion coefficient, which could be attributed to a thicker barrier that impeded the Li⁺ migration at the LTO surface. It could also be ascribed to the increase in the APS of LTO-10 wt. % LiAlO₂ (54 nm). The Li⁺ diffusivity result can be compared Table S6 to reported LTO-LiAlO₂ and LTO-Li_{0.33}La_{0.56}TiO₃ composite electrodes [Ref. 69,77].

TABLE S6
Comparison of Li⁺ diffusivities for various LTO-composite electrodes.

| Electrodes | D_{Li}(cm²/s) | Ref. |
|---|---|---|
| LTO-LiAlO₂ (5 wt. %) | 1.19 × 10⁻¹³ | 94 |
| LTO-LIAlO₂ (10 wt. %) | 3.51 × 10⁻¹⁵ | 94 |
| LTO-Li_{0.33}La_{0.56}TiO₃ (5 wt. %) | 1.92 × 10⁻¹⁴ | 95 |
| LTO-Li_{0.33}La_{0.56}TiO₃ (10 wt. %) | 1.23 × 10⁻¹⁴ | 95 |

The calculated Li⁺ diffusion coefficients for pristine LTO, LTO-LiAlO₂, and LTO-Li₆SiON are listed in Table 3. LTO-5 wt. % LiAlO₂-10 wt. % Li₆SiON has the highest diffusion coefficient (˜2.7×10⁻¹²) among the LTO electrodes reported here. This study demonstrates that introduction of an appropriate amount of solid electrolyte enhances the electrochemical performance of LTO.

TABLE 3
List of Diffusivities and Potential Gap for Pristine
and Composite LTO Electrodes

| Electrodes | D_{Li}(cm²/s) | Δ φₚ (mV) |
|---|---|---|
| LTO-pristine | 4.6 ± 0.5 × 10⁻¹⁴ | 400 |
| LTO-5 wt. % LiAlO₂ | 6.1 ± 0.7 × 10⁻¹³ | 340 |
| LTO-10 wt. % LiAlO₂ | 4.8 ± 0.2 × 10⁻¹⁴ | 410 |
| LTO-5 wt. % Li₆SiON | 6.7 ± 0.6 × 10⁻¹⁴ | 380 |
| LTO-10 wt. % Li₆SiON | 1.2 ± 0.3 × 10⁻¹² | 320 |
| LTO-5 wt. % LiAlO_{2 -} 5 wt. % | 2.3 ± 0.3 × 10⁻¹³ | 300 |
| Li₆SiON | | |
| LTO-5 wt. % LiAlO_{2 .} 10 wt. % | 2.7 ± 0.3 × 10⁻¹² | 290 |
| Li₆SiON | | |
| LTO-10 wt. % LiAlO_{2 -} 5 | 3.0 ± 0.5 × 10⁻¹⁴ | 350 |
| wt. % Li₆SiON | | |
| LTO-10 wt. % LiAlO_{2 -} 10 | 1.3 ± 0.6 × 10⁻¹⁴ | 370 |
| wt. % Li₆SiON | | |

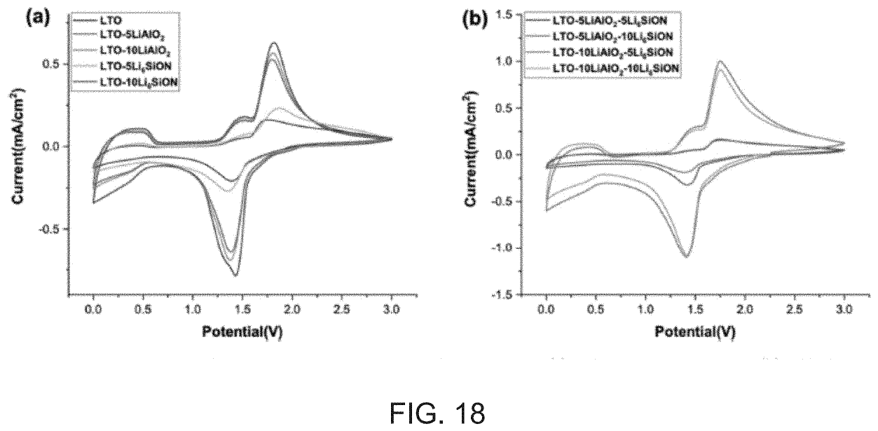

FIG. 18 panel a presents CV curves measured between 0 and 2.5 V (vs Li/Li⁺) at a scan rate of 1 mV/s. Two typical cathodic/anodic peaks are observed ˜1.8/1.5 V for all samples, corresponding to the two-phase LTO redox reaction mechanism of LTO (Li₄Ti₅O₁₂+3Li⁺+3e−⇄Li₇Ti₅O₁₂). This suggests that the introduction of LiAlO₂ and Li₆SiON polymer electrolyte does not change LTO electrochemistry (FIG. 18 panel b). Two additional weak redox peaks in the range of 0.4-0.6 V are ascribed to the multistep restoration of Ti⁴⁺ [Ref. 88]. This is attributed to the insertion of additional Li⁺ ions to the Li₇Ti₅O₁₂ (rock-salt) to transform to Li_{8.5}Ti₅O₁₂ (quasi-rock-salt) reducing all Ti⁴⁺ to Ti³⁺.⁵⁹ Table 3 also lists the peak parameters for the composite electrodes in the CV plots. The degree of polarization is reflected by the voltage difference between anodic and cathodic peaks. LTO-5 wt. % LiAlO₂-10 wt. % Li₆SiON exhibits the smallest potential gap (Δφₚ=0.29 V) between reduction and oxidation peaks compared to the pristine LTO electrode ((Δφₚ=0.4 V). This suggests that the composite electrode has lower electrochemical polarization and better diffusion kinetics than LTO-pristine. This is ascribed to faster Li⁺ and electron transfer processes imparted by the ceramic and polymer electrolyte additives. This is consistent with the excellent rate capability of the LTO-5 wt. % LiAlO₂-10 wt. % Li₆SiON composite electrode.

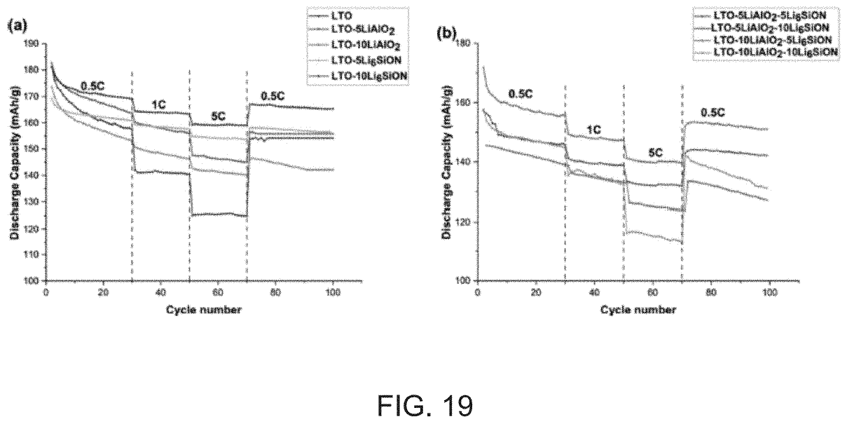

The electrochemical performance of LTO-pristine, LTO-LiAlO₂, LTO-Li₆SiON, and LTO-LiAlO₂—Li₆SiON electrodes was investigated by galvanostatic cycling test at different C-rates (0.5, 1, and 5 C) between 1 and 2.5 V. Pristine LTO (FIG. 19 panel a) shows an initial discharge capacity of ˜180 mAh/g at 0.5 C. The reversible capacity at 0.5 C rate is ˜154 mAh/g after 100 cycles, which is 88% of the theoretical capacity. This is in good agreement with previous reports and corresponds to the transformation of Li₄Ti₅O₁₂ to Li₇Ti₅O₁₂ [Ref. 42].

The discharge capacity for pristine LTO half-cell decreases to ˜125 mAh/g at 5 C. However, capacities for LTO-5 wt. % LiAlO₂ and LTO-10 wt. % Li₆SiON fade slowly remaining stable at 146 and 160 mAh/g at 5 C, respectively. The LTO-5 wt. % LiAlO₂-10 wt. % Li₆SiON exhibits a discharge capacity (˜140 mAh/g) at 5 C. On the whole, the LTO-Li₆SiON and LTO-LiAlO₂ electrodes reveal enhanced rate capacity relative to pristine LTO.

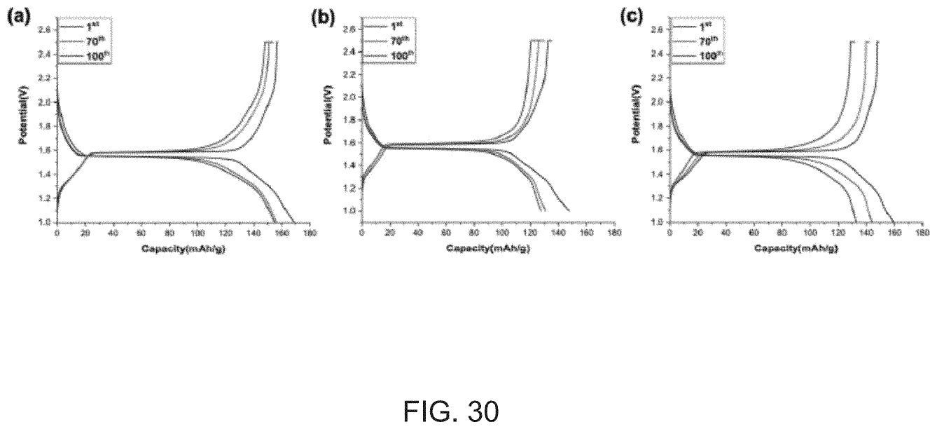

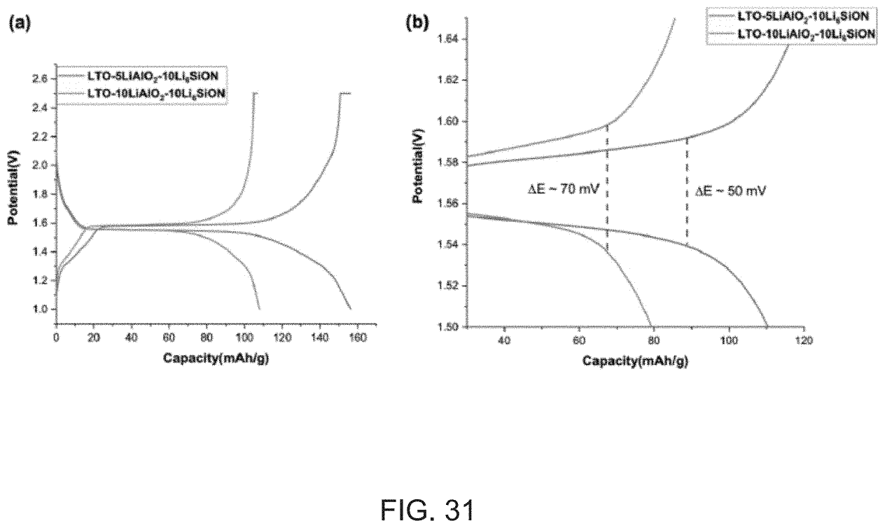

After 100 cycles, the specific capacities are 155±0.7, 142±, 156±0.5, and 162±0.2 mAh/g at 0.5 C for the half-cells assembled with LTO-5 wt. % LiAlO₂, LTO-10 wt. % LiAlO₂, LTO-5 wt. % Li₆SiON, and LTO-10 wt. % Li₆SiON electrodes, respectively. The reversible capacities of LTO-Li₆SiON decrease slowly compared to those for LTO-LiAlO₂ and the pristine LTO electrodes. However, the LTO-10 wt. % LiAlO₂-5 wt. % Li₆SiON and LTO-10 wt. % LiAlO₂-10 wt. % Li₆SiON composite electrodes show relatively low discharge capacities of 127 and 131 mAh/g after 100 cycles. To understand the reason why the LTO-10 wt. % LiAlO₂-5 wt. % Li₆SiON and LTO-10 wt. % LiAlO₂-10 wt. % Li₆SiON capacities (FIG. 19 panel b) decrease after 70 cycles, the discharge/charge curves for the selected cycles were investigated (FIG. 30). The polarization degree of the composite electrode was explored by calculating the voltage difference (ΔE) between discharge and charge plateaus. As presented in FIGS. 30 and 31, the ΔE of LTO-10 wt. % LiAlO₂-10 wt. % Li₆SiON increases gradually with increasing cycle number (ΔE≈70 mV), indicating relatively higher degrees of polarization compared to the LTO-5 wt. % LiAlO₂-10 wt. % Li₆SiON electrode (ΔE≈50 mV) after 70 cycles.

This might be ascribed to the larger quantity LiAlO₂, which significantly reduces the amount of active material LTO, resulting in lower capacity retention. This is consistent with what is reported in the literature for LTO-LiAlO₂ (10 wt. %) composite electrodes [Ref. 77]. In addition, as discussed above in the diffusivity section, the LTO-10 wt. % LiAlO₂-10 wt. % Li₆SiON composite did not show a high Li⁺ diffusivity coefficient when compared to the LTO-5 wt. % LiAlO₂-10 wt. % Li₆SiON electrode.

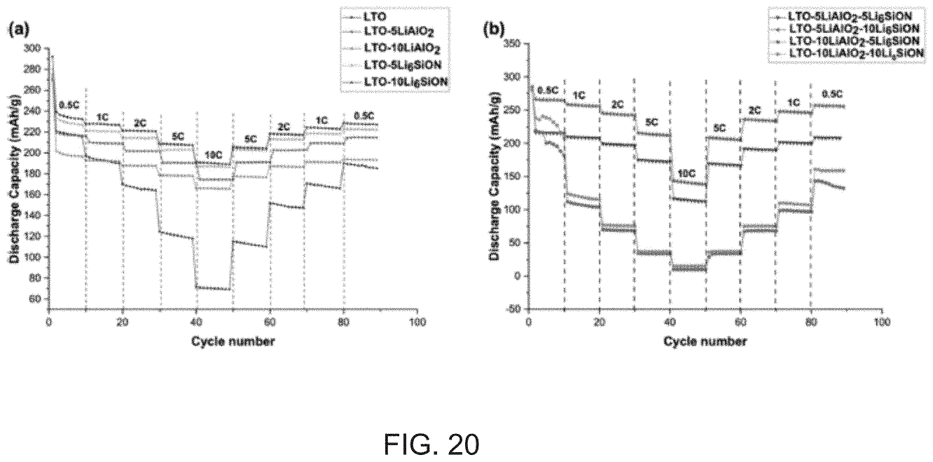

FIG. 20 presents the rate performance of the LTO-pristine and LTO-composite electrodes cycled in the range of 0.01-2.5 V. The initial discharge capacity of all of the half-cells is greater than the theoretical capacity (260 mAh/g). This extra capacity may be attributed to the formation of a solid electrolyte interface (SEI), intercalation of Li⁺ into the conductive carbon black (C65), and decomposition of the organic liquid electrolyte. The LTO electrodes (FIG. 20 panel a) display excellent cycling stability for both cutoff voltages (0.01 and 1 V), suggesting that the lithiation of the rock-salt structure is highly reversible.

The reversible capacities found for LTO-5 wt. % LiAlO₂-10 wt. % Li₆SiON (260 mAh/g) and LTO-10 wt. % Li₆SiON (231 mAh/g) are much higher than those of LTO-pristine electrodes (202 mAh/g) at 0.5 C as demonstrated in FIG. 20 panel b. LTO-5 wt. % LiAlO₂-10 wt. % Li₆SiON maintains a high discharge capacity of 255 mAh/g at 0.5 C, which is much higher than the pristine LTO (185 mAh/g) after 90 cycles. At 10 C, the LTO-10 wt. % Li₆SiON shows the highest discharge capacity of 190 mAh/g. The LTO-5 wt. % LiAlO₂ also delivered a high specific capacity of 174 mAh/g, which is more than double the capacity obtained for the pristine LTO (70 mAh/g). The introduction of appropriate amounts of LiAlO₂ NPs shortens diffusion distances for Li⁺ and electrons, increases the contact interface with electrolyte, and provides abundant surface Li⁺ storage sites or excess near-surface Li⁺ storage.

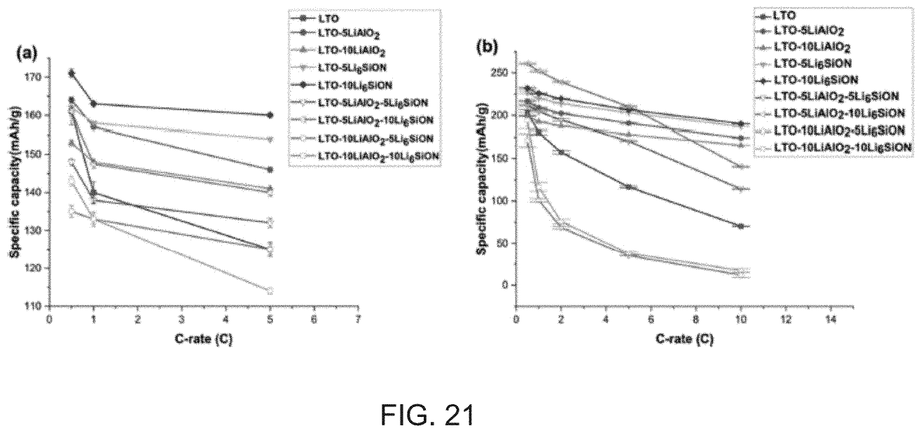

FIG. 21 demonstrates the rate capability of LTO-pristine and LTO composite electrodes cycled with different voltage windows at various current densities. The LTO-pristine half-cell cycled between 1.0 and 2.5 V potential range (FIG. 21 panel a) delivered average specific capacity of 160 mAh/g at 0.5 C. The pristine LTO half-cell was also discharged to 0.01 V delivering reversible capacities of 202 and 120 mAh/g at 0.5 and 5 C as shown in FIG. 21 panel b, respectively. These electrochemical results indicate that LF-FSP derived LTO powders enable high rate performance at different discharge voltage ranges.

FIG. 21 panels a,b show that the LTO-10 wt. % LiAlO₂-5 wt. % Li₆SiON and LTO-10 wt. % LiAlO₂-10 wt. % Li₆SiON composite electrodes show poor discharge capacities compared to the pristine LTO electrode when discharged to different voltages. This suggests that LiAlO₂ enhances the rate performance of the LTO-composite electrodes. Hence, it is important that the optimal content of LiAlO₂ (5 wt. %) is introduced to achieve superior cell performance. Compared to pristine LTO, Li₄Ti₅O₁₂—LiAlO₂ (5 wt. %) [Ref. 77] and Li₄Ti₅O₁₂—Li_{0.33}La_{0.56}TiO₃ (5 wt. %) [Ref. 69] composites prepared by solid-state reactions, the rate capability of LF-FSP derived LTO-5 wt. % LiAlO₂-10 wt. % Li₆SiON composite electrodes is much higher in the range of 0.01-2.5 V at higher C-rates (Table 4). This clearly indicates that moderate modification of LTO particle surfaces is substantially beneficial to rate performance.

TABLE 4
Comparison of Discharge Capacities of LTO-Composite
Anode Materials at 5 C

| | discharge capacities | |
|---|---|---|
| Electrodes | (mAh/g) | Ref. |
| LTO-LiAlO₂ (5 wt. %) | 127 | 77 |
| LTO-LiAlO₂ (10 wt. %) | ~50 | 77 |
| LTO-Li_{0.33}La_{0.56}TiO₃ | 146 | 69 |
| (5 wt. %) | | |
| LTO-Li_{0.33}La_{0.56}TiO₃ | 137 | 69 |
| (10 wt. %) | | |
| Li₄Ti_{4.9}La_{0.1}O₁₂ | 181 | 91 |
| LTO-TiO₂ 1 | 17 | 92 |
| LTO-TiO₂/C | 140 | 93 |
| LTO-5 wt. % LiAlO₂ | 190 | this Example |
| LTO-10 wt. % Li₆SiON | 206 | this Example |
| LTO-5 wt. % LiAlO₂₋ 10 wt. % | 217 | this Example |
| Li₆SiON | | |

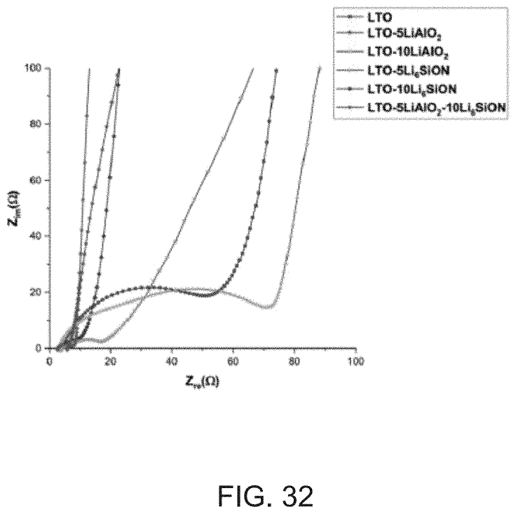

FIG. 32 shows the Nyquist plots of the half-cells in delithiation state after 100 cycles. Table S7 lists the electrolyte resistance (Rₑ) and R_{ct} of these half-cells. The R_{ct} values of LTO-5 wt. % LiAlO₂-10 wt. % Li₆SiON decreases markedly, suggesting the enhanced Li⁺ diffusion due to the introduction of electrolytes with optimal electrical conductivity than pristine LTO anode. Zhang et al. [Ref. 90] suggest that local charge imbalance promotes the electron transfer; hence, the modification of LTO surface enhances the electronic conductivity.

TABLE S7
List of impedance values for pristine and composite
LTO-Li half-cells

| Electrodes | Rₑ(Ω) | R_{ct}(Ω) |
|---|---|---|
| LTO-pristine | 3.5 | 60 |
| LTO-5 wt. % LiAlO₂ | 2.8 | 6 |
| LTO-10 wt. % LiAlO₂ | 3.3 | 75 |
| LTO-5 wt. % Li₆SiON | 3.8 | 20 |
| LTO-10 wt. % Li₆SiON | 3.6 | 15 |
| LTO-5 wt. % LiAlO_{2 -}10 | 3.0 | 8.5 |
| wt. % Li₆SiON | | |

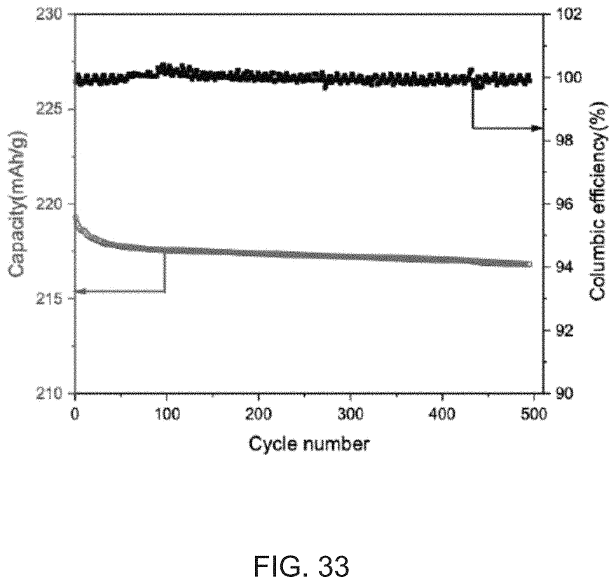

The high rate performance of the LTO-5 wt. % LiAlO₂-10 wt. % Li₆SiON electrodes is attributed to:
1. Optimal amounts of LiAlO₂ (5 wt. %) and Li₆SiON (10 wt. %) between or on the LTO particle surfaces enhancing the ionic conductivity as demonstrated by the increase in lithium ion diffusivity. (Table 3).
2. Li₆SiON polymer electrolyte reorganizing LTO surface bonding, resulting in an increase in the electronic conductivity due to the local change imbalance.
3. Diminishing electrode polarization, via introduction of appropriate LiAlO₂ and Li₆SiON electrolyte contents.
4. The enhanced electrical conductivities of electrolyte additives coupled with uniform particle morphology and high surface area of LTO NPs resulted in long-term cycling stability over 500 cycles delivering reversible capacity of ˜217 mAh/g at 5 C (FIG. 33).

### 4. Conclusions

In this Example, a facile LF-FSP method enabled the synthesis of high surface area, phase pure LTO NPs using a low-cost precursor. Pristine LTO was mixed with LiAlO₂ and Li₆SiON electrolytes to improve the ionic and electronic conductivity by simple ball-milling and ultrasonication methods. The microstructure studies show that the composite powders are homogeneous with particle sizes <60 nm. XPS and EDX studies further confirm that the surface of the LTO particles is uniformly coated with the polymer electrolyte. By virtue of the high electrical conductivity of LiAlO₂ and Li₆SiON electrolyte, the LTO composite electrodes with optimal LiAlO₂ (5 wt. %) and Li₆SiON (10 wt. %) electrolyte additives exhibit excellent rate performance delivering reversible capacity of 260 and 140 mAh/g at 0.5 and 10 C, respectively.

### Example 4—Coatings on Li—S Cells

### 1. Preparation of C—S Composites

First, polyacrylonitrile (MW 150 g/mol PAN) (200 mg) and S₈ (750 mg) were mixed and ground together using a mortar and pestle for 5 minutes. After that, 50 mg of high surface area carbon (C) (1700 m² g⁻¹) was added to the mixture and ground together again for 5 minutes, and then PAN-C—S pellets were pressed from this powder at 5 ksi/RT/5 min using a benchtop press (Carver, Inc.) using a 13 mm die set (Across International).

The PAN-C—S pellets were wrapped separately in Al foil to minimize S evaporation during heating. They were placed in a crucible, which was also wrapped in Al foil. The heating regime was “30° C.→400° C./5 h at 5° C./min in N₂” and then “400° C.→30° C. at 5° C./min in N₂”.

Table B shows the detailed information about C—S pellets after heating and soaking in CS₂.

TABLE B
S contents in C-S pellets after heat-treatment.

| Pellet before heating | | | Pellet after heating | | |
|---|---|---|---|---|---|
| Composition | | Mass | Mass | S content | |
| (wt. %) | Sample | (mg) | (mg) | (wt. %) | |
| C:P:S | 1 | 971 | 450 | 46 | 46 |
| (5:20:75) | 2 | 946 | 446 | 47 | |
| | 3 | 1002 | 464 | 46 | |
| | 4 | 985 | 447 | 45 | |
| | 5 | 999 | 462 | 46 | |
| | 6 | 987 | 466 | 47 | |

C: high surface area C (1700 m² g⁻¹), P: PAN, and S: sulfur. The heating regime to form C-S bonds: “30° C.→400° C./5 h at 5° C./min in N₂” and then “400° C.→30° C. at 5° C./min in N₂”.

The S content in the heated PAN-C—S pellets was about 46 wt. %. The heated PAN-C—S pellets were ground using a mortar and pestle and put in folded filter paper. Thereafter, they were soaked in CS₂ for 24 hours. This S extraction process was repeated two times with fresh CS₂. The C—S composites were then vacuum dried at 80° C. for XPS analysis (to determine the S content) and slurry preparation. The average S content is about 42 wt. % by XPS.

### 2. Slurry Preparation for S Electrodes with or without LATSP

Table C shows the information about slurries.

TABLE C
Starting Chemical Components For The Film Casting

| | PAN-C-S composite | *LATSP | PVDF | C65 |
|---|---|---|---|---|
| Sample | (mg) | (mg) | (mg) | (mg) |
| 1 | 700 | 0 | 150 | 150 |
| 2 | 550 | 150 | 150 | 150 |

*Solid electrolyte, ball-milled during slurry preparation for 24 hours.

First, 15 wt. % PVDF (MW: 534 kg/mol) was dissolved in 5.5 ml of distilled N-methyl-2-pyrrolidone (NMP) in a 20 ml-vial. Then 70 wt. % C—S composites in Table B and 15 wt. % carbon (Super C65, MTI Corporation) were added to the solution. In the other 20 ml-vial (Sample 2 in Table C), 15 wt. % LATSP was added to the C—S composite aiming for suppressing uncontrolled lithium polysulfides diffusion during battery cycling.

The vials were shaken for several minutes until nothing stuck to the bottom of the vials. They were sealed with tape and ball-milled with a tumbler (Model: 71637284, Fasco Industries, inc.) for 24 hours to break up agglomerates and obtain a homogeneous suspension.

The samples were cast on Al foil and the thickness of the as-cast film was controlled by adjusting the gap (160 μm) between the wire wound rod coater and Al substrate. The dried film will be cut into small round pieces with a diameter of 1.2 cm using a hammer and arch punch.

The S electrodes were thermo-pressed at 5 ksi/50° C./5 min before Li—S half-cell assembly.

### 3. Li—S Half-Cells for Performance Evaluation

After vacuum drying at 80° C. for 24 hours, the PAN-C—S electrodes were transferred to an Ar-filled glovebox. Half-cells were assembled using the S electrodes as cathode and Li metal as the anode. Before cell assembly, the metallic Li (16 mm W×750 μm T) was scraped to expose a clean surface in the glovebox. The electrolyte system was 1.1 M LiPF₆ mixed solvent (1:1:1 wt. % ratio) ethylene carbonate (EC):dimethyl carbonate (DMC):ethyl methyl carbonate (EMC) with 10 wt. % fluoroethylene carbonate (FEC). A Celgard 2400 polypropylene membrane separator was introduced. The 2032-coin cells were compressed using a ˜0.1 ksi uniaxial pressure.

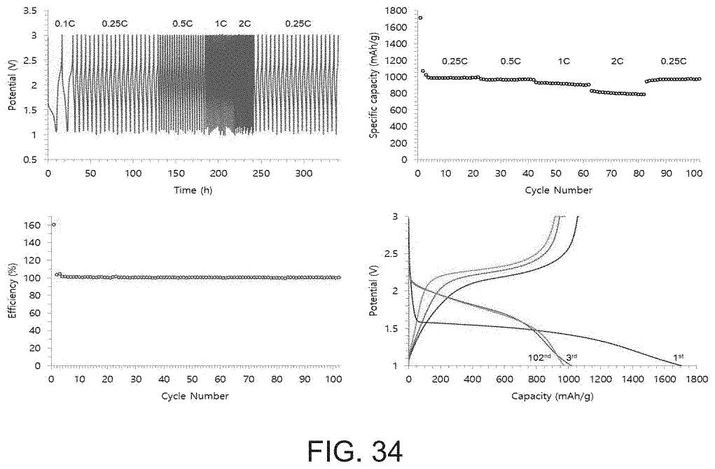

FIG. 34 illustrates the result of the Li—S half-cell without LATSP cycled at various C-rates.

The half-cell was cycled from 1 to 3 V for 102 cycles and the galvanostatic cycling profile shows that the cell was cycled for the first 2 cycles at 0.1 C, for 20 cycles at 0.25, 0.5, 1, 2C and the last 20 cycles at 0.25 C.

The initial discharge capacity was ˜1706 mAh/g which decreased to ˜1070 mAh/g after the 1st cycle. As shown in FIG. 34, the capacity decreased to ˜990, ˜960, ˜900, ˜790 mAh/g at 0.25, 0.5, 1, and 2 C. The specific capacity returned to ˜970 mAh/g when cycled again at 0.25 C. Capacity losses at 0.5, 1, and 2 C were 0.05, 0.16, and 0.24% per cycle respectively. A Coulombic efficiency of ˜100% was maintained throughout cycling.

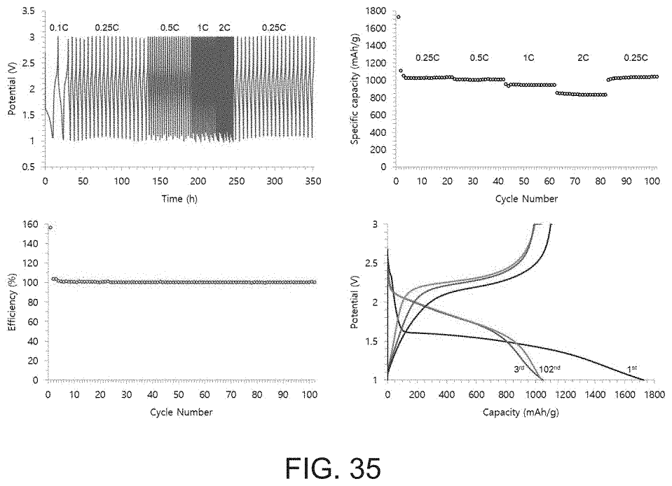

FIG. 35 presents data on the Li—S half-cell with 15 wt. % LATSP cycled at various C-rates.

The half-cell was cycled from 1 to 3 V for 102 cycles and with the first 2 cycles at 0.1 C, then 20 cycles at 0.25, 0.5, 1, 2 C and the last 20 cycles at 0.25 C.

The initial discharge capacity was ˜1730 mAh/g and this capacity decreased to ˜1110 mAh/g after the 1^{st} cycle. As shown in FIG. 35, the capacity decreased to ˜1035, ˜1010, ˜940, ˜830 mAh/g at 0.25, 0.5, 1C and 2 C. Capacity losses at 0.5, 1, and 2 C were 0.04, 0.07, and 0.12% per cycle. However, the discharge capacity recovered to ˜1040 mAh/g when cycled back to 0.25 C. A Coulombic efficiency of ˜100% was maintained throughout the cycle.

The results suggest 15 wt. % LATSP in S cathodes can make a more stable Li—S system and the discharge capacity of a Li—S half-cell with 15 wt. % LATSP can be ≥1000 mAh g⁻¹ at 0.5 C as shown in FIG. 15.

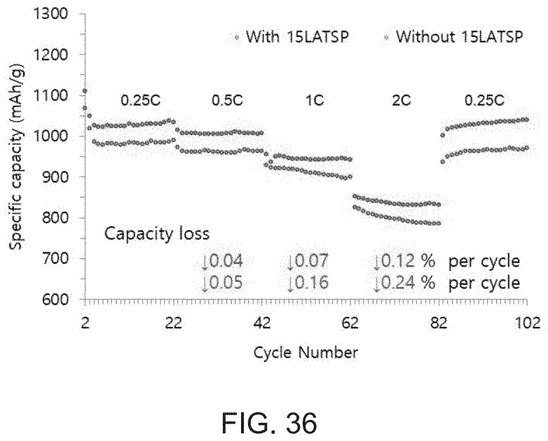

In a nutshell, FIG. 36 suggests adding solid electrolyte (SE) nanopowders to C—S composites can make stable Li—S half-cells because SE nanopowders can mitigate lithium polysulfide (LiPSs) shuttling likely by strong adsorption of sulfur species on the nanopowder SE surfaces, for example, the low-coordinated Ti sites of Ti₄O₇[Ref. 29,30].

Viewed in this way, adding LATSP nanopowders to C—S composites can be promising because they can trap LiPSs effectively and improve the slow redox reaction between Li-ions and S during battery cycling unlike normal metal oxides used only for capturing LiPSs in S cathodes.

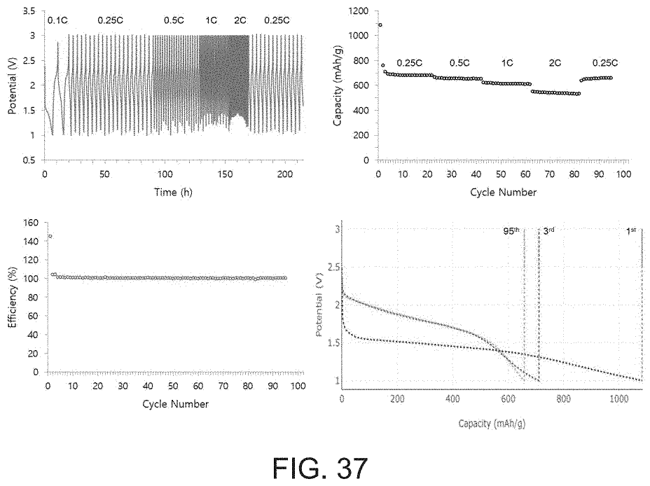

We also tested the use of LiAlO₂ nanopowder as shown in FIG. 37.

The half-cell was scheduled from 1 to 3 V for 102 cycles and monitored for 95 cycles. The galvanostatic cycling profile shows that the cell was cycled for the first 2 cycles at 0.1 C, for 20 cycles at 0.25, 0.5, 1C, and 2 C, and the last 13 cycles at 0.25 C.

The obtained initial discharge capacity was ˜1084 mAh/g and this discharge capacity de-creased to ˜761 mAh/g after the 1st cycle. As shown in FIG. 37, the capacity decreased to ˜681, ˜654, ˜614, and ˜538 mAh/g at 0.25, 0.5, 1, and 2 C. However, the capacity recovered to ˜658 mAh/g when cycled back to 0.25 C. A Coulombic efficiency of ˜100% was maintained throughout the cycle. Clearly, LiAlO₂ is not as effective as LATSP.

### 4. LiSiₓPON Coated Li—S Half Cells

For comparison, we also used a solid polymer electrolyte, Li₆SiPON, for coating.

The half-cell was scheduled from 1 to 3 V for 102 cycles and monitored for 102 cycles. The galvanostatic cycling profile shows that the cell was cycled for the first 2 cycles at 0.1 C, for 20 cycles at 0.25, 0.5, 1C, and 2 C, and the last 20 cycles at 0.25 C.

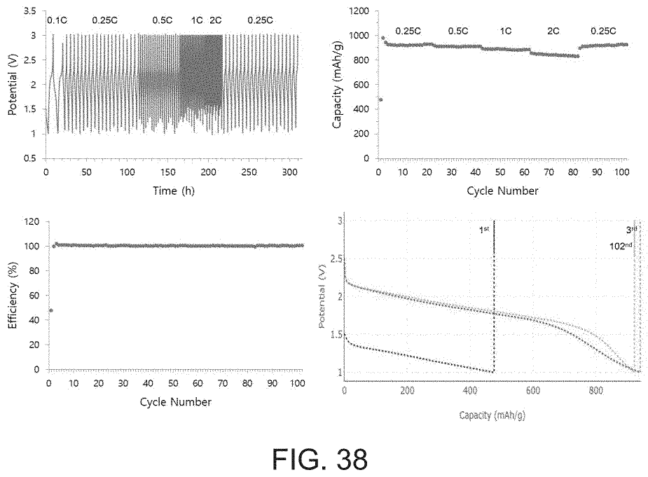

The obtained initial discharge capacity was ˜476 mAh/g and this discharge capacity in-creased to ˜977 mAh/g after the 1st cycle. As shown in FIG. 38, this capacity decreased to ˜918, ˜905, ˜884, and ˜838 mAh/g at 0.25, 0.5, 1, and 2 C. However, the capacity recovered to ˜916 mAh/g when cycled back to 0.25 C. A Coulombic efficiency of ˜100% was maintained throughout the cycle.

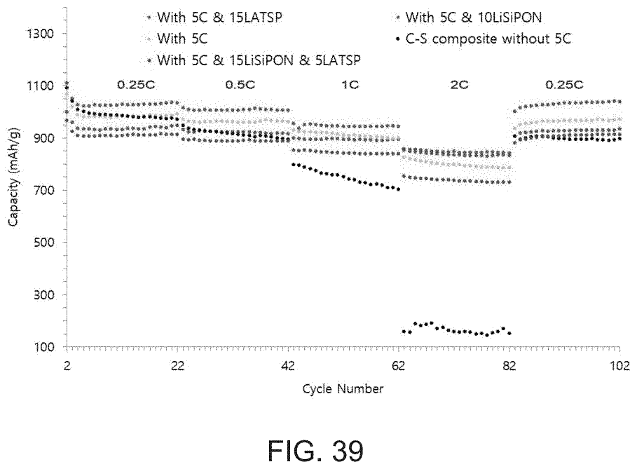

To summarize these studies, reference is made to FIG. 39.

### Example 5—Assembly of all Solid State Batteries (ASSB)

LTO-20 wt. % LATSP electrodes were investigated as an alternative anode as they demonstrate good rate performance and optimal Li⁺ diffusivity. NMC 622}−20 wt. % LATSP (Li_{1.7}Al_{0.3}Ti_{1.7}Si_{0.4}P_{2.6}O₁₂) electrodes were used as the catholyte and 60 wt. % PEO/Li₆PON was used as a polymer electrolyte and separator. The full cells were warm pressed at 10 kpsi/50° C./5 minutes. The full cell was dried at 60° C./12 hours/vacuum prior to assembly in the glove box. Three stainless steel spacers were used to ensure good contact between the coin cell parts.

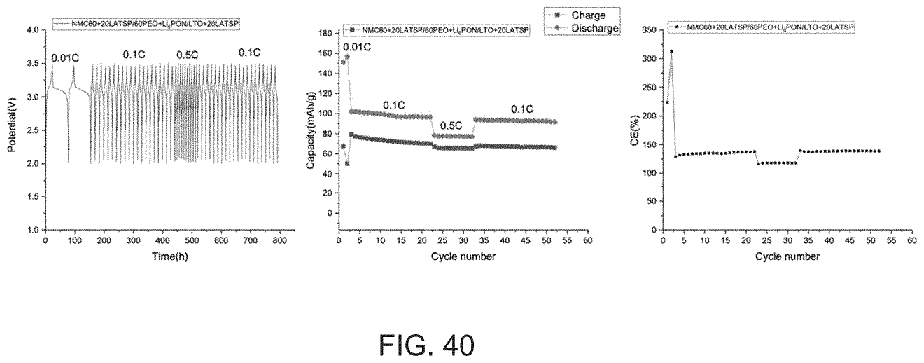

FIG. 40 shows galvanostatic cycling of the ASSB cycled between 2-3.5 V. The potential vs. time profile shows that the ASSB cycled to the targeted potentials with minimal polarization and IR drop for 800 hours.

The ASSB shows an initial discharge capacity of 160 mAh/g at 0.01 C. However, this capacity was not reversible as the charge capacity is ˜80 mAh/g. The discharge capacity decreases to 100 mAh/g as the C-rate increases to 0.1 C. A charge capacity of ˜80 mAh/g was maintained for the 20 cycles. The discharge and charge capacities decreased to 90 and 70 mAh/g at 0.5 C. The ASSB capacity recovers back to ˜100 mAh/g discharge capacity when the C-rate is decreased to 0.1 C. The ASSB demonstrates high columbic efficiency attributed to the gap between charge and discharge capacities.

Without intending to be bound by theory, coatings as presented in the above examples likely function via a variety of mechanisms. Among these, the introduction of high surface area lithium-ion sources directly coating the catholyte and anolyte active materials almost certainly improves the concentration of lithium ions at the interface with the active material thereby enhancing transport across interfaces. However, other operative mechanisms are also likely. For example, for catholytes that generate Mn²⁺ that dissolves in liquid electrolytes degrading capacity, the high surface area, the high energy surfaces of the NPs will give up Li⁺ to the surroundings resulting in surfaces that are highly negatively charged. Given that Mn²⁺ is a di-cation, one expects that such species will electrostatically bind more strongly to NP surfaces than Li⁺ becoming trapped and are thereby prevented from degrading anolytes. For the Li—S system, one can envision that polysulfides might also wrap around the NPs if sufficient positive ion cites remain or to underlying metal cations or simply be trapped in the narrow pores of the NP coating. In addition, the high surface area NPs can be anticipated to trap free F⁻ preventing or minimizing corrosion. Perhaps most important is that the presence of NPs at surfaces can be anticipated to strongly effect the electrostatic field near interfaces thereby changing the character of the individual double layer.

### Example 6—Nano LMNO (n-LMNO) Cathodes

In this Example, overlithiated LMNO (Li_{1.26}Mn_{1.5}Ni_{0.5}O₄) nano-size particles (synthesized using LF-FSP) were coated with LiAlO₂ nano-size particles. To differentiate this material from LMNO (Nano One) in Example 1, the nano-size, overlithiated LMNO will be referred to as “n-LMNO.” Unlike most coating processes, the method involved the use of a soft and scalable ball milling technique in which 5 wt. %-20 wt. % of the active nanoparticles were introduced to n-LMNO just before electrode fabrication. The n-LMNO powder and carbon black (C-65) were heated to 100° C./24 hours/vacuum. The electrode slurries were prepared by mixing n-LMNO (60-80 wt. %), C65 (5-10 wt. %), nanoparticles (5-20 wt. %), and PVDF (10 wt. %) in 1-methyl pyrrolidin-2-one. The mixtures were then ball-milled for 24 hours using yttria-stabilized zirconia beads (3 mm, 6 g). The slurries were then coated on Al foil.

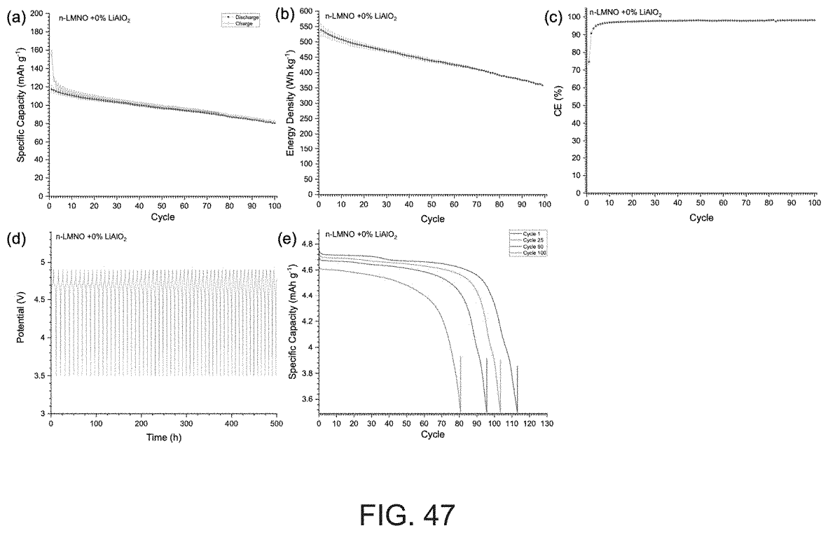

Half-cells were assembled using n-LMNO+0 wt. %, 5 wt. %, 10 wt. %, or 20 wt. % nano-LiAlO₂ (same nano-LiAlO₂ as used in Example 1 above) as catholyte, Li as the anode, and Celgard (25 μm) as a separator. For initial studies, the electrolyte system was 1.1 M LiPF₆ mixed solvent (6:2:2 vol. % ratio) EC:DEC:EMC with an added 10 wt. % FEC and 0.02M lithium bis(oxalato)borate. Before cell assembly, the metallic Li (16 mm W×750 μm T) was scraped to expose a clean surface. The 2032 coin cells were compressed using a ˜0.1 kpsi uniaxial pressure. The electrochemical values of duplicate half-cells were averaged as shown in FIGS. 47-50. There is clear electrochemical benefit in coating LiAlO₂ to n-LMNO, including higher energy density retention and greater retention of discharge plateau potential.

FIG. 47 shows galvanostatic cycling of the n-LMNO+0 wt. % LiAlO₂/Li (baseline) half-cell between 3.5-4.9V at 0.3 C. The potential vs. time profile shows that the half-cell cycled to the targeted potentials with minimal polarization and IR drop for 500 hours. The potential vs. capacity plot shows that the half-cell maintained flat discharge plateaus of ˜4.7 V, attributed to the redox of Ni; however, the discharge plateau at 4.7 V is only observed in initial cycling. There is voltage decay to ˜4.6 V for the primary discharge plateau after 100 cycles. The potential profile also showed a small shoulder ˜4 V attributed to redox of Mn.

The half-cell shows an initial charge and discharge capacity of 155 and 113 mAh/g at 0.3 C, respectively. The discharge capacity gradually decreases to 96 mAh/g after 50 cycles [FIG. 47, panel (e)]. The n-LMNO+0 wt. % LiAlO₂/Li half-cell showed an initial discharge energy density of ˜540 Wh/kg (FIG. 47 panel (b)) and showed 67% energy density retention after 100 cycles. The half-cell also demonstrates optimal columbic efficiency ˜98%.

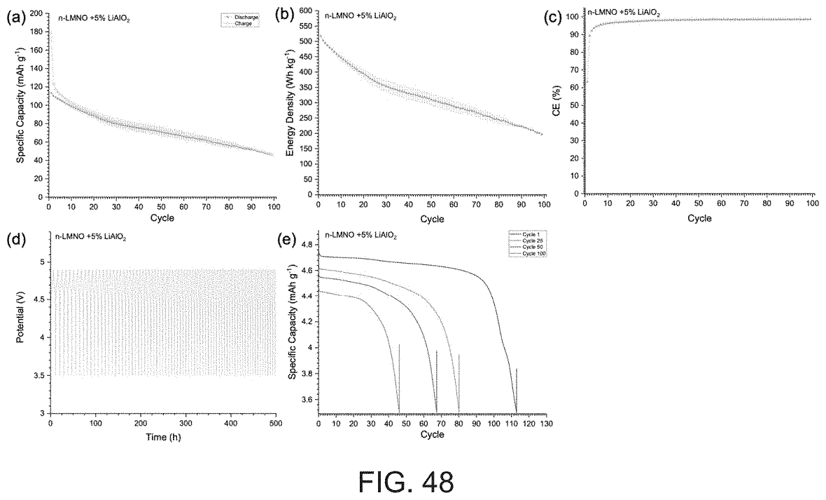

FIG. 48 shows galvanostatic cycling of the n-LMNO+5 wt. % LiAlO₂/Li half-cell between 3.5-4.9V at 0.3 C. The potential vs. time profile shows that the half-cell cycled to the targeted potentials with minimal polarization and IR drop for 500 hours. The potential vs. capacity plot shows that the half-cell maintained flat discharge plateaus of ˜4.7 V during initial cycles; however, there is significant voltage decay to ˜4.6 and 4.4 V for the primary discharge plateau after 25 and 100 cycles, respectively.

The half-cell shows an initial charge and discharge capacity of 179 and 114 mAh/g at 0.3 C, respectively [FIG. 48 panel (a)]. The discharge capacity gradually decreases to 46 mAh/g after 100 cycles. The n-LMNO+5 wt. % LiAlO₂/Li half-cell showed an initial discharge energy density of ˜450 Wh/kg and showed poor energy density retention of 38% after 100 cycles. The half-cell also demonstrates optimal columbic efficiency ˜99%.

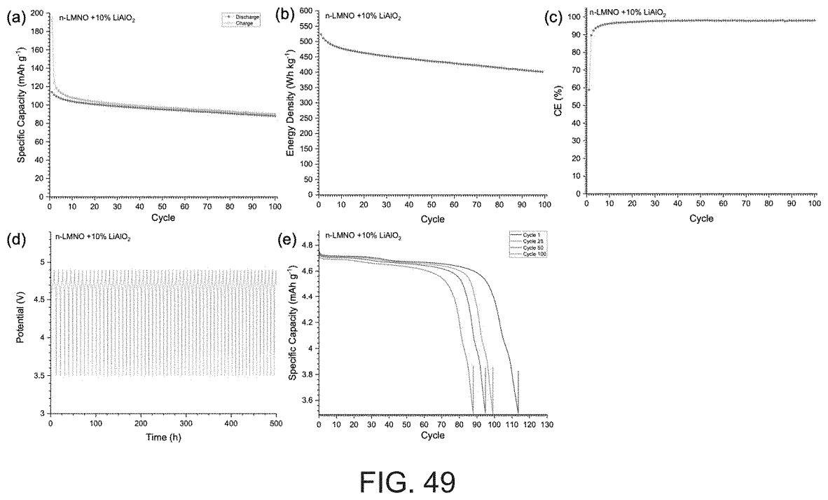

FIG. 49 shows galvanostatic cycling of the n-LMNO+10 wt. % LiAlO₂/Li half-cell between 3.5-4.9V at 0.3 C. The half-cell shows an initial charge and discharge capacity of 194 and 114 mAh/g at 0.3 C, respectively. The discharge capacity gradually decreases to 88 mAh/g after 100 cycles [FIG. 49 panel (e)]. The n-LMNO+10 wt. % LiAlO₂/Li half-cell showed an initial discharge energy density of ˜523 Wh/kg (FIG. 49 panel (b)) and energy retention of 77% after 100 cycles. The half-cell also demonstrates optimal columbic efficiency ˜98%.

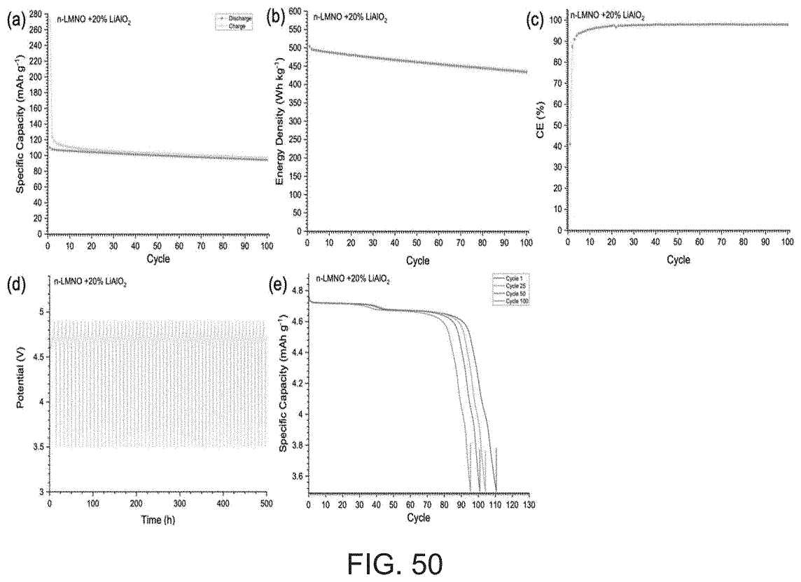

FIG. 50 shows galvanostatic cycling of the n-LMNO+20 wt. % LiAlO₂/Li half-cell between 3.5-4.9 V at 0.3 C. The potential vs. time profiles shows that both half-cells cycled to the targeted potentials with minimal polarization and IR drop for 500 hours. The n-LMNO+20 wt. % LiAlO₂/Li half-cells show an initial charge and discharge capacity of 268 and 110 mAh/g at 0.3 C, respectively. The n-LMNO+20 wt. % LiAlO₂/Li half-cell showed an initial discharge energy density of ˜505 Wh/kg (FIG. 50 panel (b)) and energy retention of 86% after 100 cycles. The half-cell also demonstrates optimal columbic efficiency ˜98%.

As shown in FIGS. 47-50 panels (a) and (c), there is considerable irreversible charge capacity lost for the ensuing discharge during the 1^{st} cycle as the LiAlO₂ content increases. Traditionally, it is optimal to increase 1^{st} cycle, and every cycle thereafter, columbic efficiency as to not irreversibly lose Li during cycling. In the case of n-LMNO+x wt. % LiAlO₂ (x=10, 20), the “lost Li” is most likely not lost to the system in a side reaction, but instead plated onto the Li anode, and not stripped away during the following charge step. The reason for the “excess” charge capacity not being reciprocated on the following discharge is related to the hurdle of re-lithiating the Li-poor LiAlO₂.

It stands to reason that if the system did not have a Li (usually in excess), perhaps this high first cycle capacity could contribute/start forming a Li reservoir on/in a Li-poor anode (i.e., Cu foil). This new Li reservoir could enable an anode-free system, starting only with an anode current collector with no active material. Additionally, in a system where the anode is known to also show low 1^{st} cycle columbic efficiency, perhaps the excess charge capacity from the n-LMNO+x wt. % LiAlO₂ (x=10, 20) could be sacrificed as irreversible capacity loss on the anode side (i.e., Si-based anode). The opportunity in this scenario would be donating excess Li from the cathode to be consumed in irreversible SEI formation on high-capacity anodes (i.e., Si-based anodes).

It is important to also note that the 20 wt. % LiAlO₂ promoted system is the most stable of the half cells tested demonstrating that imperfect nano-nano systems also offer superior behavior to uncoated systems.

### REFERENCES

1. Aegerter, M. A.; Mennig, M., Sol-Gel Technologies for Glass Producers and Users; Springer: New York; London, 2011.
2. Groenewolt, M., Highly Scratch Resistant Coatings for Automotive Applications. Prog. Org. Coat. 2008, 61 (2-4), 106-109. https://doi.org/10.1016/j.porgcoat.2007.07.036.
3. Suzuki, I., Corrosion-Resistant Coatings Technology; Corrosion technology; M. Dekker: New York, 1989.
4. Wang, J.; Liao, L.; Li, Y.; Zhao, J.; Shi, F.; Yan, K.; Pei, A.; Chen, G.; Li, G.; Lu, Z.; Cui, Y., Shell-Protective Secondary Silicon Nanostructures as Pressure-Resistant High-Volumetric-Capacity Anodes for Lithium-Ion Batteries. Nano Lett. 2018, 18 (11), 7060-7065. https://doi.org/10.1021/acs.nanolett.8b03065.
5. Zhang, Y.; Du, N.; Yang, D., Designing Superior Solid Electrolyte Interfaces on Silicon Anodes for High-Performance Lithium-Ion Batteries. Nanoscale 2019, 11 (41), 19086-19104. https://doi.org/10.1039/C9NR05748J.
6. Xuyan Liu; Xinjie Zhu; Deng Pan., Solutions for the Problems of Silicon-Carbon Anode Materials for Lithium-Ion Batteries. R Soc Open Sci 5 172370 Httpdx-doiorg101098rsos172370 5, 172370.
7. Li, N.; Yi, Z.; Lin, N.; Qian, Y., An Al₂O₃Coating Layer on Mesoporous Si Nanospheres for Stable Solid Electrolyte Interphase and High-Rate Capacity for Lithium Ion Batteries. Nanoscale 2019, 11 (36), 16781-16787. https://doi.org/10.1039/C9NR05264J.
8. Xiao, X.; Lu, P.; Ahn, D., Ultrathin Multifunctional Oxide Coatings for Lithium Ion Batteries. Adv. Mater. 2011, 23 (34), 3911-3915. https://doi.org/10.1002/adma.201101915.
9. Yamauchi, E.; Takeuchi, T.; Sakaebe, H., Improvement of Cycling Capability of Li₂S—FeS Composite Positive Electrode Materials by Surface Coating With Titanium Oxide. Front. Energy Res. 2019, 7, 38. https://doi.org/10.3389/fenrg.2019.00038.
10. Li, X.; Lushington, A.; Sun, Q.; Xiao, W.; Liu, J.; Wang, B.; Ye, Y.; Nie, K.; Hu, Y.; Xiao, Q.; Li, R.; Guo, J.; Sham, T.-K.; Sun, X., Safe and Durable High-Temperature Lithium-Sulfur Batteries via Molecular Layer Deposited Coating. Nano Lett. 2016, 16 (6), 3545-3549. https://doi.org/10.1021/acs.nanolett.6b00577.
11. Shin, W.; Lu, J.; Ji, X., ZnS Coating of Cathode Facilitates Lean-electrolyte Li—S Batteries. Carbon Energy 2019, 1 (2), 165-172. https://doi.org/10.1002/cey2.10.
12. Dharmasena, R.; Thapa, A. K.; Hona, R. K.; Jasinski, J.; Sunkara, M. K.; Sumanasekera, G. U., Mesoporous TiO₂ Coating on Carbon-Sulfur Cathode for High Capacity Li-Sulfur Battery. RSC Adv. 2018, 8 (21), 11622-11632. https://doi.org/10.1039/C8RA01380B.
13. Djafer, L.; Ayral, A.; Boury, B.; Laine, R. M., Surface Modification of Titania Powder P25 with Phosphate and Phosphonic Acids—Effect on Thermal Stability and Photocatalytic Activity. J. Colloid Interface Sci. 2013, 393, 335-339. https://doi.org/10.1016/j.jcis.2012.11.002.
14. Guan, P.; Zhou, L.; Yu, Z.; Sun, Y.; Liu, Y.; Wu, F.; Jiang, Y.; Chu, D., Recent Progress of Surface Coating on Cathode Materials for High-Performance Lithium-Ion Batteries. J. Energy Chem. 2020, 43, 220-235. https://doi.org/10.1016/j.jechem 0.2019.08.022.
15. Park, J. S.; Meng, X.; Elam, J. W.; Hao, S.; Wolverton, C.; Kim, C.; Cabana, J., Ultrathin Lithium-Ion Conducting Coatings for Increased Interfacial Stability in High Voltage Lithium-Ion Batteries. Chem. Mater. 2014, 26 (10), 3128-3134. https://doi.org/10.1021/cm500512n.
16. Tao, S.; Kong, F.; Wu, C.; Su, X.; Xiang, T.; Chen, S.; Hou, H.; Zhang, L.; Fang, Y.; Wang, Z.; Chu, W.; Qian, B.; Song, L., Nanoscale TiO₂ Membrane Coating Spinel LiNi_{0.5}Mn_{1.5}O₄ Cathode Material for Advanced Lithium-Ion Batteries. J. Alloys Compd. 2017, 705, 413-419. https://doi.org/10.1016/j.jallcom.2017.02.139.
17. Shevtsov, A.; Han, H.; Morozov, A.; Carozza, J. C.; Savina, A. A.; Shakhova, I.; Khasanova, N. R.; Antipov, E. V.; Dikarev, E. V.; Abakumov, A. M., Protective Spinel Coating for Li_{1.17}Ni_{0.17}Mn_{0.50}Co_{0.17}O₂ Cathode for Li-Ion Batteries through Single-Source Precursor Approach. Nanomaterials 2020, 10 (9), 1870. https://doi.org/10.3390/nano10091870.
18. Muratahan Aykol; Shiqiang Hao; Zhi Lu; Vinay Ishwar Hedge; David H. Snydacker; Scott J. Kirklin; Dane Morgan; Christopher M. Wolverton., Protective Cath-Ode Coatings For Lithium-Ion Batteries. U.S. Patent Application Publication No. 2017/0229742 A1.
19. Porz, L.; Swamy, T.; Sheldon, B. W.; Rettenwander, D.; Frömling, T.; Thaman, H. L.; Berendts, S.; Uecker, R.; Carter, W. C.; Chiang, Y.-M., Mechanism of Lithium Metal Penetration through Inorganic Solid Electrolytes. Adv. Energy Mater. 2017, 7 (20), 1701003. https://doi.org/10.1002/aenm.201701003.
20. Dedryvère, R.; Leroy, S.; Martinez, H.; Blanchard, F.; Lemordant, D.; Gonbeau, D., XPS Valence Characterization of Lithium Salts as a Tool to Study Electrode/Electrolyte Inter-faces of Li-Ion Batteries. J. Phys. Chem. B 2006, 110 (26), 12986-12992. https://doi.org/10.1021/jp061624f.
21. Kim, J. W.; Kim, D. H.; Oh, D. Y.; Lee, H.; Kim, J. H.; Lee, J. H.; Jung, Y. S., Surface Chemistry of LiNi_{0.5}Mn_{1.5}O₄ Particles Coated by Al₂O₃Using Atomic Layer Deposition for Lithium-Ion Batteries. J. Power Sources 2015, 274, 1254-1262. https://doi.org/10.1016/j.jpowsour.2014.10.207.
22. Landschoot, N. V.; Kelder, E. M.; Kooyman, P. J.; Kwakernaak, C.; Schoonman, J., Electrochemical Performance of Al₂O₃-Coated Fe Doped LiCoVO₄. J. Power Sources 2004, 138 (1-2), 262-270. https://doi.org/10.1016/j.jpowsour.2004.06.046.
23. Eleni Temeche; Elizaveta Buch; Xinyu Zhang; Taylor Brandt; Andreas Hinntennach; Richard M. Laine., Improved Electrochemical Properties of Li₄Ti₅O₁₂ Nanopowders (NPs) via Addition of LiAlO₂ and Li₆SiON Polymer Electrolytes, Derived from Agricultural Waste. ACS Appl. Energy Mater. 2021. https://doi.org/doi.org/10.1021/acsaem.0c02994.
24. Fang, Z. K.; Zhu, Y. R.; Yi, T. F.; Xie, Y., Li₄Ti₅O₁₂—LiAlO₂ Composite as High Performance Anode Material for Lithium-Ion Battery. ACS Sustain. Chem. Eng. 2016, 4 (4), 1994-2003. https://doi.org/10.1021/acssuschemeng.5b01271.
25. Zhu, Y. R.; Yuan, J.; Zhu, M.; Hao, G.; Yi, T. F.; Xie, Y., Improved Electrochemical Properties of Li₄Ti₅O₁₂—Li_{0.33}La_{0.56}TiO₃ Composite Anodes Prepared by a Solid-State Synthesis. J. Alloys Compd. 2015, 646, 612-619. https://doi.org/10.1016/j.jallcom.2015.05.239.
26. Yi, T. F.; Xie, Y.; Wu, Q.; Liu, H.; Jiang, L.; Ye, M.; Zhu, R., High Rate Cycling Performance of Lanthanum-Modified Li₄Ti₅O₁₂ Anode Materials for Lithium-Ion Batteries. J. Power Sources 2012. https://doi.org/10.1016/j.jpowsour.2012.04.101.
27. Rahman, M. M.; Wang, J. Z.; Hassan, M. F.; Chou, S.; Wexler, D.; Liu, H. K., Basic Molten Salt Process—A New Route for Synthesis of Nanocrystalline Li₄Ti₅O₁₂—TiO₂ Anode Material for Li-Ion Batteries Using Eutectic Mixture of LiNO₃—LiOH-Li₂O₂. J. Power Sources 2010. https://doi.org/10.1016/j.jpowsour.2010.01.073.
28. Wang, J.; Zhao, H.; Yang, Q.; Wang, C.; Lu, P.; Xia, Q., Li₄Ti₅O₁₂—TiO₂ Composite Anode Material for Lithium-Ion Batteries. J. Power Sources 2013. https://doi.org/10.1016/j.jpowsour.2012.08.082.
29. Tao, X.; Wang, J.; Liu, C.; Wang, H.; Yao, H.; Zheng, G.; Seh, Z. W.; Cai, Q.; Li, W.; Zhou, G.; Zu, C.; Cui, Y., Balancing Surface Adsorption and Diffusion of Lithium-Polysulfides on Nonconductive Oxides for Lithium-Sulfur Battery Design. Nat. Commun. 2016, 7 (1), 11203. https://doi.org/10.1038/ncomms11203.
30. Tao, X.; Wang, J.; Ying, Z.; Cai, Q.; Zheng, G.; Gan, Y.; Huang, H.; Xia, Y.; Liang, C.; Zhang, W.; Cui, Y., Strong Sulfur Binding with Conducting Magnéli-Phase TiₙO₂ₙ₋₁ Nanomaterials for Improving Lithium-Sulfur Batteries. Nano Left. 2014, 14 (9), 5288-5294. https://doi.org/10.1021/nl502331f.
31. Zubi, G.; Dufo-Lo\acute{p}ez, R.; Carvalho, M.; Pasaoglu, G., The Lithium-Ion Battery: State of the Art and Future Perspectives. Renewable Sustainable Energy Rev. 2018, 89, 292.
32. Nitta, N.; Wu, F.; Lee, J. T.; Yushin, G., Li-Ion Battery Materials: Present and Future. Mater. Today 2015, 18, 252.
33. Tarascon, J. M.; Armand, M., Issues and Challenges Facing Rechargeable Lithium Batteries. Materials for Sustainable Energy: A Collection of Peer-Reviewed Research and Review Articles from Nature Publishing Group 2010, 171.
34. Ma, L.; Hendrickson, K. E.; Wei, S.; Archer, L. A., Nanomaterials: Science and Applications in the Lithium-Sulfur Battery. Nano Today 2015, 10, 315.
35. Uhlmann, C.; Illig, J.; Ender, M.; Schuster, R.; Ivers-Tiffeé, E., In Situ Detection of Lithium Metal Plating on Graphite in Experimental Cells. J. Power Sources 2015, 279, 428.
36. Liu, Q.; Du, C.; Shen, B.; Zuo, P.; Cheng, X.; Ma, Y.; Yin, G.; Gao, Y., Understanding Undesirable Anode Lithium Plating Issues in Lithium-Ion Batteries. RSC Adv. 2016, 6, 88683.
37. Aurbach, D.; Zinigrad, E.; Cohen, Y.; Teller, H., A Short Review of Failure Mechanisms of Lithium Metal and Lithiated Graphite Anodes in Liquid Electrolyte Solutions. Solid State Ionics 2002, 148, 405.
38. Doughty, D.; Roth, E. P., A General Discussion of Li Ion Battery Safety Electrochem. Soc. Interface 2012. DOI: 10.1149/2.F03122if.
39. Aravindan, V.; Lee, Y.-S.; Madhavi, S., Research Progress on Negative Electrodes for Practical Li-Ion Batteries: Beyond Carbonaceous Anodes. Adv. Energy Mater. 2015, 5, 1402225.
40. Pfanzelt, M.; Kubiak, P.; Fleischhammer, M.; Wohlfahrt-Mehrens, M., TiO₂ Rutile—An Alternative Anode Material for Safe Lithium-Ion Batteries. J. Power Sources 2011, 196, 6815.
41. Zuo, X.; Zhu, J.; Müller-Buschbaum, P.; Cheng, Y. J., Silicon Based Lithium-Ion Battery Anodes: A Chronicle Perspective Review. Nano Energy 2017, 31, 113.
42. Sun, X.; Radovanovic, P. V.; Cui, B., Advances in Spinel Li₄Ti₅O₁₂ Anode Materials for Lithium-Ion Batteries. New J. Chem. 2015, 39, 38.
43. Yi, T. F.; Jiang, L. J.; Shu, J.; Yue, C. B.; Zhu, R. S.; Qiao, H. Bin., Recent Development and Application of Li₄Ti₅O₁₂ as Anode Material of Lithium Ion Battery. J. Phys. Chem. Solids 2010, 71, 1236.
44. Zhao, B.; Ran, R.; Liu, M.; Shao, Z., A Comprehensive Review of Li₄Ti₅O₁₂-Based Electrodes for Lithium-Ion Batteries: The Latest Advancements and Future Perspectives. Mater. Sci. Eng., R 2015, 98, 1.
45. Zhang, Q.; Li, X., Recent Developments in the Doped-Li₄Ti₅O₁₂ Anode Materials of Lithium-Ion Batteries for Improving the Rate Capability Int. J. Electrochem. Sci. 2013.
46. Zaghib, K.; Simoneau, M.; Armand, M.; Gauthier, M., Electrochemical Study of Li₄Ti₅O₁₂ as Negative Electrode for Li-Ion Polymer Rechargeable Batteries. J. Power Sources 1999, 81-82, 300.
47. Mukai, K.; Kato, Y.; Nakano, H., Understanding the Zero-Strain Lithium Insertion Scheme of Li[Li_{1/3}Ti_{5/3}]O₄: Structural Changes at Atomic Scale Clarified by Raman Spectroscopy. J. Phys. Chem. C 2014, 118, 2992.
48. Sandhya, C. P.; John, B.; Gouri, C., Lithium Titanate as Anode Material for Lithium-Ion Cells: A Review. Ionics 2014, 20, 601.
49. Yuan, T.; Tan, Z.; Ma, C.; Yang, J.; Ma, Z. F.; Zheng, S., Challenges of Spinel Li4Ti5O12 for Lithium-Ion Battery Industrial Applications. Adv. Energy Mater. 2017, 7, 1601625.
50. Yao, X. L.; Xie, S.; Chen, C. H.; Wang, Q. S.; Sun, J. H.; Li, Y. L.; Lu, S. X., Comparisons of Graphite and Spinel Li_{1.33}Ti_{1.67}O₄ as Anode Materials for Rechargeable Lithium-Ion Batteries. Electrochim. Acta 2005, 50, 4076.
51. Xiang, H. F.; Jin, Q. Y.; Wang, R.; Chen, C. H.; Ge, X. W., Nonflammable Electrolyte for 3-V Lithium-Ion Battery with Spinel Materials LiNi_{0.5}Mn_{1.5}O₄ and Li₄Ti₅O₁₂. J. Power Sources 2008, 179, 351.
52. Chen, C.; Vaughey, J.; Jansen, A.; Dees, D.; Kahaian, A.; Goacher, T.; Thackeray, M., Studies of Mg-Substituted Li₄₋ₓMgₓTi₅O₁₂ Spinel Electrodes (0≤x≤1) for Lithium Batteries. J. Electrochem. Soc. 2001, 148, A102.
53. Zhao, L.; Hu, Y. S.; Li, H.; Wang, Z.; Chen, L., Porous Li₄Ti₅O₁₂ Coated with N-Doped Carbon from Ionic Liquids for Li-Ion Batteries. Adv. Mater. 2011, 23, 1385.
54. Han, J. P.; Zhang, B.; Wang, L. Y.; Zhu, H. L.; Qi, Y. X.; Yin, L. W.; Li, H.; Lun, N.; Bai, Y. J., Li_{1.3}Al_{0.3}Ti_{1.7}(PO₄)₃ Behaving as a Fast Ionic Conductor and Bridge to Boost the Electrochemical Performance of Li₄Ti₅O₁₂. ACS Sustainable Chem. Eng. 2018, 6 (6), 7273-7282.
55. Gao, J.; Jiang, C.; Ying, J.; Wan, C., Preparation and Characterization of High-Density Spherical Li₄Ti₅O₁₂ Anode Material for Lithium Secondary Batteries. J. Power Sources 2006, 155, 364.
56. Bai, X.; Li, W.; Wei, A.; Li, X.; Zhang, L.; Liu, Z., Preparation and Electrochemical Properties of Mg²⁺ and F⁻ Co-Doped Li₄Ti₅O₁₂ Anode Material for Use in the Lithium-Ion Batteries. Electrochim. Acta 2016, 222, 1045.
57. Tian, Q.; Zhang, Z.; Yang, L.; Xiang, Y., Improving the Lithium Storage Properties of Li₄Ti₅O₁₂ anodes by Facile Two-Phase Formation and Nanostructure Engineering Strategy. J. Alloys Compd. 2017, 705, 638-644.
58. Wolfenstine, J.; Allen, J. L., Electrical Conductivity and Charge Compensation in Ta Doped Li₄Ti₅O₁₂. J. Power Sources 2008, 180, 582.
59. Ji, S.; Zhang, J.; Wang, W.; Huang, Y.; Feng, Z.; Zhang, Z.; Tang, Z., Preparation and Effects of Mg-Doping on the Electro-chemical Properties of Spinel Li₄Ti₅O₁₂ as Anode Material for Lithium Ion Battery. Mater. Chem. Phys. 2010, 123, 510.
60. Zhao, H.; Li, Y.; Zhu, Z.; Lin, J.; Tian, Z.; Wang, R., Structural and Electrochemical Characteristics of Li_{4-X}AlₓTi₅O₁₂ as Anode Material for Lithium-Ion Batteries. Electrochim. Acta 2008, 53, 7079.
61. Lee, B.; Yoon, J. R., Preparation and Characteristics of Li₄Ti₅O₁₂ with Various Dopants as Anode Electrode for Hybrid Supercapacitor. Curr. Appl. Phys. 2013, 13, 1350.
62. Huang, S.; Wen, Z.; Gu, Z.; Zhu, X., Preparation and Cycling Performance of Al³⁺ and F⁻ Co-Substituted Compounds Li₄AlₓTi_{5-X}F_{Y}O_{12-Y}. Electrochim. Acta 2005, 50, 4057.
63. Salvatore, K. L.; Lutz, D. M.; Guo, H.; Yue, S.; Gan, J.; Tong, X.; Liu, P.; Takeuchi, E. S.; Takeuchi, K. J.; Marschilok, A. C.; Wong, S. S., Solution-Based, Anion-Doping of Li₄Ti₅O₁₂ Nanoflowers for Lithium-Ion Battery Applications. Chem.—Eur. J. 2020, 26, 9389.
64. Qi, Y.; Huang, Y.; Jia, D.; Bao, S. J.; Guo, Z. P., Preparation and Characterization of Novel Spinel Li₄Ti₅O_{12-X}Brₓ Anode Materials. Electrochim. Acta 2009, 54, 4772.
65. Li, X.; Qu, M.; Huai, Y.; Yu, Z., Preparation and Electro-chemical Performance of Li₄Ti₅O₁₂/Carbon/Carbon Nano-Tubes for Lithium Ion Battery. Electrochim. Acta 2010, 55, 2978.
66. Wang, G. J.; Gao, J.; Fu, L. J.; Zhao, N. H.; Wu, Y. P.; Takamura, T., Preparation and Characteristic of Carbon-Coated Li₄Ti₅O₁₂ Anode Material. J. Power Sources 2007, 174, 1109.
67. Jung, H. G.; Kim, J.; Scrosati, B.; Sun, Y. K., Micron-Sized, Carbon-Coated Li₄Ti₅O₁₂ as High Power Anode Material for Advanced Lithium Batteries. J. Power Sources 2011, 196, 7763.
68. Luo, H.; Shen, L.; Rui, K.; Li, H.; Zhang, X., Carbon Coated Li₄Ti₅O₁₂ Nanorods as Superior Anode Material for High Rate Lithium Ion Batteries. J. Alloys Compd. 2013, 572, 37.
69. Zhu, Y. R.; Yuan, J.; Zhu, M.; Hao, G.; Yi, T. F.; Xie, Y., Improved Electrochemical Properties of Li₄Ti₅O₁₂—Li_{0.33}La_{0.56}TiO₃ Composite Anodes Prepared by a Solid-State Synthesis. J. Alloys Compd. 2015, 646, 612-619.
70. Poizot, P.; Laruelle, S.; Grugeon, S.; Dupont, L.; Tarascon, J. M., Nano-Sized Transition-Metal Oxides as Negative-Electrode Materials for Lithium-Ion Batteries. Nature 2000, 407, 496.
71. Wang, Y.; Liu, H.; Wang, K.; Eiji, H.; Wang, Y.; Zhou, H., Synthesis and Electrochemical Performance of Nano-Sized Li₄Ti₅O₁₂ with Double Surface Modification of Ti(III) and Carbon. J. Mater. Chem. 2009, 19, 6789.
72. Jaiswal, A.; Home, C. R.; Chang, O.; Zhang, W.; Kong, W.; Wang, E.; Chern, T.; Doeff, M. M., Nanoscale LiFePO₄ and Li₄Ti₅O₁₂ for High Rate Li-Ion Batteries. J. Electrochem. Soc. 2009, 156, A1041.
73. Shen, C. M.; Zhang, X. G.; Zhou, Y. K.; Li, H. L., Preparation and Characterization of Nanocrystalline Li₄Ti₅O₁₂ by Sol-Gel Method. Mater. Chem. Phys. 2003, 78, 437.
74. Zhou, Q.; Liu, L.; Tan, J.; Yan, Z.; Huang, Z.; Wang, X., Synthesis of Lithium Titanate Nanorods as Anode Materials for Lithium and Sodium Ion Batteries with Superior Electrochemical Performance. J. Power Sources 2015, 283, 243.
75. Ju, S. H.; Kang, Y. C., Characteristics of Spherical-Shaped Li₄Ti₅O₁₂ Anode Powders Prepared by Spray Pyrolysis. J. Phys. Chem. Solids 2009, 70, 40.
76. Chou, S. L.; Wang, J. Z.; Liu, H. K.; Dou, S. X., Rapid Synthesis of Li4Ti5O12 Microspheres as Anode Materials and Its Binder Effect for Lithium-Ion Battery. J. Phys. Chem. C 2011, 115, 16220.
77. Fang, Z. K.; Zhu, Y. R.; Yi, T. F.; Xie, Y., Li₄Ti₅O₁₂—LiAlO₂ Composite as High Performance Anode Material for Lithium-Ion Battery. ACS Sustainable Chem. Eng. 2016, 4 (4), 1994-2003.
78. Monchak, M.; Hupfer, T.; Senyshyn, A.; Boysen, H.; Chernyshov, D.; Hansen, T.; Schell, K. G.; Bucharsky, E. C.; Hoffmann, M. J.; Ehrenberg, H., Lithium Diffusion Pathway in Li_{1.3}Al_{0.3}Ti_{1.7}(PO₄)₃ (LATP) Superionic Conductor. Inorg. Chem. 2016, 55, 2941.
79. Wu, X. M.; Li, X. H.; Wang, S. W.; Wang, Z.; Zhang, Y. H.; Xu, M. F.; He, Z. Q., Preparation and Characterization of Lithium-Ion-Conductive Li_{1.3}Al_{0.3}Ti_{1.7}(PO₄)₃ Thin Films by the Solution Deposition. Thin Solid Films 2003, 425, 103.
80. Temeche, E.; Indris, S.; Laine, R. M., LiAlO₂/LiAl₅O₈ Membranes Derived from Flame Synthesized Nanopowders as a Potential Electrolyte and Coating Materials for All Solid-State Batteries (ASSBs). ACS Appl. Mater. Interfaces 2020, 12, 46119.
81. Zhang, X.; Temeche, E.; Laine, R. M., LiₓSiON (X=2, 4, 6); A Novel Solid Electrolyte System Derived from Agricultural Waste. Green Chem. 2020, 22, 7491
82. Yi, E.; Wang, W.; Mohanty, S.; Kieffer, J.; Tamaki, R.; Laine, R. M., Materials That Can Replace Liquid Electrolytes in Li Batteries: Superionic Conductivities in Li_{1.7}Al_{0.3}Ti_{1.7}Si_{0.4}P_{2.6}O₁₂. Processing Combustion Synthesized Nanopowders to Free Standing Thin Films. J. Power Sources 2014, 269, 577-588.
83. Temeche, E.; Yi, E.; Keshishian, V.; Kieffer, J.; Laine, R. M., Liquid-Feed Flame Spray Pyrolysis Derived Nanopowders (NPs) as a Route to Electrically Conducting Calcium Aluminate (12Ca_{0.7}Al₂O₃) Films. J. Eur. Ceram. Soc. 2019, 39, 1263.
84. Temeche, E.; Yu, M.; Laine, R. M., Silica Depleted Rice Hull Ash (SDRHA), an Agricultural Waste, as a High-Performance Hybrid Lithium-Ion Capacitor. Green Chem. 2020, 22, 4656.
85. Alias, N. A.; Kufian, M. Z.; Teo, L. P.; Majid, S. R.; Arof, A. K., Synthesis and Characterization of Li₄Ti₅O₁₂. J. Alloys Compd. 2009, 486, 645.
86. Prosini, P. P.; Mancini, R.; Petrucci, L.; Contini, V.; Villano, P., Li₄Ti₅O₁₂ as Anode in All-Solid-State, Plastic, Lithium-Ion Batteries for Low-Power Applications. Solid State Ionics 2001, 144, 185.
87. Du, Z.; Wood, D. L.; Daniel, C.; Kalnaus, S.; Li, J., Understanding Limiting Factors in Thick Electrode Performance as Applied to High Energy Density Li-Ion Batteries. J. Appl. Electrochem. 2017, 47, 405.
88. Yi, T. F.; Shu, J.; Zhu, Y. R.; Zhu, X. D.; Zhu, R. S.; Zhou, A. N., Advanced Electrochemical Performance of Li₄Ti_{4.95}V_{0.05}O₁₂ as a Reversible Anode Material down to 0 V. J. Power Sources 2010, 195, 285.
89. Tian, B.; Xiang, H.; Zhang, L.; Wang, H., Effect of Nb-Doping on Electrochemical Stability of Li₄Ti₅O₁₂ Discharged to 0 V. J. Solid State Electrochem. 2012, 16, 205.
90. Zhang, Q.; Verde, M. G.; Seo, J. K.; Li, X.; Meng, Y. S., Structural and Electrochemical Properties of Gd-Doped Li₄Ti₅O₁₂ as Anode Material with Improved Rate Capability for Lithium-Ion Batteries. J. Power Sources 2015, 280, 355.
91. Yi, T. F.; Xie, Y.; Wu, Q.; Liu, H.; Jiang, L.; Ye, M.; Zhu, R., High Rate Cycling Performance of Lanthanum-Modified Li₄Ti₅O₁₂ Anode Materials for Lithium-Ion Batteries. J. Power Sources 2012, 214, 220.
92. Rahman, M. M.; Wang, J. Z.; Hassan, M. F.; Chou, S.; Wexler, D.; Liu, H. K., Basic Molten Salt Process-A New Route for Synthesis of Nanocrystalline Li₄Ti₅O₁₂—TiO₂ Anode Material for Li-Ion Batteries Using Eutectic Mixture of LiNO₃—LiOH-Li₂O₂. J. Power Sources 2010, 195, 4297.
93. Wang, J.; Zhao, H.; Yang, Q.; Wang, C.; Lu, P.; Xia, Q., Li₄Ti₅O₁₂—TiO₂ Composite Anode Material for Lithium-Ion Batteries. J. Power Sources 2013, 222, 196.
94. Fang, Z. K.; Zhu, Y. R.; Yi, T. F.; Xie, Y., Li₄Ti₅O₁₂—LiAlO₂ Composite as High Performance Anode Material for Lithium-Ion Battery. ACS Sustain. Chem. Eng. 2016, 4 (4), 1994-2003. https://doi.org/10.1021/acssuschemeng.5b01271.
95. Zhu, Y. R.; Yuan, J.; Zhu, M.; Hao, G.; Yi, T. F.; Xie, Y., Improved Electrochemical Properties of Li₄Ti₅O₁₂—Li_{0.33}La_{0.56}TiO₃ Composite Anodes Prepared by a Solid-State Synthesis. J. Alloys Compd. 2015, 646, 612-619. https://doi.org/10.1016/j.jallcom.2015.05.239.

The citation of any document or reference is not to be construed as an admission that it is prior art with respect to the present invention.

Thus, the present invention provides coatings that enhance battery component performance.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the invention has been described in considerable detail with reference to certain embodiments, one skilled in the art will appreciate that the present invention can be used in alternative embodiments to those described, which have been presented for purposes of illustration and not of limitation. Therefore, the scope of the appended claims should not be limited to the description of the embodiments contained herein.

What is claimed is:

1. An electrode for an electrochemical device, the electrode comprising:
a lithium host material; and
a porous coating on the lithium host material, the porous coating comprising a solid-state ion conducting electrolyte material selected from the group consisting of:
(i) lithium aluminum oxides,
(ii) lithium containing phosphates,
(iii) LiₓPON wherein x is 1, 1.5, 3, or 6,
(iv) LiₓSiPON wherein x is 1, 1.5, 3, or 6,
(v) LiₓSiON wherein x is 2, 4, or 6,
(vi) a ceramic electrolyte material having the formula LiᵤReᵥM_{w}AₓO_{y} wherein Re can be any combination of elements with a nominal valence of +3 including La, Nd, Pr, Pm, Sm, Sc, Eu, Gd, Tb, Dy, Y, Ho, Er, Tm, Yb, and Lu, M can be any combination of metals with a nominal valence of +3, +4, +5 or +6 including Zr, Ta, Nb, Sb, W, Hf, Sn, Ti, V, Bi, Ge, and Si, A can be any combination of dopant atoms with nominal valence of +1, +2, +3 or +4 including H, Na, K, Rb, Cs, Ba, Sr, Ca, Mg, Fe, Co, Ni, Cu, Zn, Ga, Al, B, and Mn, u can vary from 3-7.5, v can vary from 0-3, w can vary from 0-2, x can vary from 0-2; and y can vary from 11-12.5, and
(vii) mixtures thereof.

2. The electrode of claim 1 wherein:
the porous coating comprising the solid-state ion conducting electrolyte material is formed from one or more precursors that form the porous coating comprising the solid-state ion conducting electrolyte material upon cycling of the electrochemical device.

3. The electrode of claim 1 wherein the electrode comprises:
a plurality of first particles comprising a porous coating of one of the solid-state ion conducting electrolyte materials on the lithium host material, and
a plurality of second particles comprising a porous coating of another of the solid-state ion conducting electrolyte materials on the lithium host material.

4. The electrode of claim 3 wherein:
the one of the solid-state ion conducting electrolyte material is present in the first particles at a weight percentage between 5% and 30% based on a total weight of the one of the solid-state ion conducting electrolyte material and the lithium host material in the first particles, and
the another of the solid-state ion conducting electrolyte materials is present in the second particles at a weight percentage between 5% and 30% based on a total weight of the another of the solid-state ion conducting electrolyte materials and the lithium host material in the second particles.

5. The electrode of claim 1 wherein:
the electrode has a thickness between 1 and 200 micrometers, and
the porous coating has a thickness between about 20 nanometers and about 10 micrometers, and
the porous coating comprises particles having an average particle size between 1 and 100 nanometers.

6. The electrode of claim 1 wherein:
the electrode is a cathode, and
the lithium host material comprises a cathode active material selected from (i) lithium metal oxides wherein the metal is one or more aluminum, cobalt, iron, manganese, nickel and vanadium, (ii) lithium-containing phosphates having a general formula LiMPO₄ wherein M is one or more of cobalt, iron, manganese, and nickel, and (iii) materials having a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811).

7. The electrode of claim 1 wherein:
the solid-state ion conducting electrolyte material comprises a lithium aluminum oxide.

8. The electrode of claim 1 wherein:
the solid-state ion conducting electrolyte material comprises a lithium containing phosphate.

9. The electrode of claim 1 wherein:
the solid-state ion conducting electrolyte material comprises LiₓPON wherein x is 1, 1.5, 3, or 6.

10. The electrode of claim 1 wherein:
the solid-state ion conducting electrolyte material comprises LiₓSiPON wherein x is 1, 1.5, 3, or 6.

11. The electrode of claim 1 wherein:
the solid-state ion conducting electrolyte material comprises LiₓSiON wherein x is 2, 4, or 6.

12. The electrode of claim 1 wherein:
the solid-state ion conducting electrolyte material comprises the ceramic electrolyte material.

13. The electrode of claim 1 wherein:
the electrode is an anode, and
the lithium host material is selected from the group consisting of lithium titanium oxides, silicon-containing materials, and high entropy oxides.

14. The electrode of claim 1 further comprising:
silica depleted rice hull ash.

15. An electrochemical device comprising:
the electrode of claim 1 as a cathode;
an anode; and
an electrolyte positioned between the cathode and the anode.

16. An electrochemical device comprising:
the electrode of claim 1 as a anode;
a cathode; and
an electrolyte positioned between the cathode and the anode.

17. A method for forming an electrode for an electrochemical device, the method comprising:
(a) forming a slurry including coated particles comprising a porous coating of a solid-state ion conducting electrolyte material on a lithium host material; and
(b) casting a layer of the slurry on a surface to form the electrode.

18. The method of claim 17 wherein:
the solid-state ion conducting electrolyte material is selected from the group consisting of:
(i) lithium aluminum oxides,
(ii) lithium containing phosphates,
(iii) LiₓPON wherein x is 1, 1.5, 3, or 6,
(iv) LiₓSiPON wherein x is 1, 1.5, 3, or 6,
(v) LiₓSiON wherein x is 2, 4, or 6,
(vi) a ceramic electrolyte material having the formula LiᵤReᵥM_{w}AₓO_{y} wherein Re can be any combination of elements with a nominal valence of +3 including La, Nd, Pr, Pm, Sm, Sc, Eu, Gd, Tb, Dy, Y, Ho, Er, Tm, Yb, and Lu, M can be any combination of metals with a nominal valence of +3, +4, +5 or +6 including Zr, Ta, Nb, Sb, W, Hf, Sn, Ti, V, Bi, Ge, and Si, A can be any combination of dopant atoms with nominal valence of +1, +2, +3 or +4 including H, Na, K, Rb, Cs, Ba, Sr, Ca, Mg, Fe, Co, Ni, Cu, Zn, Ga, Al, B, and Mn, u can vary from 3-7.5, v can vary from 0-3, w can vary from 0-2, x can vary from 0-2; and y can vary from 11-12.5, and
(vii) mixtures thereof.

19. A method for forming an electrode for an electrochemical device, the method comprising:
(a) forming a slurry including coated particles comprising a lithium host material and a coating of one or more precursors that form a porous coating of a solid-state ion conducting electrolyte material on the lithium host material upon cycling of the electrochemical device; and
(b) casting a layer of the slurry on a surface to form the electrode.

20. The method of claim 19 wherein:
the solid-state ion conducting electrolyte material is selected from the group consisting of:
(i) lithium aluminum oxides,
(ii) lithium containing phosphates,
(iii) LiₓPON wherein x is 1, 1.5, 3, or 6,
(iv) LiₓSiPON wherein x is 1, 1.5, 3, or 6,
(v) LiₓSiON wherein x is 2, 4, or 6,
(vi) a ceramic electrolyte material having the formula LiᵤReᵥM_{w}AₓO_{y} wherein Re can be any combination of elements with a nominal valence of +3 including La, Nd, Pr, Pm, Sm, Sc, Eu, Gd, Tb, Dy, Y, Ho, Er, Tm, Yb, and Lu, M can be any combination of metals with a nominal valence of +3, +4, +5 or +6 including Zr, Ta, Nb, Sb, W, Hf, Sn, Ti, V, Bi, Ge, and Si, A can be any combination of dopant atoms with nominal valence of +1, +2, +3 or +4 including H, Na, K, Rb, Cs, Ba, Sr, Ca, Mg, Fe, Co, Ni, Cu, Zn, Ga, Al, B, and Mn, u can vary from 3-7.5, v can vary from 0-3, w can vary from 0-2, x can vary from 0-2; and y can vary from 11-12.5, and
(vii) mixtures thereof.
